(19) United States
(12) Patent Application Publication
(10) Pub. No.: US 2024/0093895 A1
(43) Pub. Date: Mar. 21, 2024

(54) HVAC AIR BALANCE AND REPORTING SYSTEM FOR DESIGN, INFECTION CONTROL, CONTAMINATION REMOVAL, AND ENERGY CONSERVATION

(71) Applicant: LIFE BALANCE TECHNOLOGIES LLC, Pleasant Grove, UT (US)

(72) Inventors: Corey KILPACK, Pleasant Grove, UT (US); David Kelly, Plano, TX (US); Eric Laflure, Whitehouse, TX (US); Steven A. Manz, Sugar Land, TX (US)

(73) Assignee: LIFE BALANCE TECHNOLOGIES LLC, Pleasant Grove, UT (US)

(21) Appl. No.: 18/502,219

(22) Filed: Nov. 6, 2023

Related U.S. Application Data
(63) Continuation-in-part of application No. 17/327,539, filed on May 21, 2021, now Pat. No. 11,852,364.
(60) Provisional application No. 63/162,737, filed on Mar. 18, 2021.

(51) Int. Cl. F24F 11/46; F24F 11/38; F24F 11/64

(52) U.S. Cl. CPC F24F 11/46; F24F 11/38; F24F 11/64; F24F 2110/40

(57) ABSTRACT

This invention presents an integrated air and hydronic testing, adjusting, balancing, and reporting system. Comprising essential HVAC data collection equipment, data processing software, and advanced algorithms leveraging machine learning and artificial intelligence, the system analyzes building design, energy conservation, and actual conditions against infection control requirements, contamination removal requirements, and regulatory standards. The invention's methodology gathers room condition data and applies ventilation regulations and structural attributes to assess adherence to air balance standards, breathing zone requirements, exhaust rates, energy efficiency, occupational safety, infection control, and regulatory mandates.

### CROSS-REFERENCE TO RELATED APPLICATIONS

This application is a Continuation-In-Part of U.S. patent application Ser. No. 17/327,539, entitled HVAC Air Balance Monitoring and Testing System, filed on May 21, 2021, which claims priority to U.S. Provisional Application Ser. No. 63/162,737, entitled HVAC Air Balance Monitoring and Testing System, filed on Mar. 18, 2021, the entire disclosures of which are incorporated herein by reference in their entireties for all purposes.

### TECHNICAL FIELD

This disclosure pertains to the technical field of Heating, Ventilation, and Air Conditioning (“HVAC”) systems, specifically to the Testing, Adjusting, and Balancing (“TAB”) of these systems across various building types, incorporating both air and hydronic elements. The technical aspects extend to architectural design, mechanical engineering, HVAC installation, and facility maintenance. The disclosure also involves the use of software configuration, machine learning, artificial intelligence (“AI”), data modules, sensors, monitors, and calibrated handheld instruments such as airflow hoods, balometers, anemometers, tachometers, and manometers. A key application within this technical field is the reduction of hospital-acquired infections (“HAI”) within healthcare facilities.

### BACKGROUND OF THE INVENTION

Architects and mechanical engineers collaborate to design HVAC systems, aiming to provide comfortable and healthy environments. This process considers many factors such as climate conditions, heat loads, building structures, window placements, sun exposure, and specific facility uses. While heating and cooling are the most perceptible aspects for occupant comfort, there exists a wide array of other critical considerations that must be addressed. To guarantee the safety and well-being of patients, staff, students, customers, and visitors, achieving air balance in compliance with stringent parameters becomes paramount. This entails compliance with standards for external air intake, differential pressure, ventilation rates, air change rates, temperature control, humidity control, infection prevention, and other regulatory mandates.

The mechanical blueprints for a building incorporate comprehensive schedules outlining the specifications of the HVAC equipment. These schedules include details about fans and other components responsible for conditioning and distributing air, and their specifications can vary based on the design needs of the HVAC system.

Mechanical plans and ventilation schedules guide and communicate the design of HVAC systems according to regulatory standards and the intended usage of a facility. Once the building structure and HVAC equipment are in place, skilled TAB contractors evaluate and fine-tune the air balance to align with the initial design.

The preeminent authority in HVAC standards in the United States is the American Society of Heating, Refrigerating, and Air-Conditioning Engineers (“ASHRAE”). Renowned for its industry regulations, guidelines, and best practices, ASHRAE's publications span HVAC system design, operation, and maintenance, covering sectors such as healthcare, commercial spaces, and low-rise residential buildings. On an international level, the International Organization for Standardization (“ISO”) also contributes significantly to the establishment of standards, including those related to HVAC systems. ISO's standards are recognized globally, used across various industries, and play an integral role in promoting safety and efficiency in HVAC system design and operation worldwide.

TAB contractors receive certification from agencies such as The National Environmental Balancing Board (“NEBB”), The Associated Air Balance Council (“AABC”), Testing, Adjusting and Balancing Bureau (“TABB”), and National Balancing Council (“NBC”). These agencies certify the expertise of the contractors, establish equipment specifications for testing instruments, and set procedural standards for the testing, adjusting, and balancing processes.

Stationary engineers play a crucial role in maintaining building safety and adjusting HVAC systems based on sensor data. However, these professionals often lack the independent resources needed to assess compliance with comprehensive regulatory standards, particularly those related to infection control. Current TAB reports and Building Management Systems (“BMS”) or Building Automation Systems (“BAS”) frequently omit key parameters for infection control, leaving engineers without essential information to verify compliance when performing maintenance or responding to emergencies. ASHRAE 111 2008 (RA 2017) 12.2.1 substantiates this problem (Page 51, Column 1), stating, “[m]any excellent forms have been developed by various associations but are available for use by their members only.” (Emphasis added.)

Certification associations and report-aggregating companies provide rudimentary spreadsheets and PDF forms only to their members. However, these forms, whether independently created or member-produced, do not facilitate the calculation of compliance to regulatory standards nor enable pass/fail tests for all parameters. They primarily capture select conditions, which are then compared against only a few select features of the design. This limitation extends to the omission of necessary tests for parameters of ASHRAE 62.1 Ventilation for Acceptable Indoor Air Quality. The consequence of this omission is particularly evident in schools and other non-healthcare applications that require complicated formulas for correct testing. Despite TAB technicians documenting tests and adjustments to air-moving and hydronic equipment, these records frequently lack critical parameters for ensuring compliance, particularly those needed for infection control, due to the absence of a structured database system.

The TAB technician may evaluate volumetric air balances by comparing the actual cubic feet per minute (“CFM”) measured at each grille, diffuser, or hood, against the intended design specifications. Yet, the reporting of compliance with all regulatory standards is woefully inadequate. For instance, differential pressure is tested at envelope crossings for selected rooms in hospitals or healthcare facilities. However, these measurements do not holistically encompass all areas subject to infection control mandates, revealing a gaping hole in the current system. This failure stems from an archaic reliance on spreadsheets, which lack the capacity to handle a relational collection of data. This severe deficiency not only undermines the integrity of infection control but also poses an unacceptable risk to the safety and well-being of facility occupants.

In the United States, The Joint Commission on Accreditation of Healthcare Organizations, often simply referred to as The Joint Commission, performs spot-check tests tri-annually to confirm the directional airflow at envelope crossings. However, this test represents only a random audit of select envelope crossings, and does not encompass a comprehensive inspection of all such crossings.

Testing and balancing reports of HVAC systems are required for commissioning new construction and tenant improvements. These reports are more typically commissioned by general contractors and mechanical contractors, not by the building owners or commissioning agents. Intermittent, periodic, and post-occupancy TAB reporting is conducted for accreditation, maintenance, or emergency repairs, but reporting is not commonly performed alongside the implementation of a comprehensive energy conservation model for HVAC systems. This discrepancy not only carries a potential influence on breathing zone conditions and infection control within occupied buildings, but it also presents a serious threat to health and life for individuals and the public. In the absence of comprehensive, systematic, and real-time reporting, HAI's can escalate, leading to avoidable patient complications, increased healthcare costs, and tragically, loss of life. The current state of the prior art, with its gaps and limitations, fails to adequately safeguard the health and safety of those who depend most on these environments, emphasizing an urgent need for advancements in this critical area.

A ventilation schedule outlines the volume and rate at which fresh air is supplied and stale air is exhausted within a building or specific space. It primarily includes details like CFM of supply air, outside air, return air and exhaust air, room volume, air changes per hour (“ACH”), and only occasionally, efficiency factors. When preparing a TAB report for new construction or permitted tenant improvements, ventilation and equipment tables are recreated only for the rooms listed in the ventilation schedule. As a result, in the current practice, summary TAB reports may exclude certain rooms, along with the regulatory parameter tests for those rooms and adjacent spaces, if these rooms are not included in the ventilation schedule.

The ventilation schedule for a facility includes a list of room types with corresponding standards. The requirements that apply to a unique room are derived from the tables in a published and applicable regulatory standard. For example, a healthcare facility would apply the standards of 20 ACH and positive differential pressure for an operating room based on the described minimums and limits in Table 7-1 of ASHRAE 170-2021, Ventilation of Health Care Facilities (Page 15).

The ASHRAE 170 design standards for healthcare facilities include differential pressure relationships, minimum outside air changes, minimum air changes, whether the room's air must be exhausted, an allowance for recirculation of air to meet the required air changes, occupancy turndowns, filter requirements, humidity, and temperature requirements. For specific rooms, such as an Airborne Infection Isolation (“AII”) or Protective Environment (“PE”), there exist additional requirements in the footnotes detailing unique balance differential and cascade requirements.

In addition to the tabular data providing parameters for specific room types, ASHRAE 170-2021 includes this instruction as a footnote to Table 7-1 (page 20): “[Footnote] 1. Design of the ventilation system shall provide air movement that is generally from clean to less-clean area. If any form of variable air volume or load-shedding system is used for energy conservation, it shall not compromise the pressure balancing relationships or the minimum air changes required by the table.” (Emphasis added) Hence, any hospital employing an energy conservation model shall ensure it does not impinge upon infection control parameters as per the ASHRAE standards. Compliance can only be confirmed through rigorous testing and accurate reporting of every prescribed standard. This includes consideration for the relationship of a room to other areas, including those not deemed critical but still necessitating controls for airborne infection and proper ventilation.

In ASHRAE 170-2021, the regulatory standards are clarified for room types that do not appear in the healthcare standard or design Table 7-1. Examples could be administrative rooms or multi-purpose rooms that have a public health or training function. Specifically, ASHRAE instructs in footnote 2 of Table 7-1 (page 20), “[t]he ventilation requirements in this table are intended to provide for comfort as well as asepsis and odor control in spaces of a health care facility that directly affect patient care. For spaces not specifically listed here, ventilation requirements shall be that of functionally equivalent spaces in the table. If no functionally equivalent spaces exist in the table, ventilation requirements shall be obtained from ASHRAE Standard 62.1 in the absence of other codes or standards that govern those space ventilation rate requirements. Where spaces with prescribed rates in both Standard 62.1 and Table 7-1 of [ASHRAE 170-2021] exist, the higher of the two air change rates shall be used.” (Emphasis added)

The prior art, without the benefit of comparing data sets and parameters in a database module, excludes certification or confirmation that the design or actual conditions of rooms pass comparable parameter tests for healthcare and non-healthcare standards. After all, for the TAB industry, there is not a feature in the prior art, including proprietary TAB certification agency forms, for testing any of the primary parameters in ASHRAE 62.1.

Conventional air balance testing for infection control is achieved by means of manual data collection using handheld manometers and balometers. Infection control reports, including reports of healthcare facilities are incomplete. Within hospitals, the testing and balancing method and process is disruptive to medical personnel, facility managers and patients. In many cases, the potential for disruption will prevent the testing of infection control conditions. Currently, most occupied hospitals test and report the infection control conditions of a small portion of their facility.

Standards extend beyond ASHRAE 170 or ASHRAE 62.1 for healthcare facilities. As indicated in the Normative Notes for Table 7-1, Footnote b (page 18), “[p]harmacy compounding areas may have additional air changes and differential pressure requirements beyond the minimum of this table, depending on the type of pharmacy, the regulatory requirements, which may include adoption of ([United States Pharmacopeia (USP) Chapter 795: Pharmaceutical Compounding—Nonsterile Preparations, USP Chapter 797: Pharmaceutical Compounding—Sterile Preparations, and USP Chapter 800: Hazardous Drugs—Handling in Healthcare Settings]), the associated level of risk of the work, and the equipment used in the spaces.”

Healthcare is perhaps the most recognized setting where infection control is a priority. However, air balancing for infection control and safe occupancy applies to all non-residential spaces and residential facilities. There are no exceptions in schools, commercial, and public buildings, as they all have requirements for safe air conditioning and management of air flow. Commercial buildings and schools have specific calculations and standards for the breathing zone, exhaust rate, and transfer air requirements. Though, in the prior art, tests for these breathing zone and transfer air standards are excluded from TAB reports and certifications.

Published in the 2019 update to the Guidelines for Environmental Infection Control in Health-Care Facilities (2003), the Centers for Disease Control and Prevention also addresses infection control in the HVAC environment. Most urgently, in Chapter 3, Heating, Ventilation, and Air Conditioning Systems in Health-Care Facilities, Infection Control Impact of HVAC System Maintenance and Repair, the CDC states, “A failure or malfunction of any component of the HVAC system may subject patients and staff to discomfort and exposure to airborne contaminants. Only limited information is available from formal studies on the infection-control implications of a complete air-handling system failure or shutdown for maintenance. Most experience has been derived from infectious disease outbreaks and adverse outcomes among high-risk patients when HVAC systems are poorly maintained.” (Centers for Disease Control and Prevention, 2019, p. 34). It is imperative to maintain the HVAC system betimes and to do so in accordance with regulatory standards.

The Committee for the Update of the Guide for the Care and Use of Laboratory Animals, Division on Earth and Life Studies, and Institute for Laboratory Animal Research (2011) provide clear guidelines for air balancing in animal habitats and vivariums. On page 47, it states, “[t]he successful operation of any HVAC system requires regular preventive maintenance and evaluation, including measurement of its function at the level of the secondary enclosure. Such measurements should include supply and exhaust air volumes, fluctuation in temperature and relative humidity, and air pressure differentials between spaces as well as critical mechanical operating parameters.”

However, the current state of the prior art offers no structured database source, software, or integrated module to uphold and assess these critical standards. These standards are not just guidelines; they are lifelines for the care and safety of both animals and staff in a vivarium. Even though HVAC control measures may exist, without a database solution, facilities lack the necessary tools to verify and report the conditions effectively and accurately. This glaring deficiency becomes a significant roadblock in ensuring consistent compliance and effectively managing vivarium environments. It's not just about maintaining a controlled environment; it's about being able to confirm that control, and to report it reliably. The safety of the secondary enclosure—and by extension, its occupants and the integrity of the research conducted within—hinges on this capability.

Manufacturing, biochemistry, pharmaceutical, cleanrooms, laboratories, commercial office, schools, data centers, retail, and residential facilities all adhere to published standards for safe air balancing. These standards are often outlined by reputable organizations such as ASHRAE and ISO, ensuring consistent and safe practices across various sectors globally.

HVAC systems often reduce airflow in an attempt to conserve energy. This is typically done without thorough consideration of the impact on air balance or the air change requirements necessary for preventing airborne infections. With energy conservation models implemented in building management systems, failing infection control conditions can exist in occupied spaces. Absent a method for auditing air balances and conditions, the effects of conservation and the resulting reduction in air change and alteration to differential pressures remain unknown for most buildings. Many energy conservation models are enacted based on theoretical or projected HVAC conditions, with no reported verification for infection control.

Traditionally, TAB schematics of rooms and conditions are often recreated with rudimentary line drawings for select rooms, sometimes incorporating computer-aided designs (“CAD”). Fan distributions and terminal unit distributions may be represented via independent CAD recreations, or more commonly, through pen-highlighted photographic images of the mechanical drawings, scanned images, or screenshots highlighted with a PDF editor.

While these schematics or “sketches” serve as handy figures for some reports, they fall short as they do not form a structured dataset capable of determining pass or fail parameter tests based on relationships between rooms or at envelope crossings. This limitation in the data structure diminishes these reports' efficacy in accurately representing the true state of the building. Consequently, TAB contractor reports and such rudimentary schematics often lead to unreliable information and conclusions when they do not align with engineered drawings and actual conditions. This misalignment becomes a significant issue when these reports are used for verifying ventilation schedules.

Discrepancies between a projected schedule and the actual as-built conditions pose serious implications for compliance, infection control, fire and life safety, and maintenance purposes. This situation often arises when a TAB contractor omits critical ASHRAE parameter tests because the tests aren't included in a rote form, opting instead to report only the air volume at a grille. However, when the facility later needs to report actual air changes, ventilation rates, or differential pressure for accreditation, and these real-world conditions do not meet the previously untested regulatory requirements, a serious and consequential problem arises.

Recognizing these limitations presents a clear opportunity for TAB contractors to enhance their contributions to creating accurate and reliable as-built ventilation schedules. By using refined analytics and a structured database solution that accurately captures actual room relationships and envelope crossings, TAB contractors can provide data that truly reflects as-built conditions and passes all necessary standards. In this way, the TAB report can contribute to the HVAC design as prescribed in ASHRAE 111-2008 (RA 2017) Section 13 Commissioning for Test and Balances (Page 57). Further, by commissioning passing conditions that match the actual facility, information from sensors and the BAS is more reliable.

It's worth noting that TAB contractor reports are often derived from estimated room volumes and may not always incorporate as-built ceiling heights or room dimensions. The traditional forms disregard this discrepancy entirely. Complications in estimating the volumes of corridors and adjoining spaces often result in their exclusion from ventilation schedules. TAB reports, including certified examples, that rely on estimated room sizes may not reflect actual conditions. As such, calculations of air changes or ventilation rates based on estimates and unconfirmed room dimensions remain merely estimates. For a truly accurate report, all actual conditions, including exact room dimensions, should be considered.

For instance, in a ventilation schedule, an operating room might have an estimated 9-foot ceiling. If the actual ceiling height were 9.5 feet, the total volume of the room would change by 5.55%, which exceeds most tolerances for the volumetric air volume at a unique grille. Using actual dimensions might reveal a failing condition for one or more infection control parameter tests, even when the volume of air is certified by a technician based on allowed volume variation at a single diffuser or grille. In such a case, the total volume of air in the room should be balanced to pass infection control parameters, even if the balance exceeds the engineered design tolerance.

Incorporating a structured database and unique identification of all aspects of the HVAC system within the TAB report, including schematics based on the actual construction, significantly enhances the precision and practicality of these reports. When the as-built conditions and any necessary design corrections are accurately reflected in these reports, building owners can truly take ownership, ensuring occupancy of buildings that have been expertly commissioned, with infection control and ventilation conditions meeting the necessary standards.

TAB reports that neglect to include primary parameter tests lead to immediate occupancy of buildings failing to meet established standards. These buildings put forward as-built plans that are inaccurate, unsustainable, and unmanageable in the long term. Such a situation can compromise the safety and comfort of occupants and could lead to expensive and time-consuming rectifications later. Therefore, it's imperative to accurately represent and document regulatory compliance for all spaces and components of the HVAC system. This practice ensures optimal performance and sustainable maintenance of the building, elements that are as critical as the construction of the building itself

The fields of architecture, mechanical engineering, energy conservation, and infection control all need integrated tools. These tools should combine multi-disciplinary data, real-time insights, and predictive modeling to enhance decision-making and validation. Existing methods fall short in harmonizing these aspects, leading to inefficiencies and suboptimal outcomes. The limitations of current tools used for HVAC testing, adjusting, and balancing hinder the verification of compliance, efficiency, and accuracy in construction and maintenance. Without a unified database integrating design, as-built conditions, energy conservation, real-time data, and set points within building automation, the ability to control infection and maintain regulatory compliance is at risk.

### SUMMARY OF THE INVENTION

The invention improves the construction process, commissioning, retro-commissioning, and maintenance for infection control and energy conservation by creating a virtual facility using an automated data management system consisting of conventional software algorithms, artificial intelligence including machine learning or deep learning, image processing, calibrated equipment, and structured databases. The virtual facility includes the mechanical design, mechanical schematics, ventilation schedules, and regulatory standards. The system, comprising a database and an array of modules, facilitates the generation of diverse reports for both new and existing facilities. These reports encompass aspects of HVAC equipment, room configurations, grilles, and envelope crossings. The system calculates minimum volumetric measurements and ascertains pass or fail outcomes based on compliance with regulatory standards. The virtual facility can reveal regulatory compliance, including infection control and energy efficiency, to engineers, architects, permitting agencies, builders, TAB contractors, commissioning agents, infection control officers, nurses, teachers, administrators, and building owners.

In multiple embodiments, explained in this summary, the invention includes five modules construed as functional blocks of a computer(s) and database(s) for receiving and combining specific data:
Data Integration Module (“DIM”)
Construction Design Module (“CDM”)
Energy Conservation Module (“ECM”)
Condition Monitoring Module (“CMM”)
Integrated Monitoring Module (“IMM”)

An embodiment of the invention introduces a Data Integration Module. The DIM serves as a tool that amalgamates diverse data sets, encompassing building specifications, HVAC equipment specifications, design condition measurements, energy conservation designs, and regulatory standards, into cohesive and structured databases. These databases are then strategically utilized in the execution of air balance designs, air balance testing, and airborne infection control testing and reporting. Design condition measurements refer to the quantified airflow specifications laid out in the detailed mechanical blueprints of a building, illustrating the anticipated conditions of airflow and balance.

A process to integrate building specifications with infection control and regulatory standards includes entering data from available life safety and mechanical drawings. The DIM provides the ability for a user to create a virtual representation of a building and rooms within it. A virtual representation can be built with the creation of a digital polygon structure outlining a digital image of every room. A digital polygon structure is a set of coordinates that relate to the location of a room or corridor on an image of available life safety, mechanical drawings or two-dimensional schematic of a building or room. The assigned coordinates are stored within a database, or varied databases, as part of the data set for the room or corridor. The relationship of the room to every adjacent room or corridor is part of a data set that the DIM uses to report and audit infection control and air balance conditions.

The DIM preprocesses published standards and mechanical plans, or blueprints, by digitizing the drawings into a machine-readable format. Each drawing becomes a collection of points representing walls, doors, and other architectural features. The second data of annotated mechanical or life safety drawings that include room boundaries may require reprocessing to stitch multiple images together to create a single representation of at least one of floors, zones, or distributions of air moving equipment. Each room's boundaries and corners on the digitized drawings are annotated manually until the DIM software is trained to replicate the steps. The rooms, represented by the polygon shape, are annotated with unique identifiers that associate them with their corresponding sets of coordinates.

The objective of a manual process for creating the polygon room structure is to instruct the DIM software to autonomously map rooms derived from mechanical or life safety blueprints by harnessing the power of machine learning algorithms. This methodology replicates the steps taken by a human operator, thereby allowing the software to comprehend and emulate the task of generating polygons and assigning distinct identifiers to each room or passageway. It's important to note that the training regimen for the DIM software isn't a one-size-fits-all approach. Rather, it's tailored to the specific characteristics of different blueprints, accounting for variations such as line thickness, patterns of envelope intersections, room numbers displayed in diverse fonts or offset from the room, and room descriptions.

Training the DIM software includes extracting relevant geometric features from the annotated data. These features can include the coordinates of the room's corners, arcs, the aspect ratio, and any other geometric properties that can aid the machine learning process. In addition, the DIM can derive features of the rooms that are factors in air balance, infection control, and fire safety, including room and corridor identification, direction of door swings, double doors that may have magnets, exhaust units such as toilets and showers, function of space or room descriptions, fire containment walls, fire smoke dampers, and irregular envelope crossings such as cart washers and sterilizers.

The DIM software employs a Convolutional Neural Network (“CNN”) for image-based data and a Polygon Regression Model for coordinate-based data. This data is systematically segmented into training, validation, and testing subsets. The purpose of this partitioning lies in training the chosen model using annotated data, with the goal of accurately predicting the coordinates of room boundaries based on the extracted features. This bifurcated approach allows the software to effectively learn from and apply knowledge to different types of data, enhancing its overall performance and versatility.

Validation of the DIM software's ability to accurately predict room boundaries on drawings is tested through the reporting features of the DIM, including the production of pass or fail tests for TAB parameters. Improvement of the boundary recognition and room designation within the refined model is continuous as the dataset builds. By replicating the manual room mapping, or polygon creation, process through machine learning, the DIM learns to autonomously identify and map room boundaries on mechanical and life safety drawings.

The process begins with AI methods specifically designed for scrutinizing mechanical plans. These methods map digital polygon structures that represent rooms within a building, effectively replacing the traditional manual process of room mapping. The AI extracts and processes various features, such as room functions, balance and pressure requirements of adjacent rooms, zone designations, floor designations, and locations of connected HVAC equipment.

The building specifications also include the location of doors and pass-through windows, also referred to as envelope crossings, as well as the types of these envelope crossings. The relationships to adjacent spaces, which are represented in the DIM as polygons, may be received into the DIM from AI extraction or input via the system's software. This software maps the entire distribution of a system, including every single register and every single envelope crossing.

Once the AI has scanned the rooms and identified their features, the DIM applies the regulatory standards from its database to these features. These might include parameter tests like air changes and ventilation rates, which are dependent on a room's function, zone, and other features.

Room specifications within the building may be acquired through manual methods and entered into the software for HVAC parameter tests based on actual dimensions. These dimensions, which are only estimated in mechanical drawings, include ceiling heights, square feet and cubic feet. The DIM can store estimated building specifications and actual specifications for comparison and for calculations at various phases of design, construction and retro commissioning. More specifically for dimension specifications, the DIM operator can enter dimensions of a room taken with lasers and adjust for irregularities in the room that increase or decrease the total room volume. Reports can extract those values and compare the actual room volume to the estimated room volume from the mechanical drawings.

The DIM applies unique naming conventions to every room, register, envelope crossing and all HVAC equipment, but provides the ability for a user to accommodate the existing conventions for a particular building. It is not uncommon for a room to have different room numbers in different data sets. The original room number on a mechanical drawing or life safety drawing may not match the room number posted at the room or within the BAS. The unique identification of the room also accommodates duplicate room numbers within a facility or distribution.

The room use, or designation, is digitally matched to the corresponding standards data for required air balance. In an embodiment of the invention, a room may have multiple room use designations for unique regulatory standards. For example, a room may have multiple designations in standards published by ASHRAE, including ASHRAE 170 and ASHRAE 62.1.

Room specifications are included in the associated digital polygon structure, so schematics, for reporting purposes, can be filtered for different views and applications. Schematic filters include, but are not limited to, fan distributions, registers, ducts, dampers, thermostats, sensors, and directional pressure requirements.

Current conditions may be retrieved digitally from the database outlined in other embodiments of the invention. Current condition measurements from sensors may include airflow, static pressure, temperature, humidity, and differential pressure values retrieved from sensors within the building. Current condition measurements also include airflow, static pressure and differential pressure retrieved by calibrated handheld instruments, including air flow hoods, balometers, and manometers.

In an embodiment, the invention integrates the HVAC equipment specifications and locations of the air handler units, fans, variable frequency drives, duct systems, terminal units, and grilles. The DIM will compare the air handler fan capabilities, including the fan speed, to the distribution of the air throughout the HVAC duct system. The DIM overlays the HVAC equipment locations with the digital polygon structure and stores the image within a database(s).

The DIM incorporates various regulatory standards for air balance and infection control. These standards encompass a wide range of guidelines, including nationally recognized standards like those published by ASHRAE, regional regulations such as the California Mechanical Code (“CMC”), and various federal guidelines. Federal guidelines that impact mechanical systems include the U.S. Department of Energy (DOE) standards, Occupational Safety and Health Administration (OSHA) standards, Environmental Protection Agency (EPA) regulations, and Americans with Disabilities Act (ADA) standards. Additionally, the DIM adheres to stringent mandates set by healthcare authorities like the Health Care Facilities Division of the Office of Statewide Health Planning and Development (OSHPD) in California. The comprehensive incorporation of these diverse standards shapes a holistic framework for air balance and infection control.

In an embodiment of the invention, the DIM embeds both past and present regulatory standards into its database. Although previous editions of standards may be superseded by more recent versions, they can be converted into a structured format such as a comma-separated value (CSV) file and incorporated into the database. Simultaneously, the DIM is equipped to integrate contemporary standards through various data integration methods. A significant advantage of this approach is that it enables a comparison of infection control conditions against both design parameters and contemporary standards, ensuring a comprehensive analysis and evaluation.

Regulatory standards are applied uniquely based on the room designations of a building. In an embodiment of the invention, each room has at least one unique designation within at least one standard while various standards may be applied to a building based on the date of construction, permitting, or commissioning of the unique rooms. A facility that was originally built in 2008 but was renovated in 2022 may require multiple standards to be used for the TAB reporting for infection control or energy conservation. The DIM can apply standards to whole facilities, or uniquely by room. Infection control parameter-test requirements within regulatory standards include, but are not limited to, Minimum Air Changes per Hour (“MACH”), Minimum Outside Air Changes per Hour (“MOACH”), Directional Pressure, Balance, Exhaust Rates, Transfer Air, Temperature, Humidity and Balance Differential.

In an embodiment, the disclosure has the capability to generate a variety of air balance and infection control reports, such as Design Reports, Commissioning Reports, Air Balance Reports, Infection Control Reports, Equipment Profile Reports, and Technician Worksheets. This embodiment also incorporates technician certifications and testing HVAC equipment calibration certificates, ensuring they are in compliance and can be inserted into reports.

The system allows for the creation of custom and automated reports, in addition to the ones mentioned. These reports can be comprehensive, including summary tables of all rooms, detailed analyses of individual rooms, and schematic visualizations of findings. Furthermore, report generation can be tailored to selected filters, including but not limited to zones, buildings, projects, fan types, floors, public accessibility, infection control measures, HVAC equipment, room applications, critical care areas, pass/fail results, and specific parameters.

This report generation feature plays a crucial role in periodic compliance filings, suggesting repair actions based on identified failures, facilitating audits, inspections, and document reviews by accreditation and permitting agencies. Importantly, reports can be generated in formats compatible with Building Information Modeling (“BIM”) systems, HTML, CAD, and PDF. This provides users with the flexibility to integrate the reports directly into their BIM workflows or print them as needed. The integration with BIM systems ensures that the information contained in the reports can be effectively utilized in the design, construction, and maintenance of buildings, thereby enhancing the practicality and impact of the system.

In addition, in this embodiment, the report generation feature may display infection control parameter-tests based on revised building design or newer standards. This aspect of the reporting feature can be utilized for predictive modeling for new construction, repairs, and improvements. Predictive modeling, in respect to this embodiment of the invention, is the ability to input theoretical regulatory standards, room specifications, airflow, and differential pressure condition measurements within the virtually mapped buildings and analyze the results displayed in the generated reports.

In one embodiment, the invention encompasses a Construction Design Module. As initial data, the CDM receives the architectural and mechanical plans of a new or existing building. It also obtains the construction scope of work and instructions for TAB reporting. The combination of the DIM and CDM evaluates the design during the preconstruction phase and creates a precise virtual model of every room, grille, and envelope crossing. This iterative process, capable of generating multiple reports, allows for proactive amendments during the pre-construction phase. One of the critical features of this process is the DIM's predictive capabilities, which extend to identifying individual grille variations and delivering pass or fail results based on a thorough set of standards and building codes. A significant outcome of this collaboration between the DIM and CDM is the production of accurate, or true, as-built drawings after construction. These drawings can now include actual room dimensions, tested air volumes, and differential pressures, that strictly adhere to ASHRAE and other regulatory standards.

An advanced training dynamic exists between the DIM and CDM, equipping engineers not just to predict the necessary CFM for infection control, but also to understand how this CFM correlates with differential pressure. Through a correlation of every HVAC feature associated with the polygon structure of the DIM, this feedback to the CDM specifically includes data that connects CFM with differential pressure, enhancing the predictive capabilities. This shared training allows engineers to optimize CFM configurations more effectively while meeting or exceeding infection control requirements, ensuring a more efficient and safer environment.

In an embodiment, the invention includes an Energy Conservation Module. The ECM receives, as first data, energy conservation designs, parameters, HVAC set points, and specifications based on prescriptive energy models. The invention contemplates a comprehensive system and method that integrates the DIM and ECM to achieve optimized facility design, adherence to infection control, energy efficiency, and validation. The energy models integrated within the ECM are distinct in nature, as they do not originate as proprietary ECM assets. U.S. Pat. No. 11,371,733 B2 to Bullock (“Bullock”) describes an energy conservation model. Bullock explains (Column 1, Line 56), “The instructions include a set of optimized subsystem set points that are fed back to each subsystem to improve operation and increase total efficiency.” Further (Column 1, Line 65), Bullock “optimizes the set points and sends them to controllers of each subsystem to change operation of the system.” (Emphasis added)

The ECM receives this first data and instructions from external energy models and which is used to model and analyze the HVAC system components for infection control and breathing zone parameters based on actual conditions received from other modules. This first data interacts with the DIM, which assimilates the second data. Thereby, the DIM forms the foundation for interplay with the ECM to enable subsequent optimization efforts.

In this embodiment, the DIM processes occupancy rates, environmental conditions, and architectural nuances and similar data. The ECM complements the DIM by utilizing the dataset to execute predictive analyses and simulations for energy conservation based on the architectural blueprint and dynamic inputs. The external energy conservation model pinpoints HVAC optimizations, including adjustments to components like fans, air handling units, and temperature set points.

Looking specifically at items 132, 142, and 144, Bullock describes ventilation system 132 as being connected to router 122 (Column 4, Line 7) and including one or more vents, fans, and servo motors to control pressurization and airflow in one or more buildings. Ventilation System 132 can be controlled by HVAC server 114 through commands routed via system network 118 (Column 4, Line 16). FIG. 1, on page 2 of Bullock, shows ventilation system 132 including subsystem 142. In one embodiment, subsystem 142 provides ventilation for a floor of a building served by ventilation system 132. Ventilation system 132 is also described as including zonal systems 144. In an exemplary HVAC system of Bullock (Column 3, Line 62), “one embodiment, ventilation system 132 of HVAC system 104 provides ventilation for an entire building, subsystem 142 provides ventilation for a floor of a building, and zonal systems 144 are terminals that provide ventilation for defined spaces within the floor of the building.”

In summary, within Bullock, ventilation system 132 controls overall building ventilation, with subsystem 142 handling a floor level and individual zonal systems 144 controlling defined spaces or zones within the floor. Each component can include its own sub-elements like vents and fans to distribute and control airflow at different architectural levels. In an embodiment, the ECM receives the instructions for control of systems and subsystems as first data. In this example, the Bullock model that generates the instructions, or parameters, resides within the invention of Bullock.

U.S. Pat. No. 11,416,739 B2 to Qin (“Qin”) describes in FIG. 15 (Column 15, Line 40) “the system being optimized is an exemplary HVAC system comprising a water system 194 and an air system 196.” The room image represents the solution space of control parameters for the HVAC system as Qin (Column 15, Line 39) indicates “FIG. 15 depicts a presently preferred embodiment for configuring the particle swarm optimization algorithm.”

FIG. 14 of Qin illustrates how the particle swarm optimization is integrated with the neural network. Qin explains the model receives parameters and then provides instructions where (Column 15, Line 47) “[t]he operation parameters set points 140, represent the collection of controlled parameters within the HVAC system (or other system associated with the structure). These parameters are fed as inputs to the neural network 142, which in turn supplies control instructions to operate the HVAC system (emphasis added) 38. Concurrently, the operation parameters set points 140 are supplied to the EnergyPlus simulation models 144, which generates simulation results 146 that are fed to the particle swarm optimization process. As illustrated diagrammatically at 150, the results 146 are mapped onto a topological space 150 having points that correspond to specific operation parameters within the HVAC system 38. The particle swarm process finds the optimal settings for these operation parameters, to achieve the optimally efficient HVAC system.”

In an embodiment of the invention, the operation set points of Qin or any similar operating set point, which are identified as 140 in Qin, and the results of simulation which are identified as 146 in FIG. 14, are received as first data within the invention's ECM. The simulation within a model, identified as 144, resides within the invention of Qin. The ECM receives the first data and reports the simulation for rooms and corridors, including parameter tests and volumetric measurements for rooms, registers and envelope crossings within the distribution of the affected area.

Qin explains (Column 16, Line 7) that “[t]he particle swarm optimization process 148 takes as inputs a collection of operating parameters of the HVAC system at work. These might include air pressure set points, inside and outside temperature set points, air flow set point, cooling water flow set point, circulating water flow set point, and the like. The particle swarm optimization process assesses the whole system energy consumption achieved for these set points and discovers the minimum energy consumption, giving a predefined set of constraints. These constraints may include, for example, occupant comfort parameters, such as temperature, humidity, ventilation, and the like. The particle swarm, in essence examines how the system as a whole behaves when the individual control parameters change over their allowable ranges. To do this, the particle swarm optimization process 148 uses the results 146 as generated by the simulation models 144. As illustrated in FIG. 14, these simulation models generate results 146 given the operation parameter set points 140 as inputs. Thus, the optimizer is discovering the optimal operation parameter set point settings for a particular set of conditions (weather, structure occupancy, etc.).”

In an embodiment of the invention, the ECM receives the set points described by Qin as first data. The models, benefiting from the particle swarm process, reside both externally and within Qin's invention. Instead of operating Qin's model based on simulation, these models stand to gain from the actual verified conditions. These conditions include the actual verified infrastructure design and regulatory compliance, returned and reported back to the ECM as third data.

The DIM module within the new invention reports the simulation of the set points based on parameter tests, standards and design features that reside outside of the Qin model and within other modules of the invention. Reports of the actual, non-simulated, effects of the prescribed set points are reported independently of the Qin model, or similar models. The uniqueness of the invention, and of Qin's model and prescribed set points, is highlighted by the application described by Qin (Column 18, Line 10): “In the experiment, the AICS system calculated and recommended to regulate static air pressure set point from 0.25 to 0.20 [IWC]. The experiment produced three-months of data. The experimental test of the AICS system shows that the test structure supply fans' electricity consumption could be reduced by about 5%-10%, by reducing Static Air Pressure Set Point and setting all supply dampers almost fully open in the highest load. (Emphasis added) FIG. 23 (Qin) showing experimental data results shows that the supply air fan setting based on the AICS recommendation could produce average energy and maximum energy savings. The AICS system analyzes operation data of the test structure automatically. Most of supply air damper positions are between 30%-60%, VFD air supply fans run at 100% speed most of time. The results show there is a potential energy saving for the test structure. The AICS recommends reducing the test structure static air pressure set point. Based on the static pressure set point of the test structure control logic, the AICS establishes the test schedule for performing an optimized energy efficiency method. Using the AICS-established schedule, the supply static pressure set point was reduced, step by step, to make the most of the air supply damper. In this way an area or office operation position between 90%-100% was achieved, to reduce air pressure energy loss at these dampers. By monitoring the speed of each VFD fan, the VFD air supply fans will work under 100% load and regulate to the suitable values to match the static pressure set point.”

In this example of an experiment in Qin, there are multiple set points or instructions made to the HVAC system, including fan speed, damper settings, and outside air mix rates. These set points are sent to the HVAC system and each have a potential impact to the outcome for air changes and ventilation rates within a single breathing zone or many zones. In an embodiment of the invention, the ECM receives the set points from the model described by Qin, or a similar invention, as first data. The data is evaluated for effects within the breathing zone and measured against the design standards and room function of each space, considering every grille and every envelope crossing. A report of the air changes, ventilation rates, and exhaust rates is provided based on the regulatory standards. This is particularly crucial for infection control and occupied buildings where a single change to a damper position or outside air economizer within an HVAC system may compromise the conditions of one or more unique rooms.

The intricate orchestration of the ECM, DIM, and CDM constitutes a specialized system, leveraging predictive modeling and data integration for facility design. This integration includes the ventilation standards for each room, a feature that is omitted from the Bullock and Qin inventions, including every envelope crossing and applicable regulatory standard(s) at the room and corridor level. The DIM is the neural hub interfacing the predictive energy conservation models with the CDM's architectural insights and the operational reality. Thereby, the DIM demonstrates that energy conservation, infection control, and compliance can coexist through an equilibrium of analytics, calibrated by the ECM and validated by the DIM where actual measurements, room use, standards and design infrastructure are received as first data. This triad underscore's the DEVI's potential to unite seemingly disparate goals, optimizing infection control, air balance, and efficiency.

The realm of hospital infrastructure, particularly in critical spaces like catheter labs, stands as a prime example of the impactful connection between healthcare standards and energy conservation. In 2016, these spaces necessitated 20 air changes per hour, as stipulated by 2016 California Mechanical Code, Table 4-A (page 73). However, this requirement was subsequently revised to 15 air changes per hour in 2019 California Mechanical Code, Table 4-A (page 73). This shift not only underscores the dynamic nature of healthcare norms but also highlights the potential for conservation within regulatory standards.

In this embodiment, the invention introduces a validation mechanism encompassing pre-reporting and post-reporting. The DIM receives data from the ECM and can generate an infection control report based on the regulatory parameters, including every register and envelope crossing. In the pre-phase, DIM embodiments generate TAB reports based on the predictive energy conservation model. In the post-phase, actual conditions are confirmed through rigorous analysis of sensor data, monitoring systems, and precise technician interventions.

Notably, within this embodiment, another pivotal feature emerges. The dynamic and bi-directional interaction between the DIM, host to regulatory standards, and the ECM, prioritizing energy savings, engenders a dynamic training environment for machine learning and AI models for the source of the ECM first data and for the DIM.

In addition to reporting on the effects of set point instructions, the ECM may also provide the certified air balance report to the model, which may include damper positions. While Qin is correct that a closed damper position can increase static pressure, changing the damper position may alter the distribution of air. When a room or zone is balanced, the dampers begin at a fully open position, and are systematically and methodically adjusted in sequence, starting from the grille locations furthest from the terminal unit. These positions are recorded, and the air distribution is certified with the CFM volume and distribution. The recorded data, which could be beneficial to Qin and others, should indeed be considered in conservation algorithms. However, changing damper positions to reduce static pressure without considering all parameters may not be the right approach, particularly in schools and hospitals. The subjects of proportional balancing and regulatory instructions for damper settings will be discussed further.

In another embodiment, the invention includes a Condition Monitoring Module. The CMM collects and transmits static pressure, temperature, humidity, and CFM readings within ventilation systems and room envelope crossings for use in infection control parameter-testing.

In an embodiment, the CMM connects to sensors at the fans, terminal units, and at the envelope crossings within rooms with negative or positive pressure balance requirements outlined in the regulatory standards. Connection can be achieved through wired connections, or the transmission of wireless communication signals to localized revisers throughout the building, which connects to a structured database, or varied databases. Transmitting the current conditions measurements to a database allows for expedient access, extensive data storage, record keeping, analysis capabilities and usage by the DIM for infection control parameter-testing. The data transmission interval from the sensors can be based on BAS data transmission intervals that align with established condition monitoring for energy efficiency, smoke, fire, temperature control, and any relevant comfort or safety features.

In an embodiment of this invention, sensors that reside within a separate system, as described in US Patent Application Publication No. 2016/0061477 A1 by Schultz et al. (“Schultz”), transmit data to this invention's CMM as first data. Schultz's application in Paragraph outlines a sensor network configuration, which can be a local or public network (e.g., Internet). The system described by Schultz utilizes Software as a Service (“SaaS”) to receive, process, and analyze the sensor data, and potentially take actions based on the processed data. Specifically, one SaaS component might receive and filter sensor data, and its output could be passed to another SaaS component that performs statistical analysis on the filtered data. In this context, the processed output from Schultz's system, including the sensor network or a similar network configured with embedded programs and models, is considered as ‘first data’ and is received by the CMM. This setup clearly delineates the boundary between the sensor system of Schultz's application and the invention's CMM, emphasizing that the CMM's role is to receive and further process the filtered and analyzed data output from Schultz's sensor network.

As acknowledged by the Examiner in the Notice of Allowance of the parent application (issued Aug. 8, 2023), the sensor information from Schultz or a similar invention is relayed by the CMM to the DIM for analysis based on parameters within the DIM as well as parameters received as second data from other modules. This analysis by the DIM extends beyond mere

statistical comparison relative to a threshold, as described in Schultz (Paragraph [0102]), “Reports may display information such as, but not limited to: real-time raw sensor data, real-time processed sensor data, historical raw sensor data, historical processed sensor data, analyzed data, thresholds, alarms, location, time, calibration data, statistical data, recommended values for alarms, thresholds and/or other parameters, and/or the like.” The CMM and DIM receive first data from Schultz, based on the raw data gathered by external sensors. Schultz explains further, that the information is intended to be received, processed, and in some embodiments, returned to the sensors. Significantly, Schultz's invention does not preclude the novelty of the current system. In fact, Schultz's intent was to make data available for external inventions. Schultz specifically states (Paragraph [0102]) that “[r]eports may be configurable or standard. Reports may be based upon templates. Reports may be created on a local device, created on an external device, created using information and/or data from an external device, a combination thereof, and/or the like. Similarly, reports, in part or in whole, may be communicated to an external device and/or received from an external device.”

The first data is received from Schultz which exists externally to the invention, and then used to report infection control and energy conservation that consider every register or envelope crossing and regulatory standards. Reports of the facility include the mapped and reported conditions of volumetric air balances within design and certified conditions. This is of upmost importance for rooms, registers and envelope crossings that are downstream of a sensor where balances, pressures, and transfer of air must meet regulatory standards.

Proportional balancing is a multistep process used to verify air distribution systems are delivering design quantities of supply, return, or exhaust design quantities of air as intended. ASHRAE 111-2008 (RA 2017) describes the proportional balancing process for varied types of duct systems. In a multizone system, 9.6.2 (a) (Page 43, Column 1) begins with “all fans associated with the system operating at or near their design speeds.” 9.6.2 (f) explains the process of balancing the zones, culminating with 9.6.2 (f) (9), “[a]t the completion of balancing of a multi-zone system, the following conditions should exist: (a) At least one outlet balancing damper will be fully open on every zone [; and,] (b) At least one zone balancing damper will be fully open.” Similar instructions apply to different types of duct systems. This aspect of balancing zones, particularly in schools and in healthcare facilities, must be considered in all applications of energy conservation within an HVAC system. While more than one zone (also called a branch) damper, and more than one outlet damper, may be fully open, the concept of proportional balancing sets the minimum at one with the expectation that most others will have a fixed partially-closed set point.

By systematically collecting multifaceted data and correlating findings as prescribed by ASHRAE 111-2008 (RA 2017), proportional balancing confirms distribution loads are apportioned appropriately throughout the air distribution chain, from air moving unit to terminal unit to individual grille. This ensures load-based airflow modulation functions as intended to condition spaces under changing thermal demands.

In addition to translating sensor readings into assessed room-level parameters, the DIM is able to produce comprehensive schematic reports as key output. Leveraging its virtual representation of the building established with proportional balancing, the DIM retains differentiated mappings of each individual HVAC component down to the grille level. Each component is assigned unique identifiers and characteristics as initial data during proportional balancing. When processing real-time sensor readings from the CMM, the algorithms within the DIM can reference the identifier correlated to each sensor's physical location within the building and within HVAC system models. This allows the DIM to associate measured values directly to the specific register, Variable Air Volume (“VAV”), air handler, etc. that each sensor is monitoring, including instances where the sensor is upstream of a grille and sensing the volumetric air at a terminal unit.

By amalgamating real sensor data with its differentiated component mappings in database structures, the DIM generates detailed schematic reports represented within a single virtual view of all rooms. These reports effectively rebuild the constructed environment digitally, with every singular register visualized and quantified. Airflow is depicted for each grille based on the sensor-linked initial data and ongoing measurements populating the schematic. Standards-driven infection control evaluations are also overlaid, assessing conditions room-by-room and component-by-component. This multifaceted yet cohesive reporting capability stems directly from combination of mapping precision and verified proportional balancing. It transforms raw data into a comprehensively visualized validation and troubleshooting tool for ongoing commissioning, maintenance, emergencies, conservation, and improvement.

In another embodiment, the invention includes an Integrated Monitoring Module. Most commercial buildings utilize Building Automation Systems, which are employed to monitor vital safety measurements (e.g., fire alarms, smoke detection, etc.) and to control the temperature, humidity, and airflow throughout the building. A majority of these BAS have integrated energy efficiency algorithms, which are designed to optimize energy consumption while maintaining the design settings for temperature, humidity, and air volume. Similar to the configuration as described in Schultz, a BAS collects data from sensors and optimizes the set points within an HVAC system. These BAS set points govern the volumetric air distribution for fans and terminal units. In combination with the HVAC distribution system, these set points influence the conditions within a room, including factors such as the output of supply registers and the intake of return and exhaust registers.

The BAS, in this embodiment of the invention, does not connect directly to the DIM or a database(s) within the DIM. This distinction sets the BAS as a standalone external feature within the configuration of a building's operating system. The controls, algorithms and parameters of the building's operations reside within the system of the BAS.

The first data received by the IMM from the BAS is relayed to the DIM as second data for reporting that includes the first data of the DIM and the second data from the CDM, ECM and CMM. In this embodiment, set points that communicate the intent or design of the BAS, along with actual values from sensors or monitors within the BAS, are relayed to the IMM as first data. This data is processed within the DIM as second data for the generation of reports based on pass or fail parameter tests.

The structure of the IMM and of the independence of the BAS is best illustrated by an example. The BAS could receive an alarm that an exhaust fan serving an operating suite has failed. The IMM would receive that information and then relay to the DIM for processing along with the virtual representation, unique rooms including every HVAC feature of the room, and also of the entire distribution of the failing fan. If the fan was serving both a general operating room and a bronchoscopy procedure room, it would be immediately revealed that the operating room could continue procedures with positive pressure, positive balance, mandatory air changes and conditioned air. Simultaneously, the bronchoscopy room would be failing the regulatory requirements for air changes, mandatory exhaust, negative pressure, and negative balance, and would not be safe for procedures. The reporting feature of the DIM, including all parameters for infection control, provides information for the use of the rooms in emergencies and unexpected scenarios. In this example case, the nursing staff, operating staff, stationary engineers and facility managers are equipped with real-time data to make decisions for the health and safety of the occupants. This report, including the distribution of air to the grilles and the relationship of the spaces at every crossing, is critical to proper care and decision making.

In addition to pressure and balance, reports of the distribution of air within a room or zone that display every register and envelope crossing can provide immediate information for failing conditions involving distribution and temperature. If a return fan serving a Neonatal Intensive Care Unit (“NICU”) were to fail, the air within the distribution may not benefit from the conditioned returned air temperatures. While the NICU may still pass air change, pressure and balance parameters, decisions could be made immediately to avoid risks for vulnerable patients where temperature may be a concern. Reports based on infection control parameters provide actionable information that exceeds the alarms for CFM and static pressure changes. Only reports that are prepared with room and regulatory features can generate test results that honor the infection control intent of the HVAC design.

The IMM integrates calculations that consider current conditions measurements, HVAC equipment specifications, HVAC equipment performance and regulatory standards. The IMM provides infection control parameter-testing and report generation on-demand for an integrated BAS, allowing tracking of infection control conditions within rooms, rather than just the fan or terminal unit conditions. If a room fails its specific air balance, air change or differential pressure requirement, a suggestion of how to remedy this condition, along with failed room information, is relayed for display within the BAS. Air balance and infection control failure notifications are then sent to the building's engineers or other designated personnel. General information contained in the notifications may consist of the location, time and type of parameter failure that occurred within the building.

In another example, with the distribution of registers mapped and reported within a polygonal relationship system, it is possible to identify which operating rooms are the first and most susceptible to infection control failures in emergencies and in cases where there is filter loading at the fan. In these cases, the reporting features, using information from every room and register, can identify terminal units to adjust, making rooms readily available for trauma cases while taking other rooms offline. This level of decision making is only available with parameter-based reporting of real-time conditions.

In an embodiment of the IMM, the notification contains information concerning how to remedy the failing condition. An example of this is the display of excess or deficient supply or exhaust CFM and insufficient air changes per hour within rooms connected to a shared terminal unit. The information in the notification will allow the troubleshooting and adjustment process to occur much more efficiently. Following the digital notification, the BAS, as an independent standalone feature, would adjust the VAV or Constant Air Volume (“CAV”) terminal units to optimize the airflow needed to meet the required standards. Upon implementation, a process that presently spans days or even weeks can be expedited, reducing the duration to a matter of hours or minutes, and in some instances, achieving near-instantaneous results.

The combination of embodiments revolves around the invention's modules to integrate the data for facility management, infection control, energy conservation and architectural optimization. The existing BAS further amplifies the scope of insights within the DIM and the embodiments. The DIM is the central repository that processes comprehensive reporting—an essential function that encapsulates conditions, compliance, and efficiency in detail, including schematics for all features of a room's HVAC and structural specifications, including every grille and every envelope crossing. These reports serve as the lifeblood of the system, presenting a multifaceted view of the facility's indicators, concurrently revealing its regulatory alignment, energy efficiency, and adherence to infection control standards.

### BRIEF DESCRIPTION OF THE DRAWINGS

FIG. 1 illustrates the system components, encompassing five modules: Data Integration, Construction Design, Energy Conservation, Condition Monitoring, and Integrated Monitoring.

FIG. 2A illustrates the system components and their data sources, including raw, first, second and third data where the third data consists primarily of reports.

FIG. 2B illustrates an example of the first data within the system components, forming the basis for infection control, air balance, energy conservation, and operational optimization processes.

FIG. 3 illustrates an example of the mapping process for a virtual room in the Data Integration Module, serving as a foundation for infection control testing and reporting.

FIG. 4 illustrates an example of virtual polygon structure mapping within the Data Integration Module.

FIG. 5 illustrates an example of the mapping process for envelope crossings of a virtual room within the Data Integration Module.

FIG. 6 illustrates an example of virtual envelope crossing designation within the Data Integration Module.

FIG. 7 illustrates an example of the mapping process for grilles, diffusers and registers of a virtual room within the Data Integration Module.

FIG. 8 illustrates an example of the designation of grilles, diffusers, and grilles within the Data Integration Module.

FIG. 9 illustrates an example of an air changes per hour test in the Data Integration Module parameter test algorithms, assessing compliance with air change requirements for infection control.

FIG. 10 illustrates an example of an outside air changes per hour test in the Data Integration Module parameter test algorithms, assessing compliance with outside air change requirements for infection control.

FIG. 11 illustrates an example of a differential pressure test in the Data Integration Module parameter test algorithms, assessing compliance with air differential pressure at all envelope crossings.

FIG. 12 illustrates an example of a balance test in the Data Integration Module parameter test algorithms, assessing compliance with air balance that determine directional airflow. This test includes features required for reporting compliance with ASHRAE 170 and the California Mechanical Code.

FIG. 13 provides an example of breathing zone tests in the Data Integration Module's parameter test algorithms. Based on ASHRAE 62.1 standards, equations, tables, and parameters, these tests assess the quality and quantity of air in the occupant's breathing zone.

FIG. 14 details an exhaust rate test as part of the Data Integration Module's parameter test algorithms. This test ensures that the amount of air being exhausted from a room exceeds the minimum volumes established by ASHRAE 62.1. The figure includes the parameters for reporting these tests, providing a clear understanding of the methods used to assess the exhaust rate.

FIG. 15 illustrates the process for a transfer air test as part of the Data Integration Module's parameter test algorithms. This tests the exchange of air between rooms of different air classifications for compliance with the standards set by ASHRAE 62.1.

FIG. 16 illustrates an example of a contaminant removal test as part of the Data Integration Module's parameter test algorithms. This test calculates the time required for a room to be safely reoccupied after exposure to an airborne virus. The parameters for determining this are based on guidelines published by the Centers for Disease Control. It serves an essential role in maintaining safe environments in healthcare settings where exposure to airborne viruses or contaminants is known.

FIG. 17A illustrates an example of an HVAC configuration with return air. The Condition Monitoring Module receives first data from sensors that are included in this configuration.

FIG. 17B illustrates an example of an HVAC configuration with exhaust air. The Condition Monitoring Module receives first data from sensors that are included in this configuration.

FIG. 17C illustrates an example of an HVAC supply air configuration with branch, VAV/CAV and outlet dampers.

FIG. 18 illustrates an example of the test cycle of first data received by the Conditioning Monitoring Module. The Data Integration Module tests all healthcare and non-healthcare parameters based on second data received from the Condition Monitoring Module.

FIG. 19 illustrates an example of the test cycle of first data received by the Integrated Monitoring Module. This process includes interaction with a Building Automation System and the transformation of monitored features into room-specific reports. This figure delineates the systematic and algorithmic approach followed by the Data Integration Module.

FIG. 20 illustrates an example of table and data interactions within a relational database, serving as the foundation for organized data storage and retrieval. Data is organized into primary tables, including infrastructure data, regulatory standards data, TAB processing data, and actual HVAC conditions.

FIG. 21 illustrates the report generation feature within the Data Integration Module, illustrating the process of compiling and formatting data for air balance reports. Filters for facility-specific data, report type, and end users are incorporated in the software view.

FIG. 22 illustrates the result summary feature within the Data Integration Module, illustrating an overview of room-specific air balance test results based on ASHRAE 170 and California Mechanical Code parameters, as seen in the module's Report Preview.

FIG. 23 illustrates a summary table feature within the Data Integration Module, compiling key air balance parameters tests and actual conditions. The report preview features test results for individual rooms.

FIG. 24 illustrates a room schematic feature within the Data Integration Module, displaying both design CFM and actual CFM values. This feature is most often used for new construction and is required for energy conservation as mandated by ASHRAE 170. The report preview includes all registers, all envelope crossings, and the entire envelope, which all exist as mapped data sets within the Data Integration Module.

FIG. 25 illustrates a single room schematic within the Data Integration Module, reporting transfer air at each envelope crossing. The room and system testing adheres to ASHRAE 62.1 standards, which regulate the transfer of air between air classifications.

FIG. 26 illustrates a multi-standard result summary report within the Data Integration Module, displaying comparable values including CFM and outside air mix rate. The summary includes actual conditions, design conditions, and prescribed energy conservation models, along with newer infection control parameters, for a comprehensive analysis and comparison.

FIG. 27 illustrates an Air Balance Technician Worksheet within the Data Integration Module, featuring calculations for both minimum and excess CFM. These calculations take into account the relevant regulatory requirements and the selected function of space. The software calculates the minimum CFM for supply air and exhaust air, based on the chosen regulatory standard and room use designation.

FIG. 28 illustrates the Air Moving Equipment Profile Report feature of the Data Integration Module, with a particular emphasis on fans, a critical component of HVAC systems. The system processes data related to fan set points, including specifications and performance, which are fundamental to energy conservation models, maintenance, and infection control. This data is stored in a database, and alongside actual performance readings, it is systematically presented in comprehensive reports generated by the Data Integration Module.

FIG. 29 illustrates a Pitot Traverse Report feature within the Data Integration Module, including an embedded schematic of the traverse location. The system accommodates unique details for traverses in square, round, or oval duct. Reports created by the Data Integration Module include the traverse location which is stored within the polygonal and relational data sets. The software schematically retains and reports mapped traverse locations in a building or HVAC system, along with unique feet per minute (“FPM”) measurements of the points in the traverse.

FIG. 30 illustrates a room schematic report presented in accordance with California Mechanical Code parameters. This exemplar is the product of the Data Integration Module's systematic processing: it includes actual measurements as first data, applies relevant regulatory standards, and then incorporates design features into the calculations. The schematics are images of the polygon structures within the invention.

### DETAILED DESCRIPTION OF THE INVENTION

The detailed description set forth below in connection with the appended drawings is intended as a description of presently preferred methods of the invention and is not intended to represent the only forms in which the present invention may be constructed and/or utilized. The invention discussed below may be implemented by a combination of hardware, software, and/or firmware, in various applications which may include a computer. The computer may be configured by a computer readable medium or program code to provide functionality. The program instructions may be those designed for the purposes of the present invention. When executed on the computer system of a user, configures that computer system so that the user can receive and provide information. It should be appreciated that any one or more elements of the system for controlling airborne infection, air balancing, or conserving energy in an HVAC system in an at least one environment illustrated in the following embodiments can be located remotely from any or all the other elements, and that any of the elements of a given embodiment can, in fact, be part of another system altogether.

An embodiment of the invention includes at least five modules that work in correlation construed as functional blocks of a computer for receiving and combining data: a Data Integration Module (“DIM”) 100 which at least includes the functionality of integrating building specifications, HVAC equipment and associated data, current condition measurements, regulatory standards, testing and balancing process requirements, and subscribed user information; a Construction Design Module (“CDM”) 200 for at least collecting mechanical or architectural plans and transmitting as-built, as-tested or as-balanced conditions; an Energy Conservation Module (“ECM”) 300 for at least collecting and transmitting energy conservation specifications, plans, and designs including as-tested and as-balanced conditions; a Condition Monitoring Module (“CMM”) 400 for at least collecting and transmitting pressure, temperature, and volume readings within ventilation systems and room envelope crossings; and, an Integrated Monitoring Module (“IMM”) 500 for at least airborne infection control monitoring, condition data collection, energy usage, HVAC equipment setpoints, and integration with building automation systems.

In an embodiment, the respective modules described above are designed to improve the efficacy of the airborne infection control process, energy efficiency, regulatory compliance and include a computer software application which, when executed on the computer system of a user, configures that computer system so that the user can receive and provide information and data to users or groups of users based on the designated input. In these embodiments, the invention is a software and data management solution for monitoring, testing, and reporting air balance and infection control conditions for maintenance, accreditation, new construction, and existing buildings that are retro commissioned, or where the HVAC system is modified for an energy conservation model. It calculates the quantity of airflow required to meet the established regulatory standards designed to minimize airborne infections and may generate digital reports or notifications summarizing the building's air balance design, monitored conditions, as-built conditions, and test results.

In an embodiment, the above modules may integrate with commercial or proprietary systems or software that leverage artificial intelligence. Using advanced image processing techniques in conjunction with machine or deep learning algorithms, the integrated system can generate unique identifiers and create or augment schematics for a designed HVAC system. This integration facilitates an efficient and precise interpretation of HVAC system designs, enhancing the overall functionality and utility of the modules.

In an embodiment, the above modules may be integrated with a variety of systems, including commercial building automation systems, that provide monitoring and data collection services for the life safety and energy optimization in commercial buildings such as hospitals, assisted living facilities, office buildings, retail facilities, schools, and entertainment venues.

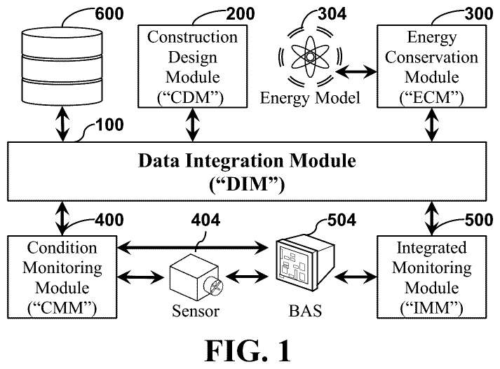

FIG. 1 depicts the architecture of the system, highlighting the interconnectedness of the different modules. DIM 100, at the heart of the system, manages the data exchanges that link these modules, processing diverse data inputs to provide a unified foundation. This facilitates a coordinated approach to the design and management of buildings and enhances the system's ability to handle infection control, optimize air balance conditions, conserve energy, and improve building operations. The bidirectional relay 101 symbolizes the communication between DIM 100 and the database(s) 600

Within an embodiment of this invention, the CDM 200 sends architectural blueprints and mechanical specifications to the DIM 100 for conversion to usable data. The DIM 100 then returns precise measurements of the as-built air balance and HVAC features to the CDM 200. This feedback refines the as-built design drawings, enabling a more accurate and optimized final design.

In an embodiment of this system, the ECM 300 receives energy conservation model instructions and designs as first data, which is converted to usable data, including parameters for test results. This communication involves the dynamic transfer of analyzed data and results from the DIM 100 to the ECM 300. Proprietary energy conservation models, including models similar to those described by Bullock and Qin, exist outside of this invention. The ECM 300, instead, receives set points and HVAC functionality instructions from the conservation models as first data.

In this system embodiment, the CMM 400 connects to at least one sensor 404 and to the DIM 100. This connection facilitates the ongoing transmission of real-time sensor data, distinct from the data received by BAS 504. This sensor data is applied to test parameters of systems or rooms influenced by pressure or CFM measurements. This configuration allows the CMM 400 to actively report changes in the environmental conditions of the monitored spaces.

The IMM 500 is a pivotal connection between the DIM 100 and BAS 504, receiving monitored conditions that could, in an embodiment of the invention, mirror or duplicate the sensor data obtained by the CMM 400. The DIM 100 interprets this data from the IMM 500, relayed from the BAS 504, and generates infection control reports. These reports include all grilles and envelope crossings. The DIM 100 reports may also recommend adjustments, such as revised set points based on minimum volumetric calculations.

In an embodiment, the BAS 504 may interface with both the CMM 400 and IMM 500, receiving sensor instructions, implementing dynamic control strategies, and facilitating bidirectional data exchanges. It has the ability to self-generate corrections based on design or set point parameters. However, the connection to the DIM 100 introduces a unique advantage. Unlike the BAS 504, the DIM 100 can generate reports based on features that may not exist within the BAS 504. These include detailed schematics of every grille and envelope crossings, considering the complex interrelationships analyzed within the polygonal configurations that the DIM 100 has constructed. These reports are circulated back to the monitoring system and the

BAS 504 via the CMM 400 and IMM 500, representing conditions processed by the DIM 100. The BAS 504 doesn't connect directly to the DIM 100 database(s) 600 but receives reports and analyses through the CMM 400 and IMM 500.

As a hub of data processing, the DIM 100 generates comprehensive reports. These reports are tailored for individual projects and buildings, encompassing a myriad of HVAC features, and adhering to established standards and practices for infection control and reporting, including standards such as ASHRAE 170 which are received as first data. Within this embodiment, the DIM 100 constructs intricate schematics Within these schematics, every envelope crossing and grille receive a prominent display, incorporating multifaceted design, energy, and infection control parameters.

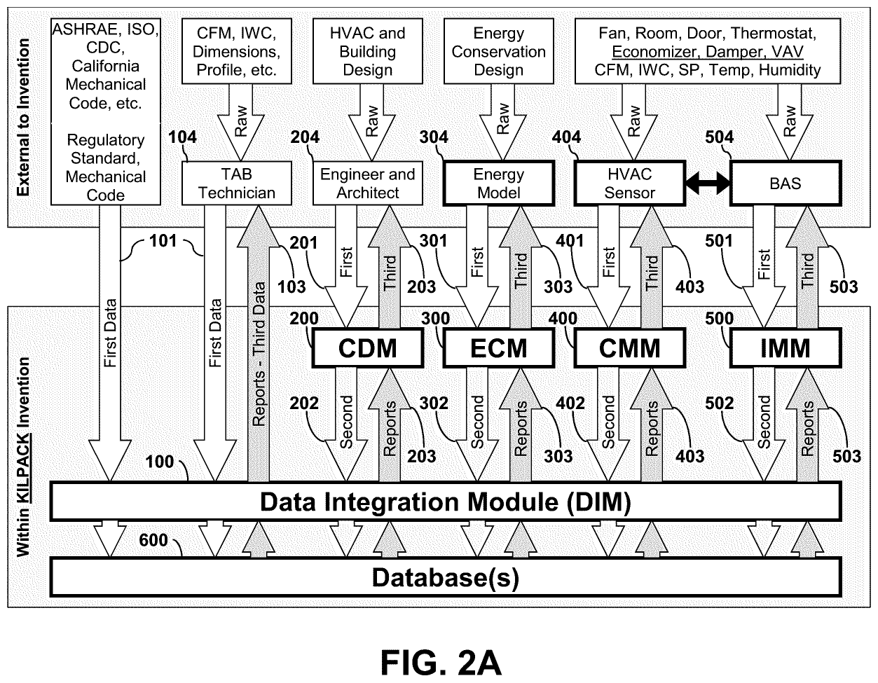

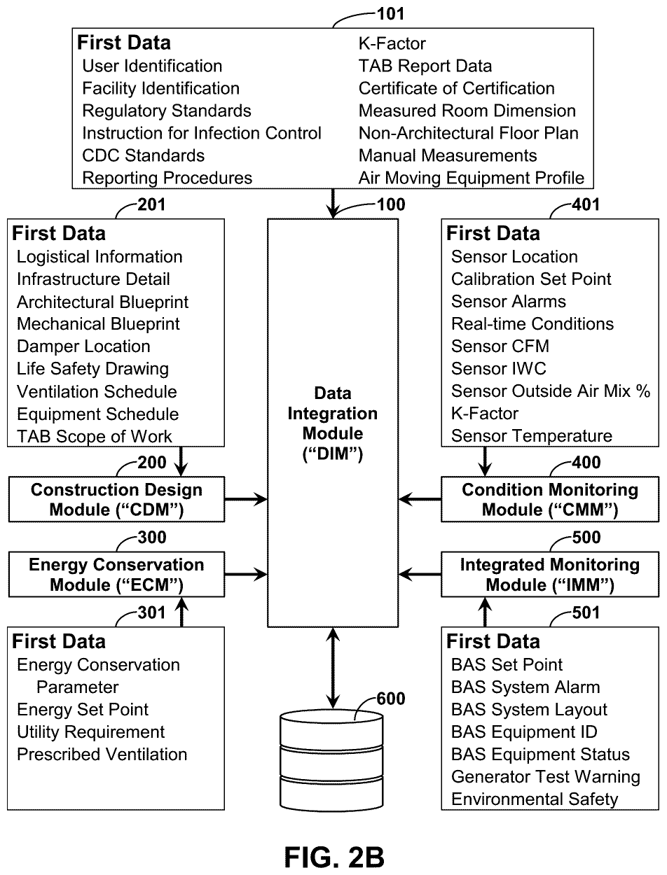

FIG. 2A illustrates raw data, first data, second data, and third data in an embodiment of the invention. The DIM 100 directly receives first data 101, either from the facility or provided by a technician 104. This data comprises verified conditions from calibrated instruments. Additionally, the DIM 100 receives regulatory standards published by agencies such as ASHRAE, the CDC, ISO, and others. These standards, often arriving in non-data formats such as PDFs, are processed by the DIM into structured forms like columns/rows or CSVs, converting the information into data usable for the DIM algorithms. Importantly, this data does not pass through any module and is sent directly to the DIM as first data.

The CDM 200 receives first data 201, which includes design specifications for a building or HVAC system, such as ventilation schedules and architectural blueprints, provided by architects and engineers 204. The CDM 200 processes this data into second data 202, which simplifies complex designs for the DIM 100. The processed data is returned with actual verified conditions 101 compared to the regulatory standards 101, forming comprehensive as-built third-data reports 203.

The ECM 300 receives first data 301, directives, or set points from an external energy model 304, which forms the basis for energy conservation plans for the HVAC system. The ECM 300 then transforms this data into second data 302, a format that the DIM 100 can process. The ECM 300 receives return reports as third data 303, which incorporate the first, second, and third data from other sources and modules.

The CMM 400 receives first data 401, including sensor 404 data such as CFM, pressure, temperature, or door status. The CMM 400 translates this sensor 404 information into second data 402, which the DIM 100 can process with shared data from the other modules. The IMM 500 receives first data 501 from an external BAS 504, which includes sensor 404 information and total system data like generator testing or power outages. The IMM 500 standardizes this system data into second data 502, making it compatible with the DIM 100.

The DIM 100 integrates all received second data to generate reports which are distributed as third data 103, 203, 303, 403, 503. These reports, derived from the combined first, second, and third data from all sources, are distributed to the respective modules. Thus, the CDM 200 receives third data 203, the ECM 300 receives third data 303, the CMM 400 receives third data 403, and the IMM 500 receives third data 503.

These reports trigger actions such as system changes executed by the BAS 504, future processing of design data in the CDM 200, adjustments of energy conservation directives in the ECM 300, or maintenance actions based on sensor data from the CMM 400. This process continuously monitors, adjusts, and enhances the overall system.

FIG. 2B provides a detailed graphical depiction of the initial data integration within the invention. In a given embodiment, the system's functionality is initiated by a series of modules— CDM 200, ECM 300, CMM 400, and IMM 500. Each of these modules is responsible for collecting specific first data. They accumulate information related to elements of building design 201, energy consumption 301, conditions derived from sensor data 401, and monitored conditions 501. Simultaneously, the DIM 100 receives its distinct set of crucial first data 101. This includes user information, custom report features, and the actual volumes and pressures as tested and reported by TAB technicians. The DIM 100 also receives the regulatory standards that govern both the reporting process and the air balancing process, underlining the system's commitment to adherence to industry standards and best practices.

Underpinning the structure of the DIM 100 is the first data 101. This data incorporates elements of TAB reporting and air balancing, each contributing distinct value to the system's operation. ASHRAE standards, including comprehensive footnotes and instructions, such as Table 7-1 of ASHRAE 170 and table references from ASHRAE 62.1, are incorporated into the first data 101 of DIM 100.

The operating principles of DIM 100 are deeply rooted in its first data inputs 101, which carry the methodologies and regulations imparted by various accrediting and certification agencies. Notably, the DIM 100 integrates the reporting requirements and testing processes outlined in ASHRAE Standard 111-2008 (RA 2017) as first data 101. This standard, especially Section 12 (Page 51, Column 1) which addresses reporting and Section 13 (Page 57, Column 2) which addresses commissioning and TAB reporting for design and commissioning, serves as a blueprint, laying down the minimum requirements for TAB report documentation and delivery. More than just input, these guidelines shape the core algorithms and procedures that drive the DIM 100. The system doesn't merely adopt these standards; it embodies them, ensuring its outputs align with industry-accepted practices and its processes echo the meticulousness of the very standards it is built upon.

Infection control instructions are part of the first data 101 to the DIM 100. Guidelines for Environmental Infection Control in Health-Care Facilities (April 2023), a collaborative work between the CDC and ASHRAE, emphasizes airborne contaminant removal. Specifically, Table B.1 (Page 223) provides insights into ACH and the time required for contaminant removal at varying levels of efficiency. The DIM 100 incorporates these guidelines, including Table B.1, as part of its first data 101.

Certificates of certification are part of the first data 101, validating technician qualifications and the accuracy of the DIM's 100 output. Calibration certificates, which verify equipment and system compliance, contribute to the precision of data processing and system reliability.

User information is part of the first data 101 for the DIM 100, enabling unique logins and personalized access. This information is tailored for various roles, such as data processing, technicians, building owners, engineers, and third-party processors, who may provide first data to the DCM 200, ECM 300, CMM 400, and IMM 500.

First data 201, funneled into the CDM 200, provides a multifaceted picture of the building's structural and mechanical design. Mechanical blueprints illustrate the layout and specifications of HVAC components, including fans and other equipment responsible for air conditioning and distribution. The complexity of these blueprints can vary based on the intricacies of the HVAC system and the unique prerequisites of the design.

Alongside these blueprints, a series of HVAC schedules details various aspects of the HVAC system's operation. These schedules include the Air Handling Unit (“AHU”) Schedule, Chiller and Boiler Schedule, Control Valve Schedule, Exhaust Fan Schedule, Fan Coil Unit (“FCU”) Schedule, Grille and Diffuser Schedule, Heat Exchanger Schedule, Pump Schedule, and VAV Schedule. The transfer of this data as first data 201 to the CDM 200 and then as second data 202 to the DIM 100 provides the DIM 100 with comprehensive insights into the building's planned design and HVAC operations. This enables precise assessments and compliance checks against the prescribed set points and schedules.

ASHRAE 111 2008 (RA 2017) emphasizes that the commissioning of HVAC systems should be a collaborative process that begins even before construction. Specifically, in Section 13 (Page 57, Column 2), ASHRAE advises, “[i]t is imperative that the TAB agency submit to the commissioning authority a commissioning plan just as any other contractor or vendor working on the project would do. This plan should describe the systems to be commissioned [and] the format for reporting[.]” The standard further elucidates on the timing of commissioning for TAB within the construction cycle (Page 57, Column 2), stating that, “Commissioning [for test and balances] should be implemented during the design phase and be carried through the occupancy phase and possibly further until the facility is 100% occupied.”

While conventional reporting practices in commissioning, TAB contracting, and TAB certification do not always align with this standard, ASHRAE's guidance clearly indicates that TAB reporting should begin with design and continue through occupancy. The CDM 200 serves as the starting point for TAB compliance, design, and performance. When the first data 201 is provided to the CDM 200, and combined with the reporting features of the DIM 100, a comprehensive database solution is created. This database aids in verifying that the HVAC system meets the owner's requirements, including those pertaining to infection control, energy conservation, and health and occupational safety.

The ECM 300 provides its first data 301, which may include directives from external models. Notably, this data could include instructions from patented models, such as those outlined in Qin and Bullock.

Bullock combines parameters to arrive at an instruction, specifically a set point instruction, for a building management system. This instruction is based on a set of rules. The system and prior art and claim 1 (Column 27, Line 36) within Bullock include “receiving a selection of a primary variable of the digital rule; receiving a selection of a secondary variable of the digital rule; receiving a selection of a first operator of the digital rule; receiving a selection of a tertiary variable of the digital rule; receiving a selection of a second operator of the digital rule; combining the secondary variable with the tertiary variable using the second operator to form an intermediate result; combining the primary variable with the intermediate result using the first operator to form a set of test results; generating a command to optimize a set point of the building automation and control system, based on the data and the set of test results.” First data 301 could include at least one command to optimize a set point of any HVAC system where the model that creates the directives remains external.

In an embodiment, the CMM 400 module gathers real-time first data from sensors. Continuous monitoring is a key aspect of the CMM's 400 role, critical for maintaining accurate infection control and air balance. The DIM 100 uses its reporting features to format and transmit information and tests of regulatory standards. This information is crucial for adjusting the BAS's 504 control actuators based on sensor 404 readings without compromising safety.

The IMM 500 module interfaces with the BAS 504 to report monitored conditions that are not only linked to sensor readings. It oversees situations like fan failures, differential pressure during a generator test, power outages, and fire smoke damper tests, providing crucial insight into the operational health of the system. Additionally, the IMM 500 can relay verified information back to the BAS 504. This includes updates on the function of space or changes in regulatory standards for infection control. These updates are used to train the alarm, reporting, and control features of the BAS 504, equipping the system to adjust to changes in room usage or health guidelines.

The database(s) 600 plays a critical role in the DIM 100 system. It receives processed data, first data, second data, and third data from the DIM 100. Some original first data, including proprietary software, processes, and algorithms from modules like the CMM 200 and the ECM 300, may not be stored within database(s) 600.

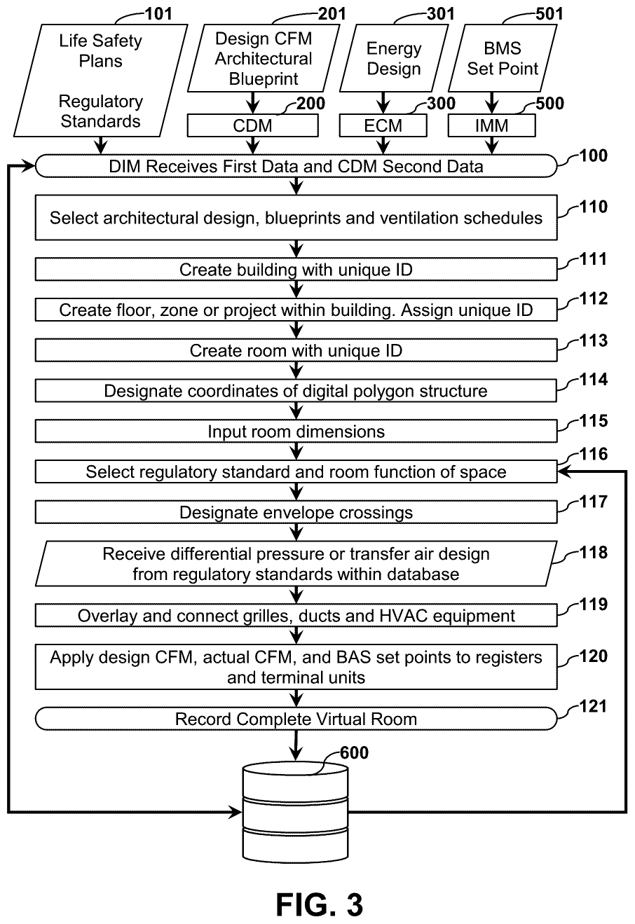

FIG. 3 demonstrates how the DIM 100 transforms building blueprints or other floor plans into a digital dataset of polygons. The process initiates when the DIM 100 receives the blueprints or selected floor plan for a building. Inputs into the system include comprehensive mechanical systems, life safety features, and HVAC equipment specifications from the CDM 200. Additionally, drawings related to sensor(s) 404, the IMM 500, or an energy model 304 when applicable, can serve as data sources for floor plans.

These inputs create the foundation for a new building entry within the system, enabling the mapping of virtual room locations via digital polygons. During this stage, the DIM 100 also processes the building's name and general specifications. The building data may span various projects, specific infection control and air balance reports, and information about the owner, managers, or other identifiers or contacts.

The DIM 100 identifies the architectural design and ventilation schedules from the received blueprints or floor plans 110. The system assigns a unique identifier to the building, establishing a crucial reference point for all related data and processes 111. Within the building, there are designations for zones, projects, or room groups, each of which is assigned a unique identifier for data organization and specific data retrieval within the system 112. Each room is given a unique identifier 113. These unique identifiers, stored in database(s) 600, allow precise identification and access to each building's data set. Furthermore, the unique identifier accommodates scenarios involving reporting, such as instances of duplicate room numbers within a building, or varied numbers or identification when room numbers on the BAS 504, actual room badges, or design plans do not match.

The virtual location of each room is established through digital polygon structures 114. These structures are created from sets of coordinates that define the locations of rooms or corridors on available images, capturing room attributes and equipment overlays. A visual representation of the creation of virtual polygon structures within the DIM 100 can be seen in

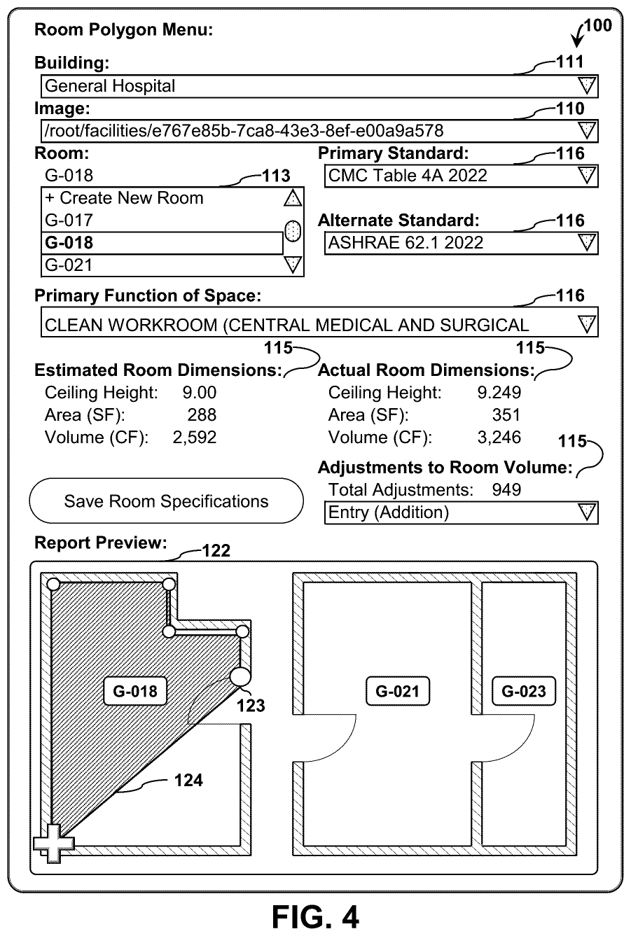

FIG. 4. Upon the creation of a room and its assignment to a standard and use, the exact specifications can be assigned to that room for analysis within the DIM 100. When new buildings are created, room details and dimensions are input as data components associated with the polygon 115.

In addition to standard cases, where room volume calculations are straightforward, there are instances where estimated, basic, or rudimentary dimensions—such as height, width, and ceiling measurements—may not accurately capture the room's physical attributes 115. These discrepancies could include cutouts, fur downs, entry spaces, columns, varying ceiling heights, or permanent installations. To account for these complexities, the DIM 100 allows for the recording and calculation of the actual room shape, adjusting for accurate volume and square footage. This feature is crucial for safety, infection control, and energy management. It corrects the omission or inaccuracy of HVAC system design and operation due to estimated room volumes. The capability to incorporate actual room attributes is key, especially in complex spaces with fire doors where an imbalance of air at the envelope crossing could hinder fire door functioning.

Within a building, individual rooms may be governed by unique regulatory standards. The DIM 100 system accommodates this by allowing a standard to be applied to an entire building while also enabling variance in standards within the building. Users select a specific standard for each room and can only select from that assigned standard when a function of space is applied to the data set for that polygon 116. The DIM 100 retrieves the menu of choices for a function of space from the database(s) 600, relying primarily on the first data 101 of DIM 100. This functionality becomes particularly crucial during an energy conservation project or a tenant improvement, when the building standard might change.

In instances where a contemporary standard modifies the requirements for a function of space or omits the option in newer versions of the standard, the DIM 100 filters the options for reporting parameter tests and conditions of every room, grille, and envelope crossing. This ensures that all reporting adheres to the most recent and applicable standards while also considering the legacy or original design standards.

The polygon data includes envelope crossings 117. These crossings mimic the interconnections between rooms, such as doors and windows, and serve as critical pathways in the building's airflow system. Primary envelope crossings are especially important as they define essential airflow routes and cascade prerequisites. The DIM 100 systematically detects and resolves any potential priorities, conflicts or obligations that arise from these cascade arrangements.

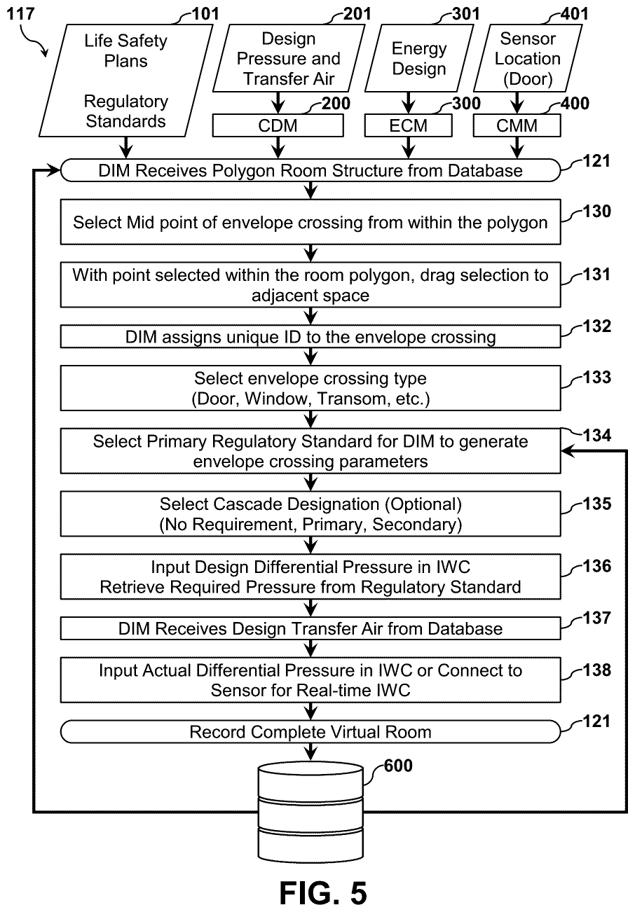

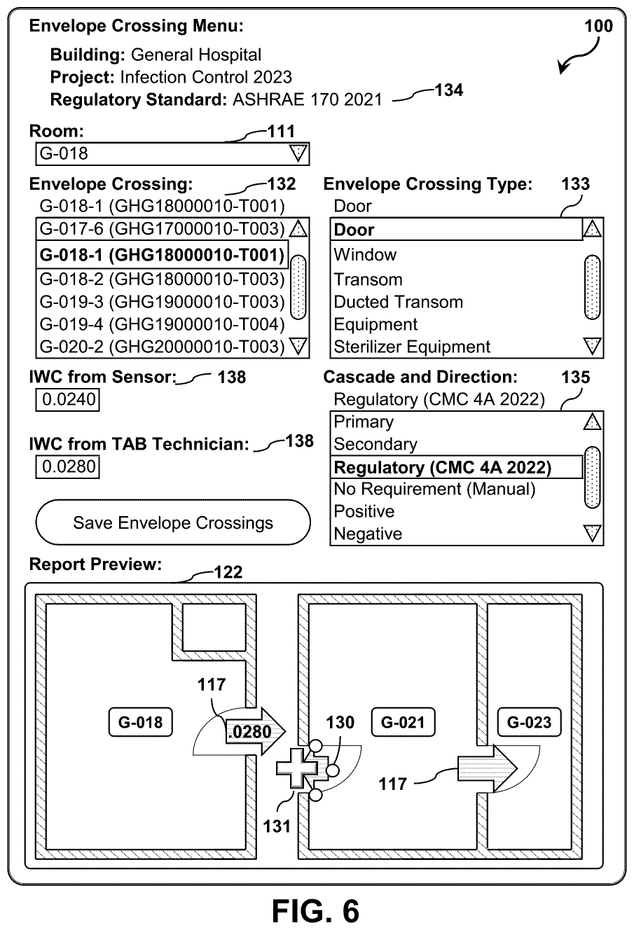

Each envelope crossing, be it primary or secondary, receives single differential design measurements 118. Here, the actual measurements are stored separately from the design measurements and standard requirements. The actual measurements specifically define the pressure differential that exists between adjacent rooms, which is a crucial parameter for infection control reporting. The process of creating envelope crossings is featured in FIG. 5 and FIG. 6. The embodiment of the DIM 100 allows for the designation of certain envelope crossings as primary, underlining their importance in facilitating primary airflow between rooms and enforcing mandatory cascade conditions. The DIM's 100 algorithmic analyses address any conflicts that arise among positive-pressure rooms sharing an envelope crossing. The process of assigning single differential design measurements to each envelope crossing is a critical aspect, as it clarifies the pressure differences between adjacent virtual rooms, laying the groundwork for subsequent design condition assessments. These measurements can be manually input, retrieved from database(s) 600, or calculated using algorithms within the DIM 100, considering the data received from the BAS 504 by the IMM 500.

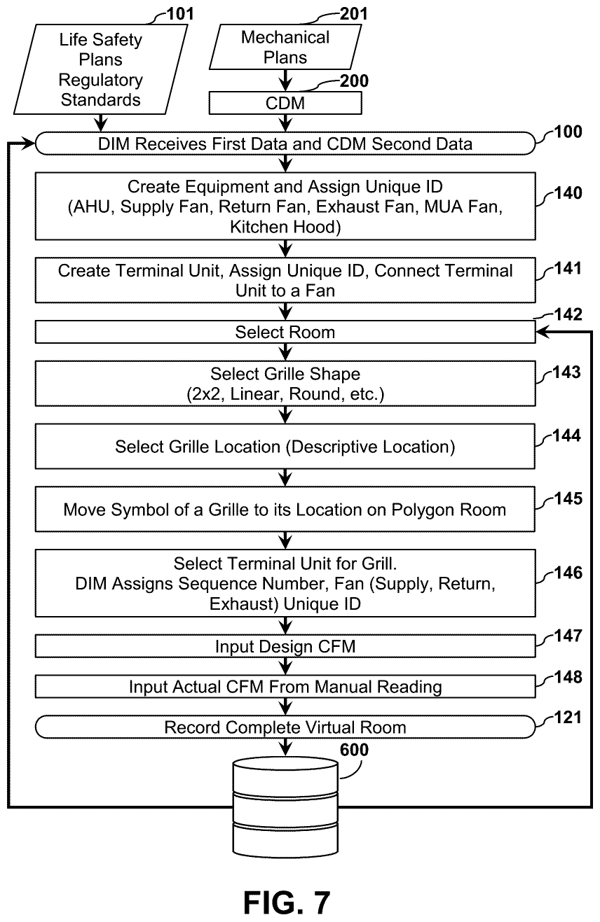

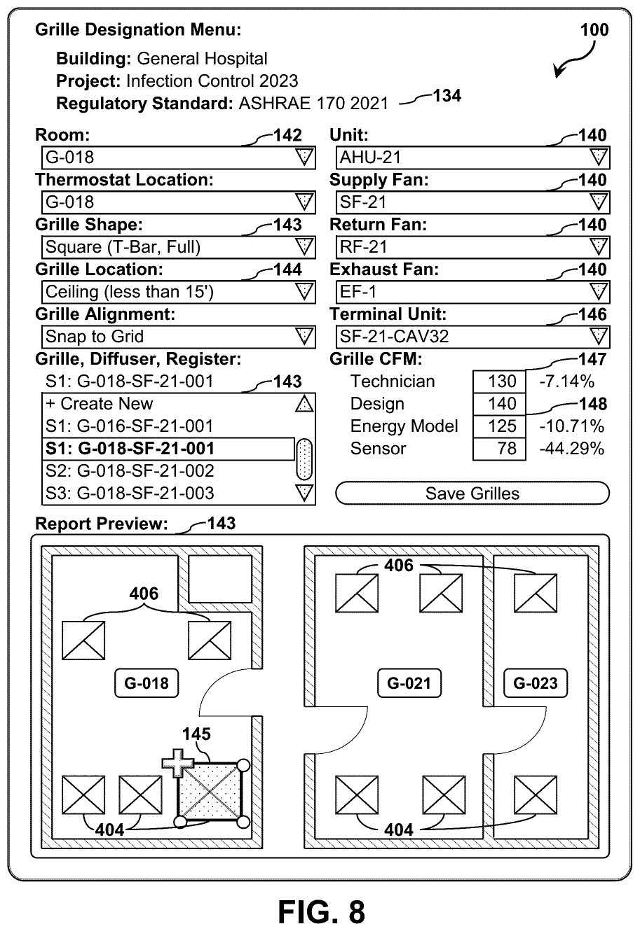

Using the mechanical drawings and equipment specifications 110, the DIM 100 overlays component positions 119, such as registers, ducts, pitot traverses, and HVAC equipment, on the digital polygons. This precise placement assures a unified system integration. This process is detailed in FIG. 7 and FIG. 8. Registers and ducts are connected to terminal units and air handler unit fans, thereby establishing an effective system. The assignment of design CFM measurements and BAS 504 set points to registers and terminal units can be done manually 120. In an embodiment, the DIM 100 retrieves these set points directly from other modules within the system. The complete virtual room, along with all its elements, is recorded 121.

Throughout the entire process, as depicted in FIG. 3, the DIM 100 maintains continuous data storage and retrieval within the structured database(s) 600. This foundational data, which includes the polygonal coordinates and schematic as an image, room relationships, and true dimensions, serves as the basis for calculations, testing, and reporting conducted in accordance with regulatory standards.

FIG. 4 demonstrates the process of constructing a virtual polygon structure within the DIM 100. The DIM 100 interface enables users to choose report options 110, 111, 113, 115, 116. These options are displayed within a dropdown menu, and the data is populated and filtered through database(s) 600. A preview pane 122 provides a workspace for the creation of the polygon room 124. This interface facilitates users to interactively design virtual representations of a room or space based on the provided blueprints or life safety drawings.

In an embodiment of the invention, the polygon creation begins with establishing a starting point for the polygon 123. From this initial point, users can select the sequential corners of the polygon, effectively tracing the contours of the room or space. This process can also accommodate arcs, facilitating the creation of polygons that accurately portray rooms with curved walls or other non-linear features.

Upon completion, the polygon is represented as a shaded area inside the preview pane 122. This polygon 124 is then transformed into a polygonal dataset. This dataset acts as a digital representation of the room or space and can be utilized for various analyses and computations within the DIM 100.

The ability to generate these polygonal datasets lays the groundwork for precise representation and analysis of rooms or spaces, regardless of their complexity. This embodiment of the invention holds particular significance for ensuring accurate relational calculations related to HVAC systems, infection control, and energy management.

Further amplifying the potential of this embodiment, the process of creating these polygonal datasets manually paves the way for the DIM 100 to learn from these inputs over time. The system can potentially use this data to train an AI component that will eventually be able to recognize room shapes, dimensions, and features automatically. This learning process could drastically enhance the system's efficiency, allowing it to replicate manual processes, reduce user input errors, and possibly even predict room attributes based on patterns identified in previous entries. This represents a promising evolution in the DIM 100 system's capabilities, enabling it to progress from a tool that assists with manual data entry to an intelligent system capable of automating and enhancing these processes.

FIG. 5 illustrates the detailed procedure for structuring envelope crossings within a virtual polygon room using the DIM 100 system. The process initiates when the DIM 100 system receives the polygon room structure, including the envelope crossing designation 121. Users select the midpoint of an envelope crossing from within the polygon 130 and can drag the selected point to an adjacent space 131. Once the position of the envelope crossing is established, the DIM 100 assigns it a unique identification 132 for precise tracking and management. Users then select the type of envelope crossing, such as a door, window, or transom 133.

The nature of the crossing significantly impacts room balance and differential pressure calculations, making it a crucial aspect of the process. The DIM 100 system generates the envelope crossing parameters 134 based on the selected standard 116 which governs the requirements for room balance and differential pressure, ensuring adherence to relevant building codes and safety regulations. As an optional procedure, users can select a facility-specified cascade designation, such as no requirement, primary, or secondary 135, providing additional information about the hierarchy or priority of envelope crossings. An example of this may be using a sub sterile space within a hospital for sterile storage. This happened frequently for areas that transitioned for COVID-19 protocols. In such a case, the facility may designate a primary cascade into or out of the room, depending on the function of space adjacent to the new storage area.

The DIM 100 is adaptable and can work with a variety of scenarios. Users can input the design differential pressure in inches of water column (IWC), or the DIM 100 can retrieve the required pressure from the regulatory standard 136. The system also receives the corresponding design transfer air data from the database(s) 600, once unique grille data is entered. This information is crucial for computations related to room balance and differential pressure.

After setting all parameters and inputting necessary data, the virtual room 121 is recorded. This data is sent to the database(s) 600, concluding the process of structuring envelope crossings within a virtual polygon room in the DIM 100 system. The process is visually represented in FIG. 6.

FIG. 6 provides a visual representation of the envelope crossing creation process using the DIM 100. The room is displayed in the preview pane 122, which also serves as the workspace for the polygon and envelope crossing creation. The filters for the room are populated by the database(s) 600 and include the envelope crossing identification 132, type 133, sensor value 138, manually tested pressure 138, and cascade or direction selection 135.

The envelope crossing is created by dragging a selector across the intersection of two rooms or polygons. This addition becomes a data set for the database to process infection control tests for the room and adjacent spaces. Similar to the polygon creation test, this is a manual process that will serve to train AI.

Training the AI involves exposing it to numerous instances of this manual process. The AI algorithm learns from each instance, gaining an understanding of the different steps and decision-making processes involved in creating an envelope crossing. Envelope crossings in sterilization departments share similarities across most facilities. Crossings for cart washers, or those used for passing instruments from the decontamination to the sterile side of the department, are largely typical. However, these are not uniformly represented in the first data 101, 201. Over time, and with the benefit of manual selections serving as learning instances, the AI becomes adept at recognizing the necessary steps and parameters for envelope crossing creation. This reduces the need for manual intervention, thereby increasing efficiency and reducing potential for human error.

FIG. 7 details the process of integrating grilles, diffusers, and registers into the virtual polygon room. The DIM 100 receives the first data 101, which includes life safety plans, digital floorplans, and regulatory standards, as well as the CDM's 200 first data, consisting of mechanical plans and ventilation schedules 201. The DIM 100 can process the ventilation schedules as digital data, or they can be manually created and input by a user. The addition of equipment encompasses all HVAC-related components, such as supply fans, return fans, exhausts, MUA fans, kitchen hoods, and others 140. Each unit is assigned a unique ID for tracking and management within the system 140.

Terminal units serve a crucial role in HVAC systems, delivering final control and conditioned air to the occupied space. The terminal unit might be the fan itself in systems without downstream control features. However, in most cases, terminal units are VAV boxes or CAV boxes. VAV boxes modulate the volume of air supplied to spaces based on demand, whereas CAV boxes deliver a constant volume of air. The selection of a terminal unit type depends on the specific needs of the building and the design of the HVAC system.

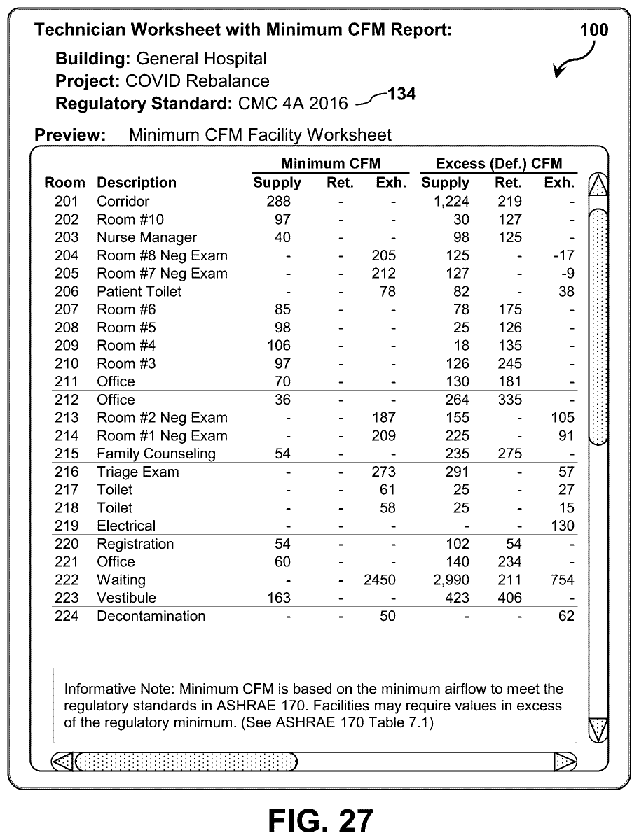

For infection control, it's vital to understand where the air must be constant and where it can vary. Including this data as part of the polygon set, with relationships mapped to adjacent spaces, is critical for managing airborne infections and providing outside air to the breathing zone. The calculation of minimum CFM, further detailed in FIG. 27, relies on regulatory factors as well as the relationship between rooms where air might be transferred to adjacent spaces. These minimums can become the set points for CAV or VAV units.

The VAV or CAV is connected to a fan 141, creating a clear data connection within the system to effectively report the air conditioning process. Terminal units, including VAVs, CAVs, and fans, are stored in the database(s) 600.

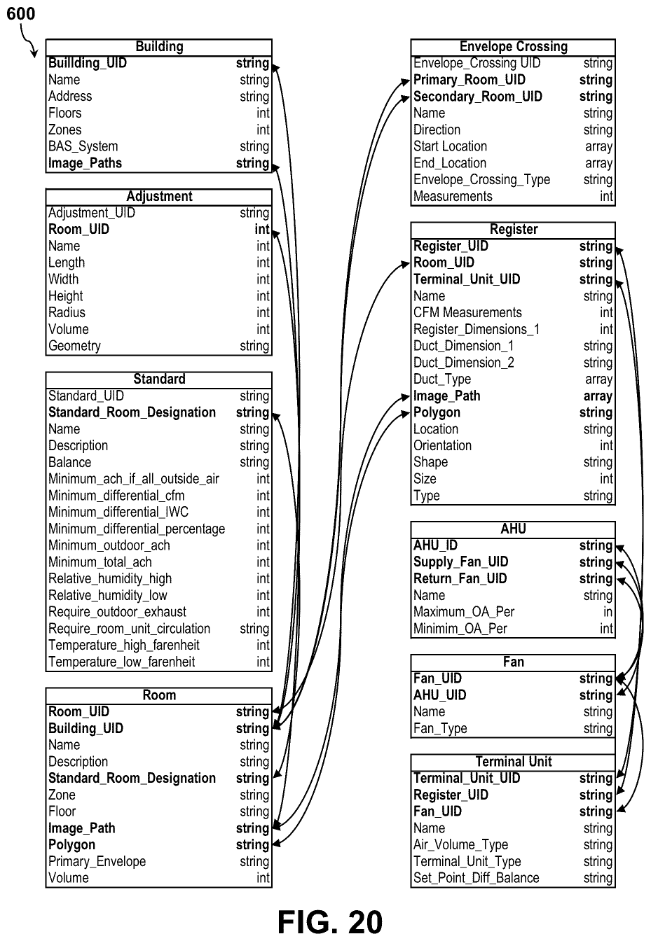

The addition of a register requires the selection of a room, which places the grille within the polygon data set 142. Specifications of the grille, such as the dimensions of the grille face, the throat of the register, duct dimensions at the connection, and the grille shape, are then added to the data set 143. Each of these elements is unique and is individually recorded within the data tables depicted in FIG. 20. When converting feet per minute (“FPM”) measurements to volumetric measurements in CFM, it is imperative to distinguish the actual dimensions of the duct and registers. These measurements are used in two significant ways: they are reported for maintenance purposes and used to calculate actual conditions compared to parameters. Incorrect or interchange use of these measurements can lead to inaccurate calculations and poor maintenance decisions, underscoring the necessity to handle each element as a distinct entity.

The grille location is selected within the polygon shape, with the option of adding a descriptive location for further clarity 144. The DIM 100 stores this information with coordinates and descriptive data for reporting. Upon placing the register in the polygon, the industry-standard symbol for a register is selected from a menu, and its position is determined on the preview pane 122 to mark the location of the register 145.

The system assigns the terminal unit to a grille 146. If the terminal unit is a VAV or CAV box, it is simultaneously assigned to the upstream fan. The design CFM for the register is manually inputted 147, uploaded from a schedule, or received from AI sources. The grille may have a variety of CFM designs for different scenarios, each recorded separately for testing and reporting purposes. This includes design, BAS 504 set points, high and low volumes, occupied and unoccupied volumes, cooling and heating volumes, and CFM from a sensor 404. Manually acquired CFM, including initial and final volumes, are received as first data 101 and recorded 148. In one embodiment of the invention, CFM is received as real-time data from a sensor 404 which is first data 401 to the CMM 400. The DIM 100 records the complete virtual room 121, encapsulating the entire process and the established relationships, leading to a comprehensive digital representation of the room and its associated grille structure.

FIG. 8 provides a visual representation of the grille creation process detailed in FIG. 7. At this stage, the polygon or room is fully defined with all relationships established, and the HVAC system components 140 are integrated. The room is depicted as a polygon. Registers are incorporated into the selected polygon data set 142, with their specific type and shape details defined 143. The exact locations of grilles 145 within the polygon are determined by coordinates and descriptive data 144 in DIM 100. These placements are dictated by design location for pre-construction reporting 203 and the actual or as-built condition for post-construction reports 203.

The design CFM for each register 147, along with other CFM data points 148, form part of the register data set. Each register carries data about air volume, set points, high and low volumes, among others. The preview pane 122 shows the placement of the registers within the polygon.

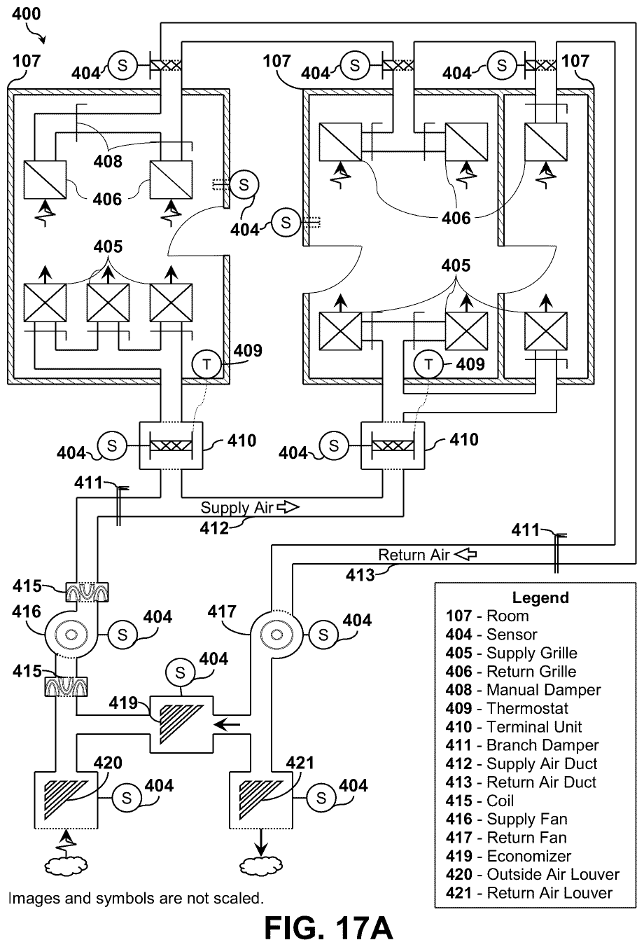

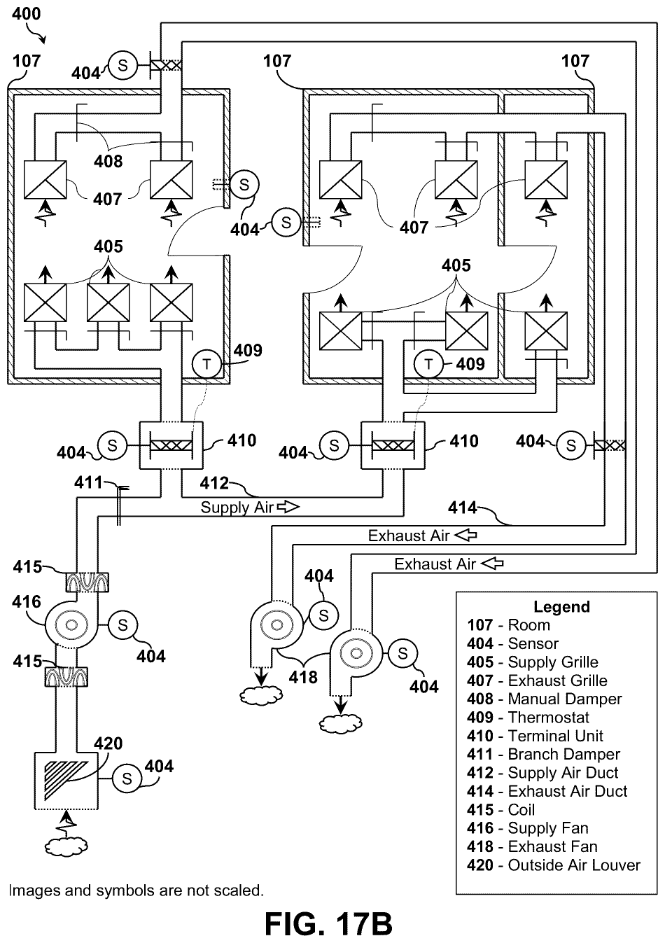

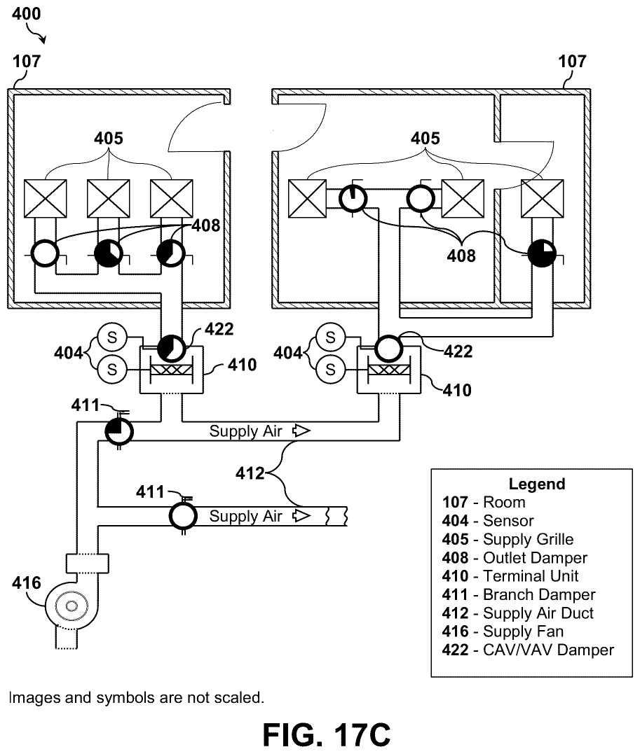

Registers are positioned onto the polygon 145 and become a permanent part of the room image for reporting. The preview pane also displays exhaust registers 407 and supply registers 405, the specifics of which are detailed further in FIG. 17A and FIG. 17B.

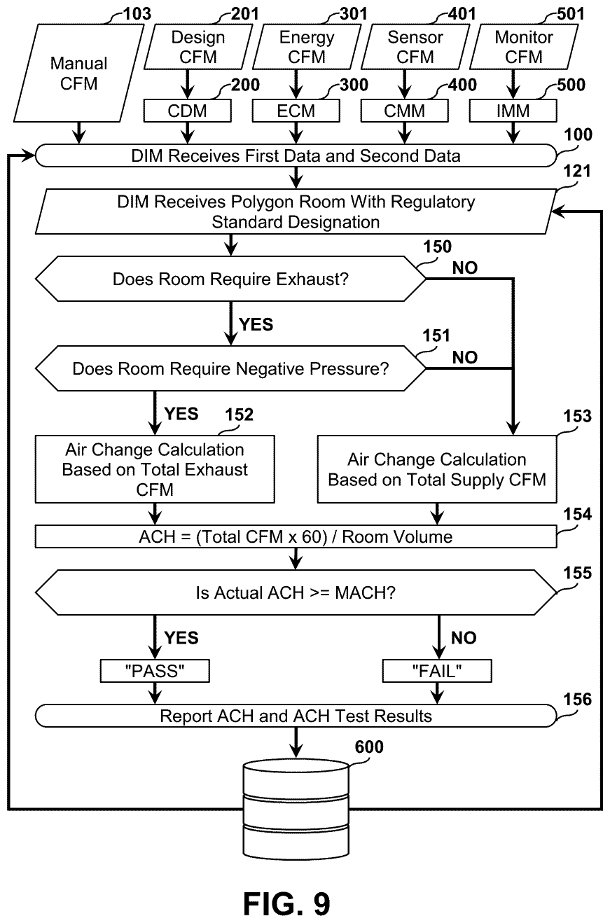

FIG. 9 demonstrates an example of an air changes per hour test within the DIM's 100 capabilities. This example test assesses ventilation efficacy in various spaces, with focus on healthcare facilities due to their specific pressure and balance requirements. The CFM used in this calculation can be received as second data from each module 201, 301, 401, 501 as well as manual measurements as first data 101 to the DIM 100. Calculations are based on data associated with the unique DIM 100 polygons, including the regulatory standards assigned and recorded for each room 121.

Following ASHRAE Standard 170 2021 Table 7.1(a)(3) (Page 20), ACH calculation process is guided by:
Positive Room: air changes are calculated based on supply air from all grilles in the room;
No Requirement (“NR”) Room: air changes are calculated based on total supply air, regardless of balance;
Negative Room without Mandatory Exhaust: air changes are calculated based on total supply air;
Negative Room with Mandatory Exhaust: air changes are calculated based on total exhaust air.

The TAB industry often struggles to correctly apply ASHRAE Standard 170 due to the complex nature of managing criteria. The traditional approach often relies on simplified if/then equations, which fail to accommodate detailed instructions and complex data. This gap between industry practices and the complexity of standards can lead to inaccuracies and limitations in air balance testing. Misapplication of this requirement is common in corridors and nursing stations, which have no requirement for directional pressure but require adequate air changes and outside air. Nurses often work outside of rooms that transfer air to the corridor and where the station or corridor has a negative balance but is not fully exhausted. All air changes, including outside air changes, in these working environments must be calculated based on the supply air and must consider the entirety of the combined volume of the space for the nurses and public. The air changes for nurses and for these spaces shall not be based on exhaust or return air volumes.

The DIM 100 calculates ACH using the formula Total CFM×60 divided by the room volume in cubic feet, using the previously retrieved standards. These standards include a range of parameters and considerations affecting ACH calculations. In the context of FIG. 9, application is tailored to the healthcare sector, which mandates distinct pressure and balance requirements for different spaces. It's important to note that this method of determining air changes isn't universally applicable. DIM 100 adapts to specific standards and their stipulations, recognizing that ACH calculations can vary based on applications. Some scenarios might require different parameter tests that modify the volume aspect of the formula. Some applications only consider room volume up to twenty feet above the floor. This adaptability illustrates the DEVI's 100 ability to handle intricate regulatory landscape governing ACH calculations.

The sample algorithm to achieve a test result starts with determining if the room is required to be exhausted 150. If the room is required to be exhausted 150, and it requires negative differential pressure 151, total exhaust is used for all air change calculations 152. Otherwise, rooms with positive pressure requirement 151, no pressure requirement 151, or no exhaust requirement 150 calculate air changes based on supply volumes 153. Air changes convert the CFM to volume per hour and divide by the room volume 154. A passing result is based on total changes relative to the regulatory standard 155. All results are recorded in the database(s) 600.

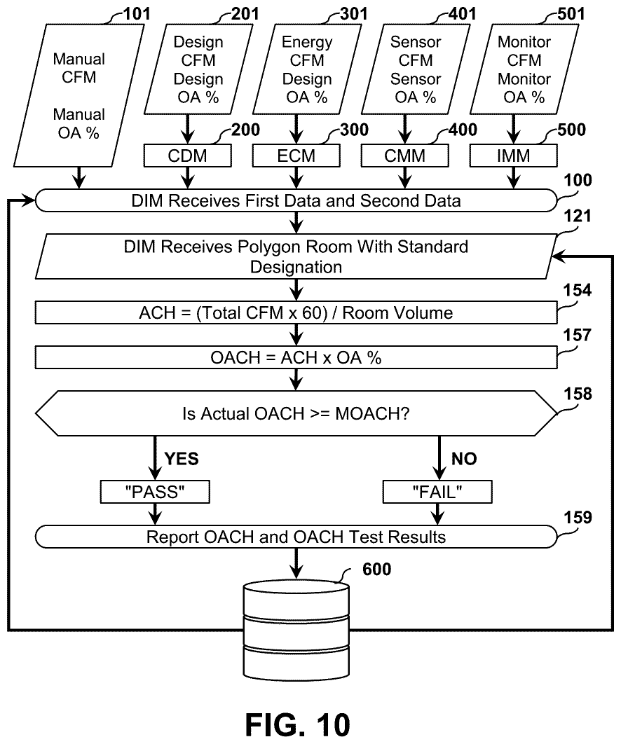

FIG. 10 illustrates the process for calculating outside air changes. The OACH test necessitates calculating the Outside Air Percentage (“OA %”), which is the ratio of fresh outside air mixed with return air in the HVAC system. The mix rate is determined by dividing OA CFM by the total CFM of the air handler, representing the mix of outside air in the total air volume being circulated in the HVAC system. Other methods for determining a mix rate may include temperature readings or pressure from a sensor 404. This mix rate may be monitored or retrieved 401 using sensors 404, an integral component of the CMM 400.

The OA % is transmitted to the DIM 100 as first data 101 when the rate is confirmed by manual methods. Mix rate designs or specifications are also received as first data 201, 301, 401, 501 by the CDM 200, ECM 300, CMM 400, and IMM 500 and then passed on as second data. The DIM 100 initiates the outside air change test for rooms within the DIM 100, which are retrieved 121 from database(s) 600.

In an embodiment, the DIM 100 applies this rate to the air change calculations and test results 154, as detailed in FIG. 9. The ACH is multiplied by the OA % to determine OACH 157. The pass or fail test compares the results 158 to the standards retrieved for each polygon or room 121. Like the ACH test, the OACH test is recorded 159 within the database(s) 600 for reporting.

Sensors 404, positioned within the HVAC system, measure factors that reveal the mix rate. These include locations at economizers 419, 420, 421 where louver positions are revealed, or within ductwork to detect static pressure, CFM, or temperature variations. These sensors 404 provide real-time data to accurately gauge the mix rate.

California Mechanical Code editions prior to 2019 had different air change requirements for a room when the circulated air was entirely OA. For many rooms, total air changes required were lower if the room's supply air was not mixed with return air. This standard remains applicable to facilities constructed before the regulatory change, despite its removal in newer versions of the California Mechanical Code.

The OA % in any HVAC system is critical, representing the primary intersection of infection control and energy conservation. Energy conservation efforts optimize the use of return air during hot and cold weather conditions and minimize the proportion of OA requiring conditioning. This introduces a potential conflict where cost-saving measures need to balance energy efficiency and health safety. Addressing this complex issue requires synergy of all system modules, coordinated and communicated through the DIM 100, which reports room-specific parameter tests of the convergence of conflicting incentives for proper certification. Through this collaboration, infection control and energy conservation systems receive comprehensive training. The DIM 100 matches monitored conditions with regulatory standards, enhancing compliance, accuracy, and effective decision-making.

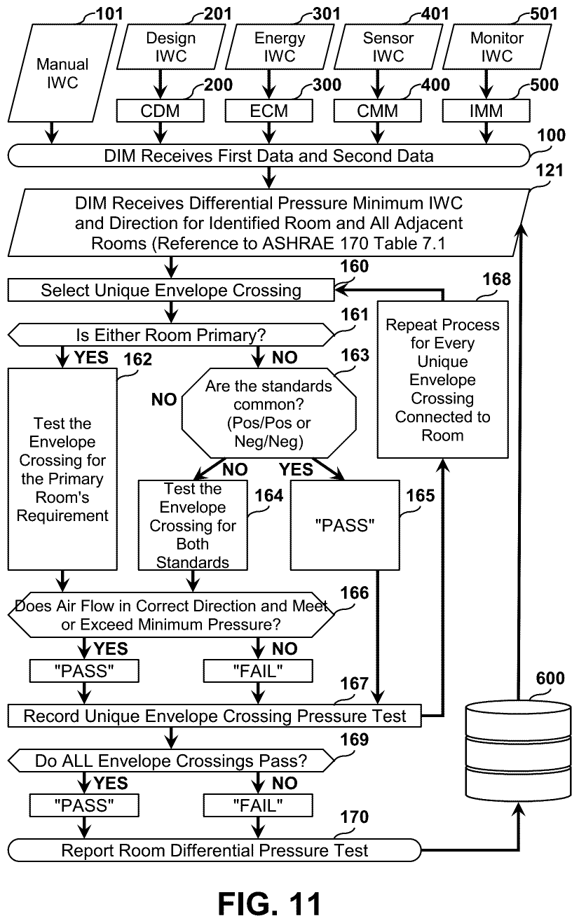

FIG. 11 illustrates the differential pressure test. Differential pressure designs or specifications are provided as first data 201, 301, 401, and 501, to the CDM 200, ECM 300, CMM 400, and IMM 500. The DIM 100 then initiates the test for rooms within its scope, retrieved 121 from database(s) 600, and incorporates the ASHRAE 170 Table 7-1 or similar standards.

The process extends beyond the immediate room under test. The DIM 100 retrieves 121 the information of adjacent rooms located on the opposite side of the envelope crossing. Including the standards of the adjacent spaces is not an optional enhancement; it's a fundamental requirement. Without this data, a differential pressure test cannot be correctly conducted. The testing process begins by selecting an envelope crossing 160. The DIM 100 evaluates both sides of the crossing to determine the relationship between the room and the adjoining space.

The concept of a “primary” room applies when both rooms at the envelope crossing share the same pressure classification: either Positive/Positive (Pos/Pos) or Negative/Negative (Neg/Neg). If one room is designated as primary to the other in these scenarios 161, the test applies the standards appropriate for the primary room 162.

For envelope crossings where the rooms have different pressure classifications or no pressure requirement is specified, the test evaluates each room's compliance with its respective requirements 164. These scenarios include Positive/Negative (Pos/Neg), Positive/No Requirement (Pos/NR), Negative/No Requirement (Neg/NR), and No Requirement/No Requirement (NR/NR).

The DIM 100 reports the designed, tested, or monitored conditions of the required flow direction in cases like Neg/Pos, where air strictly flows from the positively pressurized chamber to the negatively pressurized room 164. This mandatory direction is crucial for the successful completion of the first segment of this two-part test. In the context of an AII room, where negative pressure is a requirement, a cascade structure is implemented to ensure proper airflow management. This cascade involves the interconnected airflow direction between multiple rooms for effective infection control, creating an intricate airflow cascade from NR corridor to ante room, isolation room, and toilet/shower room to ensure the desired airflow direction for infection control. If neither room is primary in Pos/Pos or Neg/Neg scenarios 163, a potential conflict arises. The DIM 100 resolves the conflict based on the specific test conditions and regulations by passing both rooms where there is no required directional cascade 165.

Within the regulatory standards, there is a second requirement, beyond direction, that quantifies the minimum IWC for a crossing 166. This test passes if there is no quantifiable requirement, or if the IWC measured manually or by sensors exceeds the minimum with airflow in the correct direction. Otherwise, the room fails. Essentially, there are two parts—direction and minimum IWC—to achieve a passing result at a unique crossing. The result for a unique crossing is recorded 167, and the process is repeated for all envelope crossings of a room 168.

It's important to note that rooms classified as No Requirement are not inherently compliant in all scenarios. Only envelope crossings designated as No Requirement/No Requirement (NR/NR) are inherently compliant. NR rooms adjacent to positive rooms are required to be negative to maintain appropriate pressure differentials and airflow direction. In this case, a room with no required directional airflow within a standard can still fail. This requirement, although critical, is often insufficiently tested in real-world scenarios.

A room is considered passing only if all envelope crossings pass 169. The DIM 100 reports all envelope crossings, as it does for registers, associated with a room. The final differential pressure test for a room is recorded only after all crossings are tested and recorded 170 in the database(s) 600.

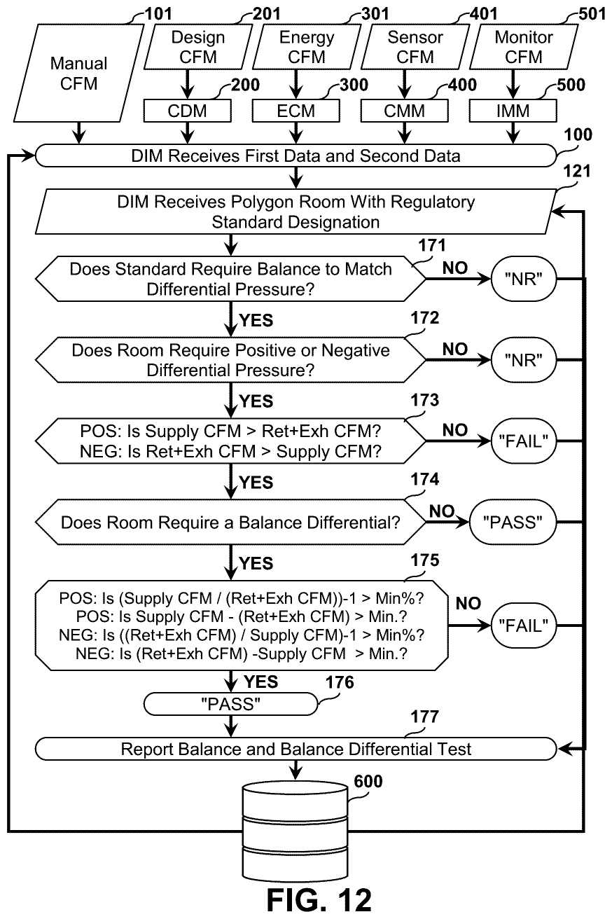

FIG. 12 depicts the room balance test, which includes various scenarios and their corresponding pass or fail conditions. The balance test begins when the DIM 100 receives first and second data, comprising actual CFM measurements and design specifications, respectively.

The DIM 100 first verifies whether the standard requires balance to match the differential pressure requirements 171. If such a requirement doesn't exist, the DIM 100 records “NR” for no requirement and proceeds to the next unique parameter test.

Subsequently, the DIM 100 determines if the room requires positive or negative differential pressure 172. If there's no such requirement, the DIM 100 records “NR” and advances to the next unique parameter test.

For rooms requiring positive pressure, the DIM 100 checks if the supply is greater than the sum of exhaust and return 173. If it isn't, the DIM 100 records “Fail” and advances to the next unique parameter test. For rooms requiring negative pressure, it checks if the sum of exhaust and return is greater than the supply. If it isn't, the DIM 100 records “Fail” and proceeds to the next unique parameter test.

Then, the DIM 100 verifies if the room requires a balance differential 174. If there's no such requirement, the DIM 100 records “Pass” and proceeds to the next unique parameter test.

Finally, the DIM 100 applies the following checks 175:
For rooms requiring positive pressure:
   The percentage difference between total supply CFM and the sum of return and exhaust CFM shall be greater than the minimum allowable percentage, i.e., (Supply CFM/(Return CFM+Exhaust CFM))−1 shall be greater than the minimum allowable percentage.
   The absolute difference between total supply CFM and the sum of return and exhaust CFM shall be greater than the minimum allowable volume, i.e., Supply CFM−(Return CFM+Exhaust CFM) shall be greater than the minimum CFM.
For rooms requiring negative pressure:
   The percentage difference between the sum of return CFM plus exhaust CFM compared to total supply CFM shall be greater than the minimum allowable percentage, i.e., ((Return CFM+Exhaust CFM)/Supply CFM)−1 shall be greater than the minimum percentage.

The absolute difference between the sum of return CFM and exhaust CFM less total supply CFM should be greater than the minimum allowable volume, i.e., (Return CFM+Exhaust CFM)−Supply CFM shall be greater than the minimum CFM.

The term “approximately” as applied within the California Mechanical Code, for example, is interpreted by the DIM 100 within a defined margin of error based on industry standards or measurement accuracy. This applies when the minimum percentage and minimum volume difference is an approximate value. If the minimum conditions aren't met, the DIM 100 records “Fail”. If they are met, the DIM 100 records “Pass” 176 and concludes the balance test.

The DIM 100 facilitates this process and records the results 177, using the room's function and the applicable standard to determine the necessary requirements, thereby preventing potential omissions. This method effectively matches the relevant standards with the specific rooms.

The final evaluation of the balance test by the DIM 100 is an overall assessment: if all of the results from unique tests 171, 172, 173, 174, 175 are either “NR” or “Pass”, the room passes the balance test. However, if any single test fails, the room fails the balance test.

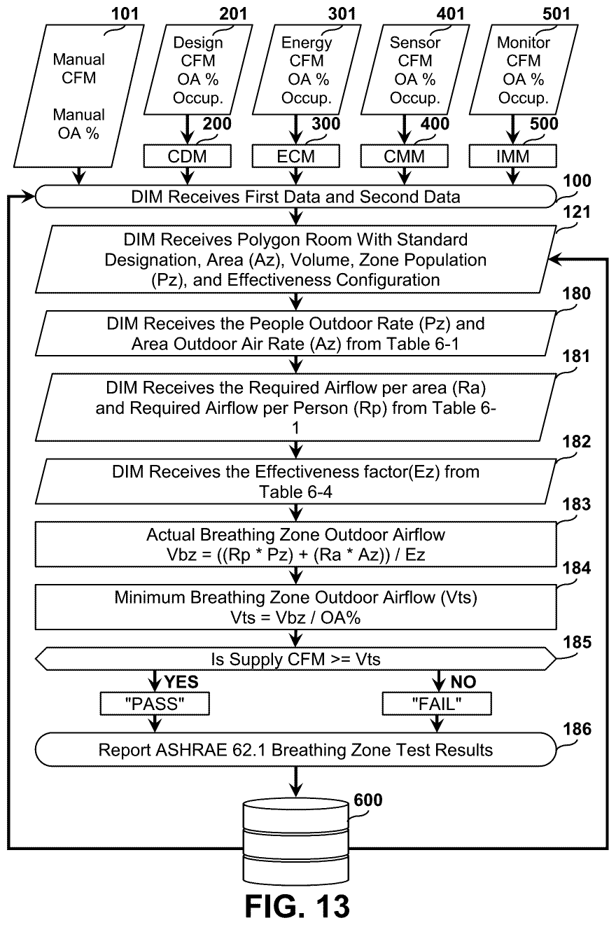

FIG. 13 illustrates the Breathing Zone Test. The test uses CFM design specifications, OA% specifications, and occupancy levels—vital elements in building design—as initial data 201, 301, 401, 501 for the CDM 200, ECM 300, CMM 400, and EVIM 500. The DIM 100 initiates this test for rooms within its scope, pulling the necessary information 121 from database(s) 600. The test adheres to the ASHRAE 62.1-2022 standard or equivalent ventilation requirements, with a goal to ensure suitable outdoor airflow for specified occupancy levels.

ASHRAE 170 is another essential guideline emphasizing complete compliance with ventilation standards. The design exhaust CFM conditions for achieving a passing certification must be determined based on the higher value derived from either the ASHRAE 170 or the ASHRAE 62.1 standard. Hence, calculations following both standards must be performed 193.

The test incorporates the standards of ASHRAE 62.1-2022 or similar ventilation requirements. Its objective is to ensure the appropriate outdoor airflow for the specified occupancy levels. Central to this test is the application of Equation 6-1 (Page 16) and Equation 6-4 (Page 24), which dictate the computation of the requisite and actual outdoor airflow within a given breathing zone, respectively.

ASHRAE 62.1, Equation 6-1: Breathing Zone Outdoor Airflow

Vbz=(Rp×Pz)+(Ra×Az), 183 where:
Vbz represents the outdoor airflow required in the breathing zone of the occupiable space or spaces within a ventilation zone 183;
Az corresponds to the net occupiable floor area of the ventilation zone, measured in square feet (ft²) or square meters (m²) 180;
Pz signifies the number of individuals present in the ventilation zone during its usage 180;
Rp denotes the outdoor airflow rate required per person, as determined by referencing ASHRAE 62.1, Table 6-1 181; and,
Ra represents the outdoor airflow rate required per unit area, as determined from ASHRAE 62.1, Table 6-1 181.

ASHRAE 62.1, Equation 6-4 quantifies the zone outdoor airflow introduced by the supply air distribution system.

Voz=Vbz/Ez, where:
Vbz (Breathing Zone Outdoor Airflow), as determined by Equation 6-1 184; and
Ez (Zone Air Distribution Effectiveness), a parameter reflecting the efficiency of air distribution within the zone, influencing how effectively outdoor air reaches occupants, as determined from Table 6-4 183.

Equation 6-1 quantifies the required outdoor airflow in the breathing zone 183, factoring in occupancy and area. Equation 6-4 then calculates the actual outdoor airflow brought into the ventilation zone, considering distribution efficiency 184. The test result (pass or fail) 186 depends on the supply air originating from the outside air 185. The test checks if the total CFM exceeds the calculated value 184 for Vts.

The DIM 100 applies the polygon relationship and zone assignments to fulfill the computational requirements of the published standard. ASHRAE 62.1 C2.2 (Page 44) Zone Air Distribution Effectiveness, mandates that “[z]one air distribution effectiveness (Ez) shall be computed in accordance with Equation C-1 for each computational cell in the breathing zone. The zone air distribution effectiveness (Ez) of the system shall be the average value of the zone air distribution effectiveness of each computational cell within the breathing zone. The analysis shall be performed for both summer cooling conditions and winter heating conditions.”

ASHRAE 62.1 C2.2 (Page 44) Zone Air Distribution Effectiveness further highlights the importance of these calculations, including the use of validated measurements at all phases of the building life cycle, stating, “[v]alidation of the computational model with physical measurements during design can improve the accuracy of the computational model and the zone air distribution effectiveness of the system. Field measurements could also be performed post-building occupancy to verify zone air distribution effectiveness.”

In ASHRAE 62.1, the zone air distribution effectiveness (Ez) is a vital factor for evaluating how effectively outdoor air is distributed within a ventilation zone. The determination of Ez is a crucial step in ensuring that occupants receive the intended amount of fresh air for optimal indoor air quality. The process for calculating Ez 190 is defined as follows:
Calculation Method: Ez is determined using either Table 6-4 or Normative Appendix C, depending on the circumstances of the ventilation system and space; and,
Default Value Variation: Some configurations have default values of Ez that are dependent on the space and supply air temperature. This understanding acknowledges that different spaces and environmental conditions can impact the efficiency of air distribution within the zone; and,
Normative Appendix C: The calculation of Ez using the procedures in Normative Appendix C may yield values greater than those listed in Table 6-4. This realization acknowledges that specific system configurations and design approaches may result in higher effectiveness values, indicating better air distribution within the zone.

This parameter takes into account factors such as room layout, supply air distribution, and occupant positions. A higher Ez value indicates more effective distribution of outdoor air, leading to improved indoor air quality and occupant comfort. ASHRAE 62.1 specifies the methodology for calculating Ez 192, ensuring ventilation systems achieve the intended air distribution effectiveness.

ASHRAE 170 serves as a critical guideline that prioritizes comprehensive compliance with ventilation standards by emphasizing the necessity of adhering to the more stringent of two relevant air change requirements. This directive underscores the fundamental principle that the design exhaust CFM conditions for achieving a passing certification must be determined based on the higher value derived from either the ASHRAE 170 or the ASHRAE 62.1 standard. Therefore, along with the breathing zone calculation 184, the result must be compared to minimum CFM for ACH 156 and OACH 159, and the greater value among the two must be met.

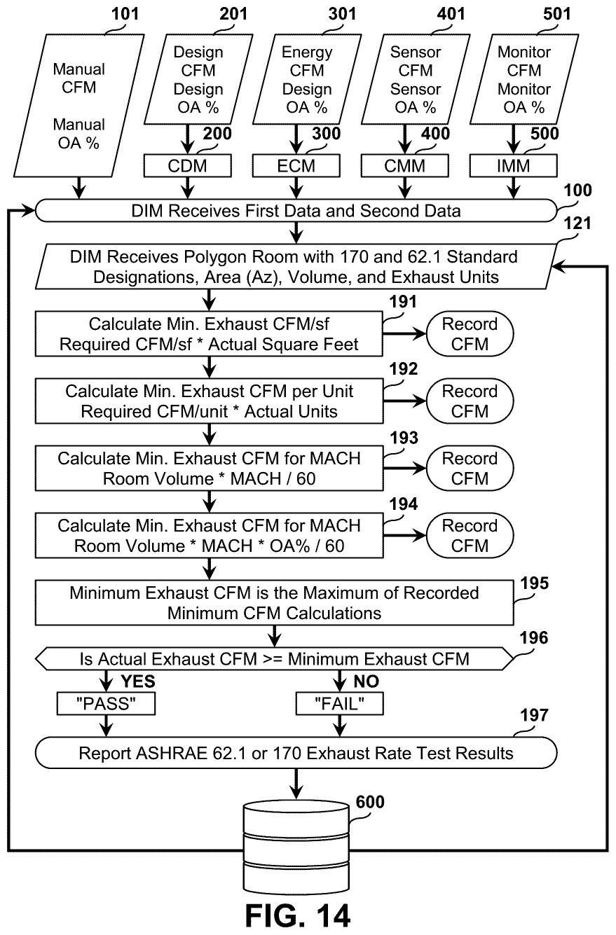

FIG. 14 integrates minimum exhaust requirements for rooms in healthcare facilities, using rates from ASHRAE 62.1-2019 (Table 6-2, Page 21) and air change, balance, and pressure requirements from ASHRAE 170-2021 (Table 7-1, Page 14). Initial data 201, 301, 401, 501, based on these inputs, are processed by modules CDM 200, ECM 300, CMIVI 400, and IMM 500. Following data processing, the DIM 100 initiates specific tests for rooms within its scope, retrieving room data 121 from database(s) 600 for this purpose.

Table 6-2 details exhaust rates for various occupancy categories, considering both the rate per unit and per area. In addition, Table 7-1 establishes a minimum number of air changes per hour. ASHRAE 170 requires compliance with the most stringent standards between the two, necessitating the inclusion of all calculations to accurately report on compliant infection control conditions.

Table 6-2 classifies occupancy types, each having unique ventilation requirements. The DIM 100 records the minimum exhaust results based on CFM per square foot 191 and CFM per unit for further comparison. Occupancy types including showers, residential kitchens, private and public toilets necessitate a minimum CFM per unit. The DIM 100 calculates exhaust rates based on the unit count for spaces with a significant potential for contaminants or odors and records this data for future comparison.

ASHRAE 170 Table 7-1 prescribes minimum ACH and minimum OACH. The DIM 100 records the ACH calculation 193, based on total exhaust air, and OACH changes 194, based on the zone outside air mix rate. Often, the zone mix rate includes the supply air mix rate of the adjacent space transferring air to the exhausted space. DIM 100 uses adjacent polygons received 121 from the database(s) 600 to determine the OA % for rooms without supply air. For rooms with supply air, the OA % is determined from the mix associated with the registers within the room.

For rooms standardized under ASHRAE 170, the minimum CFM is determined by the maximum of four minimum CFM calculations 195. A pass-or-fail test is conducted 196, comparing the actual CFM from sensors 404, 401, the BAS 504, 501, or manually acquired values 101. This comparison becomes especially significant when new design CFM or OA % is received 301 from an energy conservation model 304.

Exhaust rates, calculated by incorporating all standards and adjacent spaces 197, are crucial for producing accurate ventilation reports and meeting the unique ventilation needs of different spaces. The integration of ASHRAE 62.1 and ASHRAE 170, along with the consideration of room relationships, ensures the ventilation report adheres to the most stringent standards. When a room's function under ASHRAE 170 aligns with an occupancy category from ASHRAE 62.1, both frameworks are taken into account. As per ASHRAE's instruction in Table 7-1′s footnote 2, the ventilation requirements aim to provide comfort, asepsis, and odor control in healthcare spaces directly impacting patient care. For spaces not explicitly mentioned, requirements from equivalent functional spaces are applied, or ASHRAE 62.1 standards are used if no equivalent exists and no other codes or standards apply. If both ASHRAE 62.1 and ASHRAE 170-2021's Table 7-1 prescribe rates for a space, the higher rate is applied.

This methodological approach ensures thorough and accurate ventilation reports, which are essential in healthcare facilities, and contributes to superior indoor air quality and occupant comfort.

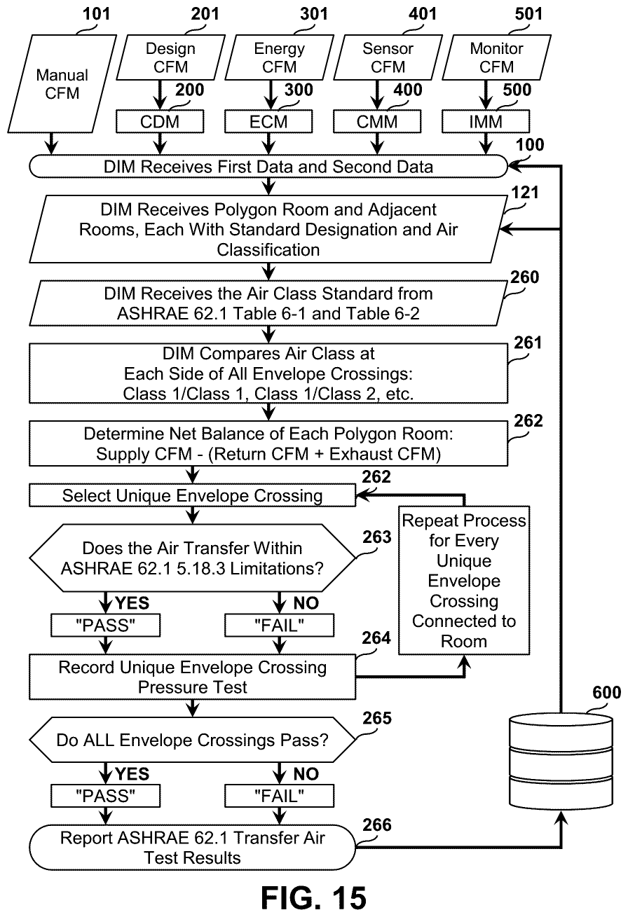

FIG. 15 illustrates the process of determining air transfer and recirculation, based on ASHRAE 62.1 air classifications and CFM design specifications. The process begins within the central DIM 100, which receives CFM design specifications from the CDM 200, ECM 300, CMM 400, and IMM 500 modules. Subsequently, the DIM 100 initiates a pass/fail testing procedure for rooms within its scope, pulling necessary room and polygon data 121 from the associated database(s) 600.

ASHRAE 62.1 classifies air into four distinct categories, labeled as Class 1 through Class 4, each with their own rules governing air transfer and recirculation:
Class 1 Air allows recirculation and transfer to spaces with any other class of air (Class 2, Class 3, and Class 4). However, rooms requiring Class 1 air should not accept the lower-class air;
Class 2 Air allows recirculation within the originating space and permits transfer to spaces sharing similar purposes and pollutant sources (Class 2 and Class 3). Additionally, transfer to toilet rooms and Class 4 spaces is authorized. Class 2 air can be recirculated in Class 1 spaces under specific energy recovery device limitations;
Class 3 Air, within this classification, recirculation is permissible within the space of origin. However, transfer to other spaces is restricted. An exception applies for recirculation when energy recovery devices are employed, subject to defined constraints; and,
Class 4 Air, within this classification, both recirculation and transfer are prohibited. This restriction applies not only within the originating space but also extends to transfer to other areas. In essence, this classification is required to have a negative balance, negative pressure and be fully exhausted.

Utilizing complex polygon room definitions, the DIM 100 identifies intersections 261 between rooms. A matrix is then constructed, combining the different air classes to model potential air transfer dynamics.

The transfer air dynamics 261 between different air classifications can be detailed as follows:
Class 1/Class 1: Air transfer is permissible in both directions between Class 1 rooms. This flexibility underscores the inherent compatibility of spaces with similar characteristics;
Class 1/Class 2: Transfer from Class 1 to Class 2 is authorized, allowing the movement of air from spaces designated for general purposes to those tailored for specific activities. However, the reverse transfer is not allowed to maintain the integrity of Class 2 environments;
Class 1/Class 3: Similar to Class 1/Class 2, transfer from Class 1 to Class 3 is permissible. This accommodates the controlled exchange of air between versatile spaces and those catering to more specific tasks. Transfer from Class 3 to Class 1 is not allowed;
Class 1/Class 4: Transfer of air is feasible from Class 1 to Class 4. This mandates the creation of a positive directional flow from Class 1 to Class 4. However, the reverse transfer is not allowed, upholding the strict isolation of Class 4 spaces;
Class 2/Class 2: Transfer within the same classification is allowed, facilitating the exchange of air between spaces with similar purposes and pollutant sources. This serves to maintain consistent air quality within distinct areas;
Class 2/Class 3: Transfer from Class 2 to Class 3 is authorized, enabling controlled air movement between spaces designed for specialized tasks and more versatile environments. However, transfer from Class 3 to Class 2 is not permissible;
Class 2/Class 4: Air transfer from Class 2 to Class 4 is permitted, adhering to the directional flow principles outlined for Class 1/Class 4. Reverse transfer is not allowed;
Class 3/Class 3: Within Class 3 classification, air transfer is not allowed to maintain the isolation of spaces, despite the potential for similar purposes;
Class 3/Class 4: Similar to Class 3/Class 3, air transfer between Class 3 and Class 4 is not permitted, ensuring the containment of contaminants;
Class 4/Class 4: As with Class 3, air transfer within Class 4 classification is restricted to maintain stringent isolation principles;

Upon receiving design CFM 201 and actual measurements 101, the system calculates the net balance of a room. This cumulative net balance at unique envelope crossings 262 is used to compute total net transfer air for each room. Each envelope crossing is tested uniquely 263 and the test for that envelope crossing is recorded 264. Following this, a comprehensive test 265 examines all envelopes crossings associated with a room. A room passes the test only if all of its envelope crossings meet the stringent ASHRAE 62.1 requirements. A room is reported, with schematics, with all envelope crossing represented 266.

Of particular interest is the Corridor Transfer Air Report generated by the DIM 100. Corridors present unique challenges due to their size, numerous envelope crossings, and the presence of fire doors designed to isolate specific zones in a facility. This report quantifies the net transfer of air at each fire door, a key factor in the proper functioning of these life safety devices.

The report considers the net balance and net transfer of air for all rooms within a zone that can be contained behind a firewall or fire doors. Understanding the interconnected relationships between rooms, facilitated by the complex polygon definitions for each room, is crucial. By examining these relationships, the report can assess the overall impact of individual room air dynamics on the larger zone. This detailed analysis provides valuable insights into potential safety concerns, particularly regarding the operation of fire doors and the containment of potential hazards.

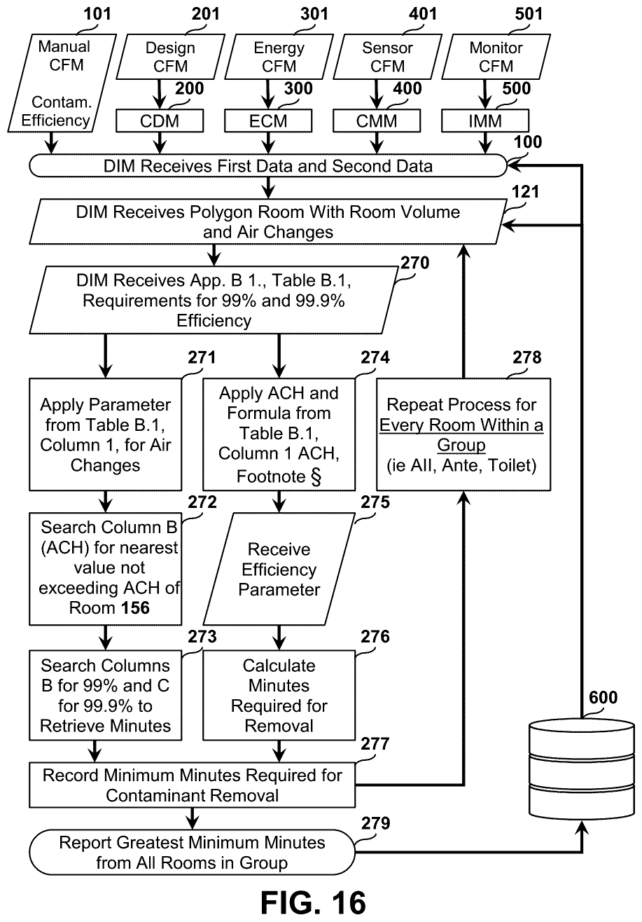

FIG. 16 provides a representation of the process for reporting the required time for airborne contamination removal. This process is instructed by the Guidelines for Environmental Infection Control in Health-Care Facilities, a publication issued by the CDC in April 2023. This procedure is orchestrated by the central DIM 100 module, which assimilates CFM design specifications and monitored conditions from the CDM 200, ECM 300, CMM 400, and IMM 500 modules. Additionally, this module incorporates manually acquired CFM as part of its initial data (first data 101).

The first data 101 delivered to the DIM 100 includes infection control instructions. The aforementioned guidelines—a collaborative effort between the CDC and ASHRAE—underscore the importance of airborne contaminant removal. A notable feature of these guidelines is Table B.1 (Page 223), which specifically includes ACH to determine the necessary time needed for contaminant removal at various efficiency levels. The DIM 100 integrates these guidelines, especially Table B.1, into its first data 101. This table offers two primary categorizations for determining contaminant removal time: the efficiency factor (which corresponds to 99% or 99.9% removal) and the known air changes within the room. The CDC has conveniently organized the data into air change ranges and provided a formula to calculate the re-occupancy time for the room. Applying the table requires ACH computation to enforce regulatory standards or recommendations.

To initiate the contaminant removal time calculations for rooms within its jurisdiction, the DIM 100 retrieves the necessary room and polygon data 121 from the associated database(s) 600. The DIM 100 doesn't limit its consideration to data from a single room, such as an All room. It also takes into account the adjacent spaces, particularly crucial in All suites where contaminants could have permeated into neighboring spaces, including the ante-room and the restroom. Including adjacent spaces within a contaminated space is of crucial importance in healthcare settings where the required ACH for ante rooms and toilet or shower rooms may be significantly lower than for the primary patient or isolation room.

The DIM 100 follows one of two routes, applying the requirements retrieved from the table that correspond to ACH ranges 271. After computing the room's ACH 156, the value is matched to the closest value in Column A of Table B.1 without exceeding it. For 99% efficiency, the necessary minutes are found in column B, and for 99.9% efficiency, the minutes are displayed in column C 273. Alternatively, an efficiency parameter 275 can be applied to the precise ACH 156 using the formula provided in Appendix B, Air. 1, Airborne Contaminant Removal footnotes (Page 223). Minimum minutes for each room are calculated 276 and recorded uniquely 277. This process is replicated 278 for all rooms in the suite.

The maximum of the minimum minutes calculated for all rooms in the suite is deemed the minimum re-occupancy time for the suite 279. Reports generated by the DIM 100 encapsulate all rooms, detailing every register and envelope crossing and applying the CDC recommendations. These reports also specify the minimum duration that a room must remain vacant following an airborne contaminant exposure for each room and for the suite as a whole.

Contaminant removal extends beyond healthcare facilities and is equally applicable to cleanrooms and other manufacturing facilities. According to the “ASHRAE Design Guide for Cleanroom: Fundamentals, Systems, and Performance” ASHRAE 2017, it is essential to substitute speculation with precise reporting and utilization of factual data. ASHRAE states, “[i]nstead of using guesswork for selection of an HVAC configuration, airstream properties need to be calculated and psychometric characteristics can be analyzed to obtain more predictable indoor conditions through computer simulations” (Section 8.3, Page 158). Additionally, ASHRAE notes, “[c]ritical parameters and operational values [should] be monitored and tracked” (Section 8.3.3, Page 159). The DIM 100, in an embodiment, applies cleanroom parameters and correlates them with the intricate features of zones and rooms within a plant. It leverages standards data and actual room conditions to produce precise reports on air flow and differential pressure for each register located within the rooms of the environment.

In cleanrooms, every register holds critical importance in terms of its location, the direction of diffused air, air velocity, and air volume. ASHRAE underscores this priority, suggesting that “[p]roper placement of return or exhaust points close to high-concentration areas can remove particles more efficiently. Effective return and exhaust pattern designs should achieve a higher contaminant removal effectiveness value to ensure fewer particles accumulate on exposed surfaces and become surface particle contamination in cleanrooms” (Section 8.4.10, Page 171.)

This level of assessment and reporting, which includes schematics with a comprehensive list of airflow rates and differential pressure measurements for every register and envelope crossing, is vital in cleanrooms, where any minor variance can significantly impact the efficiency of the plant. Therefore, any air balance report that does not convert all these features—including location, direction of diffused air, air velocity, and air volume—into a schematic for every grille and every envelope crossing is failing to contribute to the maximum HVAC system efficiency as per ASHRAE's standards.

Furthermore, it is not enough for this air volume and contamination measurements to exist in a static form. Thus, the data, which includes the full spectrum of airflow rates and differential pressure measurements, must be retrievable and usable, not just part of a picture or a non-interactive spreadsheet. It must be verifiable and replicatable. It must be accessible, dynamic data that can be analyzed and applied to ongoing cleanroom management and optimization.

The invention, therefore, provides a novel solution by ensuring efficient contaminant control and optimal operational performance. It does so by addressing every critical element that contributes to the efficiency of the cleanroom environment, in line with ASHRAE's guidance. Worth noting, ASHRAE's guidance in 8.4.10 addresses cost-effective options for lowering cleanroom air changes. Similar to healthcare facilities, this is the confluence of safety, contamination removal, and energy conservation. Reports that are based on relationships of spaces, correct measurements, and applied standards, address this intersection.

FIG. 17A illustrates the duct system structure integrated with sensors 404 within an embodiment of the CMM 400. Centered in this depiction is the VAV system, which employs an AHU to deliver conditioned air from the supply fan 416 via the supply air duct 412 at a designated temperature to individual terminal units 410 within assorted zones or a specific room 107.

This system operates on the principle of air returning to the fan, an approach prevalent in energy conservation models aiming to maximize the reconditioning of air at a lower cost than conditioning fresh outside air. A return fan 417 pulls air through return registers 406 linked via a dedicated return air duct 413. In close proximity or within the AHU, the volume of returned air is controlled by dual louvres or dampers. The economizer 419 opens to allow more air into the supply fan outside air mix cabinet, while the return air louver 421 reduces the volume of air exiting the system. An outside air louver 420 can further limit the intake of outside air, thereby reducing the static pressure needed to return air to the supply fan.

In the VAV system, thermostats 409 in each zone measure and adjust the temperature set point. Pre-heating and cooling coils 415, incorporated in line with the supply air fan 416 control the primary or common temperature to additional conditioning units downstream.

Terminal units, also known as VAV boxes 410, control the air volume and temperature at the supply registers 405 downstream of the unit. Individual registers feature manual outlet dampers 408 to balance the air and distribute it proportionately. Branch dampers 411 balance larger sections of the distribution. Each terminal unit manages airflow independently, causing the overall volume supplied by the AHU to fluctuate according to the cumulative demand from all connected boxes. This design airflow is primarily achieved by modulating the speed of the supply fan 416 in response to the total demand from all terminal units 410.

A static pressure sensor 404, typically positioned at the inlet of a terminal unit, measures airflow by assessing the differential pressure on either side. The measurement is transmitted as a wired signal to the VAV controller, which calculates the airflow rate based on these values. When a significant variance is detected, the VAV controller instructs the actuator to adjust the damper position within the terminal unit.

In the context of the presented invention, the measurement of airflow rate can be acquired from the VAV sensor 404 by integrating it with the BAS 504 and the CMM 400. Sensors 404 connected to the CMM 400 system measure changes in airflow patterns, identifying anomalies that may indicate failing conditions such as insufficient ventilation or contaminant buildup. By capturing real-time data and comparing it against established ventilation standards, the DIM 100 can promptly flag discrepancies and generate reports highlighting areas requiring attention.

FIG. 17B represents a fully exhausted HVAC system, typically referred to as a 100% outside air system. In this system, there is no return mechanism, hence the absence of economizers 419. Air is drawn directly from the outside and supplied to the rooms. Instead of a return system, the room features exhaust grilles 407 which guide the air into the exhaust air duct 414, leading towards the exhaust fan 418. This air is then expelled back to the outside environment. The sensor configuration in this system closely mirrors that of a return air system, except for the absence of sensors that monitor mix rate.

FIG. 17B is an example and does not represent all scenarios where air is exhausted. Exhaust fans 418 and registers 407 exist within systems that have returned and reconditioned air. Sensors 404 may be installed to monitor volume, as well as particulates in the air. Exhaust fans 418 are assigned to the unique rooms 107 and registers 407 in the grille mapping process just as they are for supply 405 and return registers 406.

FIG. 17C depicts an HVAC supply fan system with multiple branches. Each branch serves different zones where a zone may consist of multiple rooms. The supply fan 416 pushes conditioned air into the supply air duct 412. In this example, every branch is equipped with a branch damper 411, and at least one damper is fully open at all times. Other branch dampers can be adjusted to manage the air distribution across all branches, as per ASHRAE 111.

Terminal units 410 are downstream of the fan and upstream of the final distribution or grille. Each terminal unit has a CAV/VAV damper 422. Within each branch, at least one CAV/VAV damper is fully open, providing adequate airflow to the respective zone. The CAV/VAV dampers 422 are typically modulated by an actuator connected to the BAS 504, which, when operating correctly, should honor the concept prescribed by ASHRAE 111 to keep at least one CAV/VAV damper fully open at all times.

Conditioned air from the terminal units 410 is delivered to rooms 107 through supply grilles 405. Each supply grille has an outlet damper 408. At least one outlet damper downstream of the VAV is fully open, while others are manually adjusted as required to achieve the design proportional balance.

Sensors 404 monitor airflow and temperature changes. Their readings are used by the BAS 504 to adjust the position of the CAV/VAV dampers and fan speed. In this system, only the terminal or VAV dampers are controlled by the BAS 504, making it crucial to manually record the position of the branch and outlet dampers.

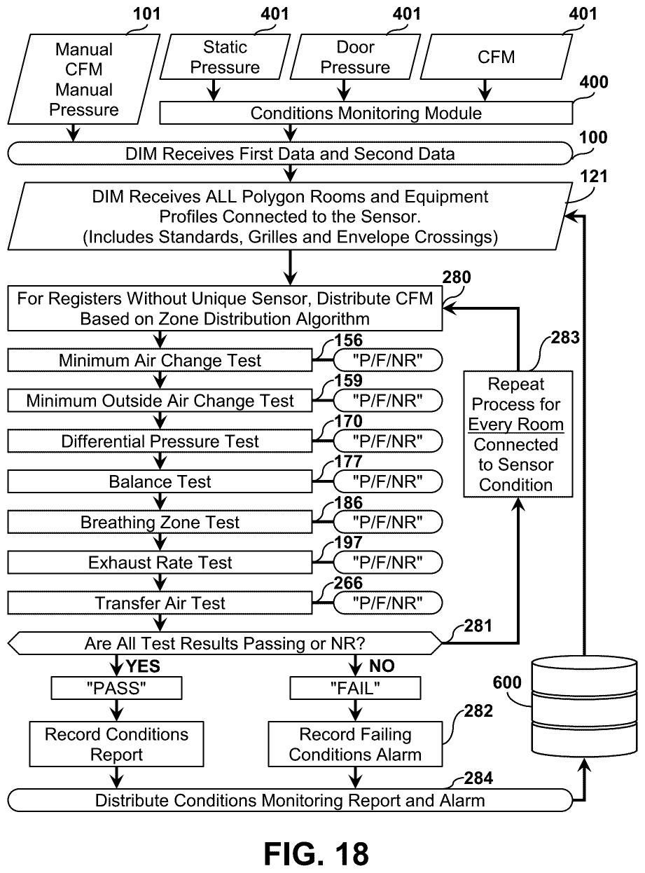

FIG. 18 illustrates the Condition Monitoring Test Cycle in an embodiment of the invention. The CMM 400 receives data from a sensor 404, capturing HVAC conditions for a specific room, zone, or HVAC component. All rooms linked to the sensor, including adjacent spaces within the distribution area connected by an envelope crossing, are considered when generating reports from the sensor data.

The test cycle is performed within the DIM 100. The test relies on three levels of information: raw data, first data, and second data. The sensors 404, which can exist externally to this invention, receive raw data directly from the space or equipment. This data is relayed as first data 401 to the CMM 400. The DIM 100 receives this data, which includes actual dimensions, regulatory standards, and ASHRAE or industry reporting standards, to generate reports for rooms and corridors, encompassing every grille and envelope crossing.

The tests, as outlined in previous figures, are conducted according to ASHRAE standards. For rooms designed to comply with ASHRAE 170, tests include the MACH, MOACH, differential pressure, balance, breathing zone, and exhaust rate. For rooms and corridors subject only to ASHRAE 62.1, the breathing zone, exhaust rate, and transfer tests are applied. These tests are filtered within the DIM 100 based on the standard applied to each room and adjacent space, or polygon. All parameters must consider the adjacent spaces for certification. The process of testing a room is repeated for every room connected to a sensor 404 condition or its associated equipment.

Each test is assigned a pass, fail, or no requirement result, independently recorded. If the sensor 404 reports a change in CFM, the DIM 100 applies this new reading to every register affected. When a sensor is not linked to a unique grille within a distribution downstream of a terminal unit, the CFM is distributed based on proportional balancing or pre-recorded static controls within the distribution.

The DIM 100 processes various tests, including ACH 156, OACH 159, Differential Pressure 170, Balance 177, Breathing Zone 186, Exhaust Rate 197, and Transfer Air 266. If any test fails 281, the room is recorded as failed 282. Test results are recorded, and in the event of a failure, an alarm or repair recommendation is provided. This report includes the complete data set within the polygon configuration of the room. Reports are distributed as alarms 284, particularly in the event the failing conditions concern infection control.

In scenarios requiring infection control reports and contamination removal calculations 273, 276, the system also calculates the new minimum required time in minutes for each room 279. This computation extends to all rooms within a suite, thus ensuring comprehensive coverage. The detailed process for these calculations is explained in the FIG. 16 description, showing the system's ability to integrate vital data across various testing phases. Notably, these calculations incorporate the results from the ACH test 156 conducted during the CMM 400 testing process. Once these calculations are complete, the results can be promptly relayed to nursing and administrative staff 284.

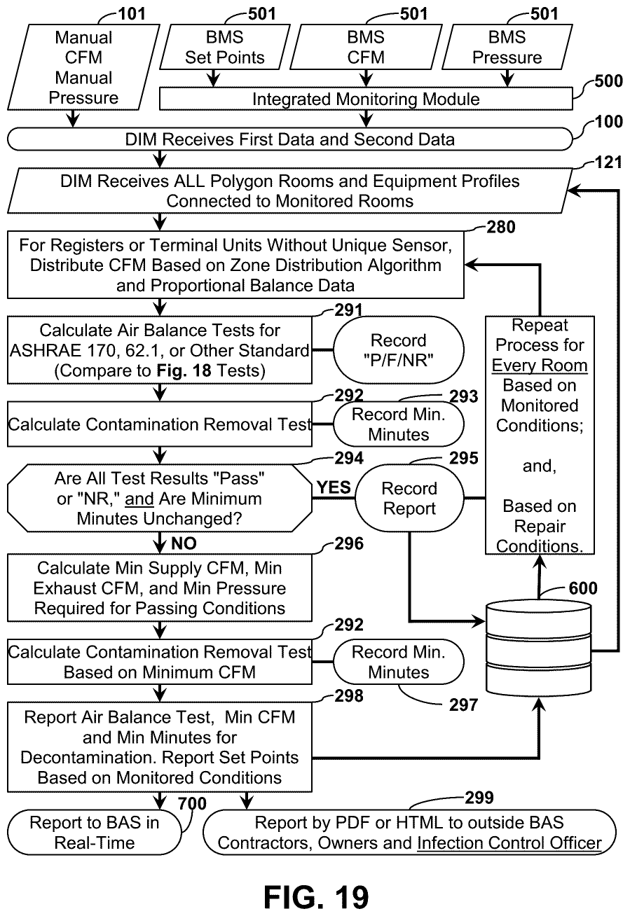

FIG. 19 presents the test cycle and reporting process within the DIM 100 based on the second data 502 received by the IMM 500. The IMM 500 obtains data from the BAS 504, which gathers raw data from various zone and equipment monitors linked to HVAC equipment. These monitors may be sensors 404. This data facilitates a detailed analysis of airflow dynamics and their influence on individual rooms.

ASHRAE has explicitly described the correlation between monitored conditions and HVAC balance reporting. In ASHRAE 111 2008 (RA 2017) Chapter 6, system effect is explained. In section 6.2 (Page 19, Column 1) ASHRAE explains, “[a] phenomenon known as “system effect” can create undesirable conditions and cause reduced capacities within all or part of a system. Recognition of system effect can help in the evaluation of systems, in solving equipment performance problems, and/or in obtaining accurate testing and balancing reports.” The IMM 500 receives first data from the BAS 504 which is an external system. The first data from the BAS 504 is based on raw data retrieved from the HVAC system. The data 501 from the system distinguishes the second data from the IMM 500 to the DIM 100 from the second data from sensors 404 relayed from the CMM 400.

The DIM 100 applies the IMM 500 data 501 to virtual rooms or polygons for testing against regulatory standards. This data, paired with zone-specific standards, forms the basis for comprehensive reports indicating compliance status with ASHRAE and other standards. When a room or system fails to meet specified infection control requirements, remediation suggestions are generated and communicated back to the BAS 504. At the same time, notifications about air balance and infection control failures are dispatched to relevant personnel. These notifications contain critical failure information including location, time, and nature, along with guidance for rectification.

The IMM 500, distinct from the CMM 400, has a key feature relating to system automation or management. It undergoes the same tests 291 described in FIG. 18 and includes an additional contamination removal test 292. It also records the minimal duration between occupancies for each room 293. Any changes in this duration 294 are documented 297 and reported 298 to the BAS 504 or other users.

The IMM 500 calculates the minimum CFM requirements for rooms 296, akin to the decontamination minutes calculation process. Reports are delivered to the BAS 504 in real time and are accessible to other users in suitable formats 299.

The IMM 500 facilitates the tracking and real-time reporting of monitored conditions for the BAS 504. It also automates the update of BAS 504 set points in relevant databases, improving system adaptability to building changes. When room alterations are needed due to failures, the IMM 500 interfaces with databases to generate equipment repair reports.

The IMM 500 serves as a comprehensive tool for the evaluation, management, and reporting of room-specific ventilation and infection control deficiencies. It integrates with the BAS 504, the CMM 400, the CDM 200, and the ECM 300, ensuring regulatory compliance and enabling real-time responses to changes. Its capacity to generate instant reports, provide remediation suggestions, and interface seamlessly with databases enhances the efficiency of building operations and the safety of occupants.

FIG. 20 illustrates the structured database(s) 600, showcasing how various tables and data interact within this embodiment. The design of this database may be based on a relational model, meaning that information is organized into tables. These tables—building, adjustment, standard, envelope crossing, register, AHU, fan, terminal unit, room—house related data in a structured format with rows and columns.

Each table comprises data elements arranged in vertical columns, which are identifiable by name, and horizontal rows. The intersection of a row and a column forms a cell, housing a specific piece of data. While the number of columns in a table is fixed, the number of rows can be variable, accommodating any amount of data entries.

Every row is distinguished by the values in a particular subset of columns, known as the primary key, which uniquely identifies each row. When this primary key appears in a second, related table, it is referred to as a foreign key in the context of that table.

This database setup highlights the interconnectivity of diverse data elements. Although the tables are standalone, they are interconnected through primary and foreign keys, enabling complex data relationships and efficient data retrieval. This interconnectivity forms the foundation for the system's ability to manage and report room-specific ventilation and infection control deficiencies.

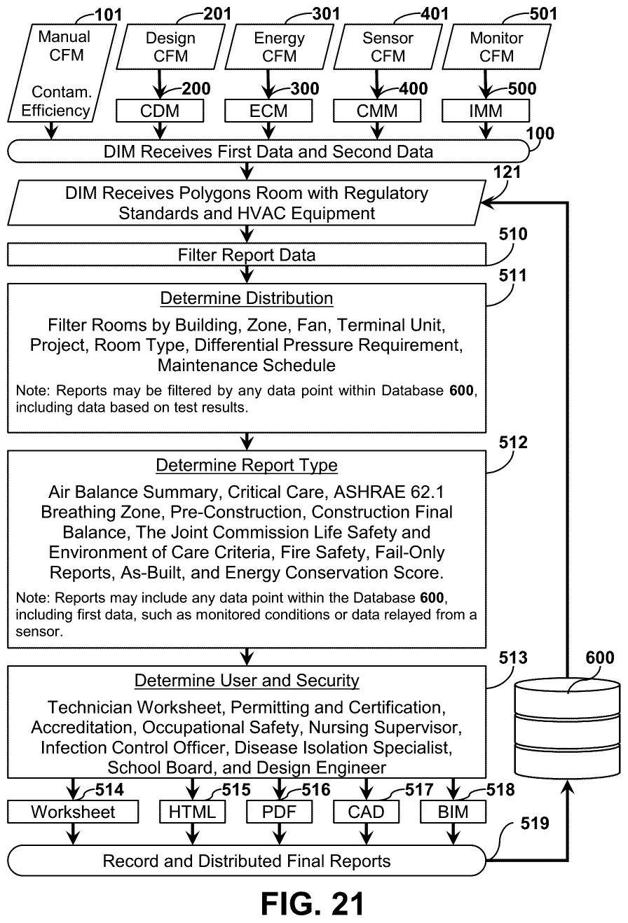

FIG. 21 illustrates the report generation process, a novel and critical function of the DIM 100. In this process, the DIM 100 integrates and processes data inputs from first data sources 101, 201, 301, 401, 501 and from the database(s) 600 to generate comprehensive, customized reports, identified as third data 103, 203, 303, 403, 503. Initially, the DIM 100 receives first and second data and acquires polygons associated with rooms 121, regulatory standards 101, and HVAC equipment 201. These elements collectively form a data set, ready for subsequent analysis and reporting. Significantly, reports are not only distributed back to the respective modules and to the TAB technician for immediate action, they are also converted back into first data, stored in the database for future reference.

The DIM 100 receives as first data 101 the reporting protocols for measurement, testing, adjusting, and balancing of building HVAC systems. These standards are embodied in the algorithms for calculating test results and also in the filtering and reporting process. ASHRAE 111-2008 (RA 2017) directs in Section 2.4 (Page 2, Column 2) that “[t]he field data collected and reported under this standard are intended for use by building designers, operators, and users, and by manufacturers and installers of HVAC systems.”

During the filter report data phase 510, the DIM 100 hones room data based on user-defined filters, encompassing building, zone, fan, terminal unit, project, room type, differential pressure requirement, and maintenance schedule 511. The DIM 100 utilizes any data point within the database(s) 600 as a filter, enabling users to customize reports to meet their precise needs.

The report type determination phase 512 empowers the DIM 100 to generate a variety of report types, including Air Balance Summary, Critical Care, ASHRAE 62.1 Breathing Zone, Pre-Construction, Construction Final Balance, The Joint Commission Life Safety and Environment of Care Criteria, Fire Safety, Fail-Only Reports, As-Built, and Energy Conservation Score. The DIM 100 can incorporate any data point from the database(s) 600 into these reports, enhancing their depth and relevance.

These reports may include schematics of the environment founded on building specifications stored within the first data, and lists of values, incorporating parameters such as air flow rate, ventilation rate, exhaust rates, transfer air, and differential pressure measurements.

The present application is a Continuation-In-Part of U.S. patent application Ser. No. 17/327,539, filed on May 21, 2021, by Corey Kilpack, titled “HVAC Air Balance Monitoring and Testing System.” The parent application introduced a novel HVAC air balance monitoring and testing system that includes a data integration module. This module is capable of receiving various types of data, including building specifications, HVAC equipment specifications, design conditions, and at least one regulatory standard.

Significantly, as emphasized by the Examiner in the Notice of Allowance of the parent application, issued Aug. 8, 2023, “the data integration module can generate a report, wherein the report includes a full list of values of at least one of air flow rate and differential pressure measurements of the at least one environment for every register located within the plurality of rooms within the at least one environment[.]” (Page 11, second paragraph, with emphasis). The Examiner highlighted a parallel feature for envelope crossings, noting that “wherein the data integration module generates a report, wherein the report includes a full list of values of at least one of air flow rate and differential pressure measurements of the at least one environment for every envelope crossing located within the plurality of rooms of the at least one environment[.]” (Page 12, first new paragraph, with emphasis)

The Examiner further cited with emphasis that the invention “generates a report and stores the report into the first data.” Particularly, the “schematic further includes the values from the parameter test conducted by the data integration module[.]” (Page 13, first new paragraph, with emphasis). This innovative inclusion of all parameter tests in the schematic is a core feature of the polygon mapping within a database and within the data integration module.

The disclosure of the parent application, including this innovative feature, is incorporated herein by reference in its entirety. These features are retained and further developed in the present application, which continues to exhibit the novelty and non-obviousness of the current claims.

The DIM's 100 user and security determination 513 allows for the customization of reports to cater to specific stakeholder requirements. These reports can also integrate values from infection control parameter tests conducted by the DIM 100.

The DIM 100 generates third data in a variety of formats, including a technician worksheet 514, HTML 515, PDF 516, CAD 517, and BIM 518, promoting accessibility and usability. Post generation, the reports are transformed back into first data and stored in the database, as well as dispatched back to the relevant modules and technicians. The reports are recorded 519 within the database(s) 600 and distributed as third data to users and to the modules.

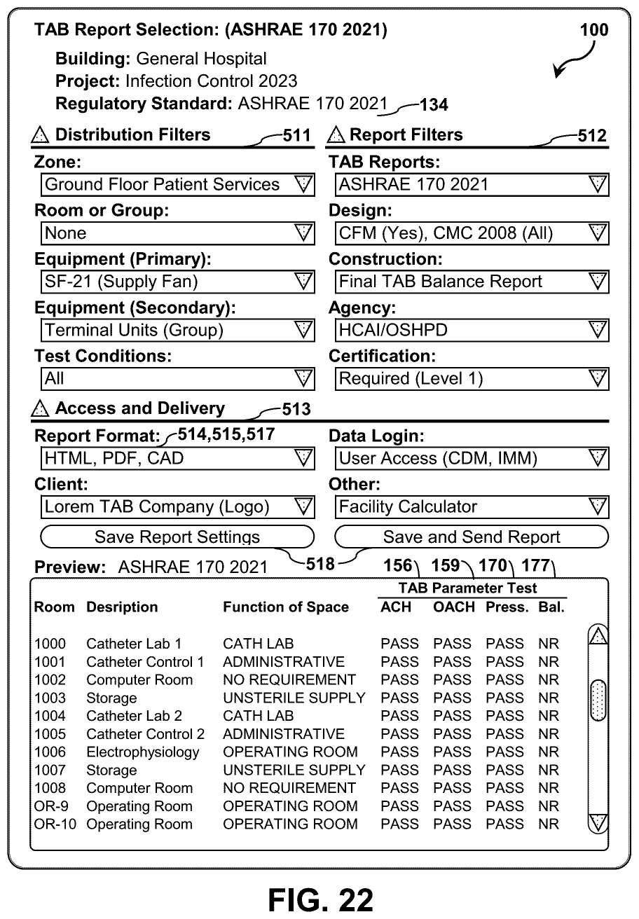

FIGS. 22 through 29 display the DIM's 100 user interface, featuring a preview pane that serves as a dynamic workspace. This interactive feature allows stakeholders to engage with their data and partake in the report generation process in real time. Each report type generated by the DIM 100 plays a distinct role in building management, aligning with applicable industry standards and revealing intricate information crucial for building operations.

FIG. 22 presents the filter settings for generating a summary TAB report. This specific report displays the outcomes of the ACH 156, OACH 159, balance 177, and differential pressure 170 tests. The report provides an extensive view of all rooms connected to the chosen supply fan. It lists each room with its corresponding room number, a brief description, and the function of space in accordance with the selected ASHRAE 170 or California standard. The summary TAB report may be distributed as third data 103, 203, 303, 403, 503 externally or to users of any module.

In this example, the distribution filters 511, report type filters 512, and access and delivery filters 513 are fully expanded. These filters allow users to tailor the report based on various parameters, thereby offering considerable flexibility and personalization. All the tests depicted in this example report conform to the chosen ASHRAE 170 standard.

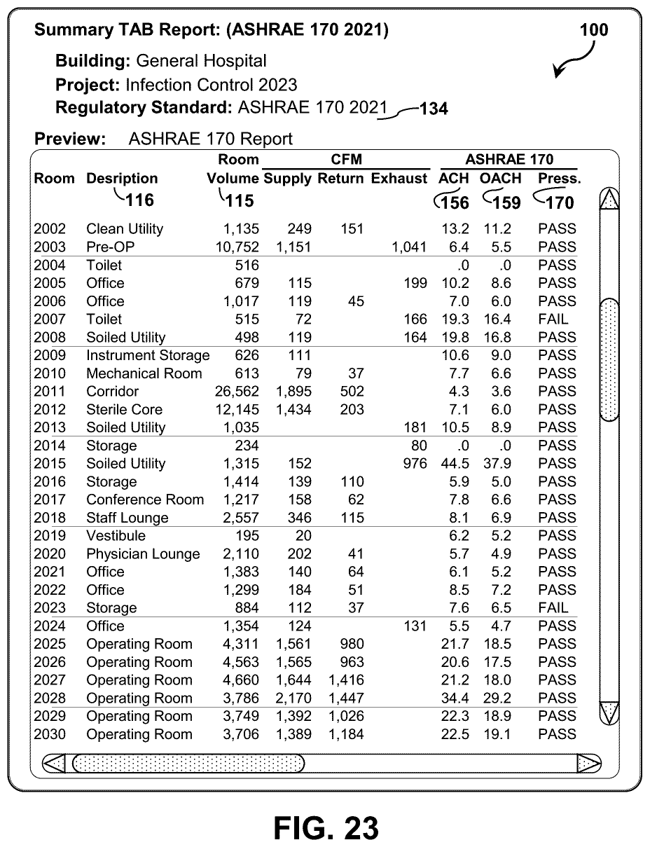

FIG. 23 features a preview of the Summary TAB Report data generated by the DIM 100 system. In this frame, the filters 511 are collapsed, putting the main data front and center. The report showcases the results of the ACH test 156, OACH test 159, and differential pressure test 170. Moreover, it displays the actual CFM values from the first data source for supply, return, and exhaust. A notable aspect of this view is the presentation of room volumes 115. These represent tangible measurement data acquired first-hand by a technician.

In the context of this report, the entire operating suite, including the corridors as highlighted in the description 116 for room 2011, has been examined and reported for infection control parameters. Although the function of space is not visible in this view of the report, all computations adhere to the ASHRAE 170 2021 standard requirements, ensuring the report's relevance and validity. This view is a subsection of the entire report, and users can apply more filters for specific applications. Therefore, the DIM 100 system offers a comprehensive and customizable tool for building management by combining detailed, real-world data with a flexible reporting system.

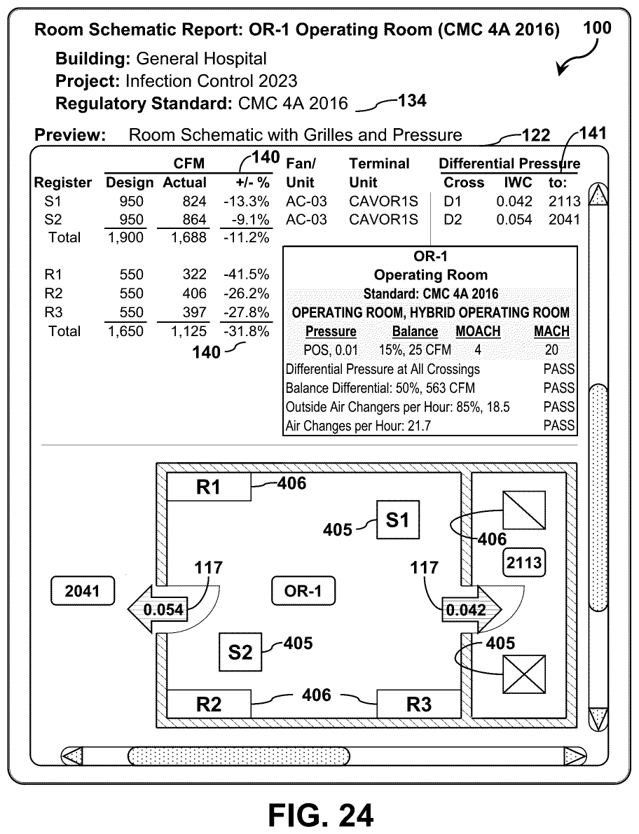

FIG. 24 reveals a pivotal aspect of the DIM 100 system's capabilities: the creation of comprehensive TAB Schematic Reports, rooted in the regulations of the California Mechanical Code 2016, Table 4A. In this representation, all filters in the DIM 100 user interface and preview are collapsed, honing focus onto the core report data.

The TAB Schematic Report for an operating room presents a detailed schematic with every grille and envelope crossing, inclusive of their respective values. This report showcases the DIM 100 system's ability to provide detailed and actionable insights. On display in the preview pane 122 is the report's capability to layer multiple data elements onto the polygon or virtual room. Envelope crossings 117 are presented with values and directions within the schematic. Supply 404 and return 405 registers are marked with unique identifiers, ensuring precision within the schematic's layout.

Moreover, the report serves as an infection control tool, presenting the pass/fail results per the California Mechanical Code's parameters, with the corresponding values. It includes design CFM 201 and the variance 140 of actual CFM 101 to design. These values are detailed per register, providing another layer of granularity to the data available.

Adjacent spaces are identified 141 using room numbers correspondent with the pressures listed in the report tables. In an embodiment of the DIM 100 system, the preview pane 122 doubles as a dynamic workspace, where users can input first data 101 directly into the system, underscoring its versatility and user-centric design.

The TAB Schematic Report, generated by the DIM 100 system, is an indispensable tool for technicians and building managers. It ensures regulatory compliance, provides a detailed overview of operating room operations, and offers a snapshot of infection control status. This level of detail is instrumental in early identification of potential issues and maintaining optimal building conditions. The DIM 100 system's comprehensive reporting capabilities illuminate its innovative approach to building management.

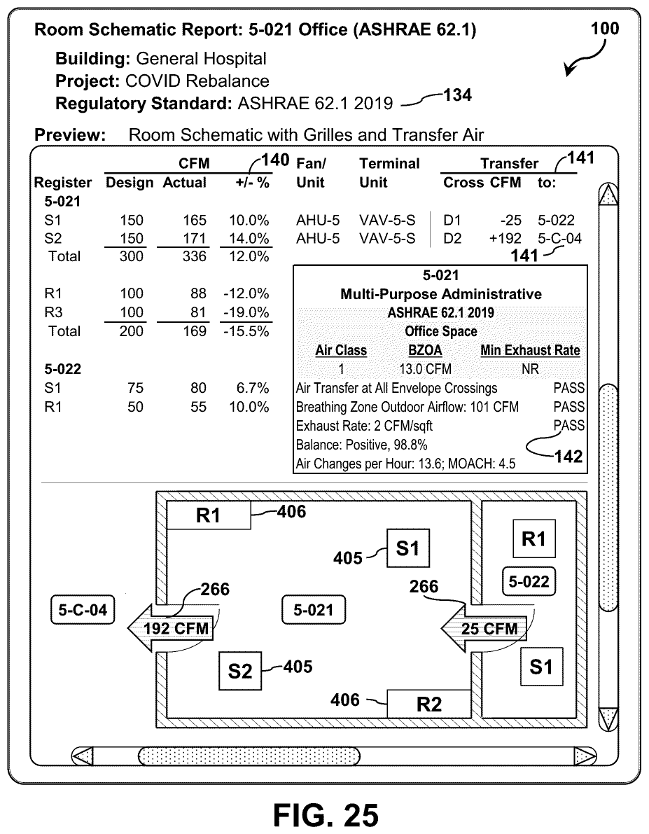

FIG. 25 introduces a TAB Schematic Report detailing a multipurpose room, tested and reported according to ASHRAE 62.1 guidelines. This comprehensive schematic showcases every register and envelope crossing in the room, with each register correlating to both actual 101 and design 201 CFM values.

Distinguished from the CMC 4A report seen in FIG. 24, this report's envelope crossings 177 highlight the transfer air volumes instead of the pressures in IWC, providing a different perspective on the room's air balance. This shift in reporting parameters offers invaluable insights into air circulation and distribution, vital for maintaining proper indoor air quality.

The report displays an air transfer scenario between two rooms—room 5-022 and the adjacent room 5021. The schematic also identifies transfer air at the adjacent corridor 5-C-04, demonstrating the system's attention to detail and consideration of the impact of adjacent spaces on air pressure and flow within the rooms.

The TAB Schematic Report incorporates pass/fail tests 142 based on all ASHRAE 62.1 standards, including transfer air, breathing zone, and exhaust rates. The actual values recorded for these tests in the featured room are also displayed, representing an innovation in the TAB industry. No known prior art in the industry offers comprehensive, room-specific reports adhering to all three ASHRAE 62.1 standards. FIG. 25 exemplifies the DIM 100 system's capabilities in providing detailed, context-specific reports that adhere to regulatory standards while exceeding TAB industry standards. It underscores its adaptability, versatility, and innovative approach to delivering actionable insights for improved building management.

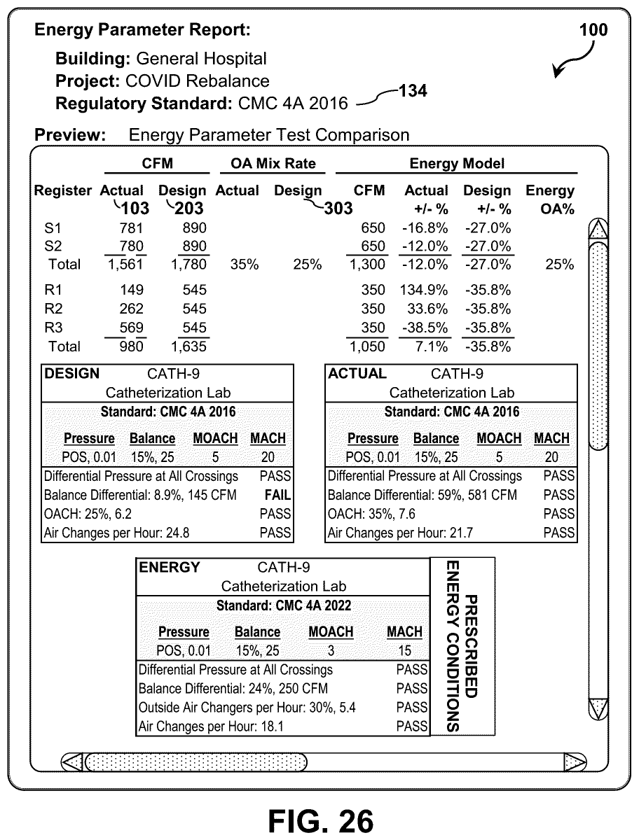

FIG. 26 exhibits a preview of an Energy Conservation Report generated by the DIM 100 system, complying with the standards outlined in CMC 2016, Table 4A. The user interface focuses on the core report data by collapsing all filters. The central feature of this figure is the

Energy Parameter Test Comparison for a tested catheter lab. This comparison encompasses three types of CFM measurements: design CFM 201, actual CFM 101, and energy CFM 301. These measurements represent the design specifications, the actual airflow taken during testing, and the optimal airflow determined by an energy model, respectively.

The design CFM 201 and actual CFM 101 are tested for the 2016 standard, while the energy CFM 301 is tested against the more recent 2022 standard. This demonstrates the DEVI' s 100 ability to incorporate updated standards to optimize energy efficiency without compromising safety or regulatory considerations. The report further indicates that the outside air mix rate can be reduced from 35% to 25% while retaining compliance with the newer standard, satisfying both safety requirements and energy conservation goals.

A significant feature of the DIM 100 system is its capacity to identify design elements that do not meet the parameter tests of the relevant standards. In the given example, the design CFM 201 does not comply with the standard and is show with a “FAIL” result for the design. If highlighted in a pre-construction report, such discrepancies can be addressed before construction commences, fostering construction efficiency with optimal airflow.

The DIM 100 system's comprehensive reporting feature also allows for the identification of potential energy-saving opportunities while maintaining stringent infection control standards. By evaluating every register and room on the fan distribution, the system delivers in-depth, actionable insights, underscoring its effectiveness in promoting energy conservation and superior building management.

FIG. 27 presents a groundbreaking feature in the DIM 100 user interface—a detailed facility worksheet providing comprehensive airflow data for every room in the distribution range of a fan, with filters collapsed for a streamlined view. The number of rooms that can be viewed, sorted, and filtered within this report and view of the data is unlimited. This report puts every room on a single table for technicians and engineers. This worksheet is of significant importance in light of room-specific adjustments made for COVID-19 precautions.

The facility worksheet provides comprehensive TAB data, including design features, regulatory standards, pass/fail results, minimum CFM requirements, and the excess or deficiency of CFM for supply, return, and exhaust for each room. This level of detail is crucial for achieving and maintaining optimal air quality and ensuring spaces meet regulatory standards for air change rates. The data in this worksheet takes into account every possible ASHRAE 170 parameter, including requirements based on adjacent spaces, making it a tool for comprehensive airflow management. It not only details the absolute minimum for every type of air but also provides the difference between the actual conditions and that minimum, effectively highlighting areas that need attention for passing conditions or for energy conservation.

This feature serves multiple purposes—it's a worksheet for data input, a report for data analysis, and a table for data presentation. In an embodiment of the invention, users can input or update data directly into the fields, and the system uses this data to generate a complete airflow report for the entire facility or rooms served by the fan.

In the context of a facility rebalance for COVID-19, where every room was rebalanced but still had to meet strict standards, this worksheet becomes an invaluable tool. It enables facility managers, HVAC professionals, and environmental health and safety officers to effectively track and manage airflow, ensuring the well-being of occupants. The complete facility room worksheet with regulatory standards represents a significant leap forward in TAB reporting and in HVAC management, ensuring optimal airflow conditions, maintaining regulatory compliance, and safeguarding public health.

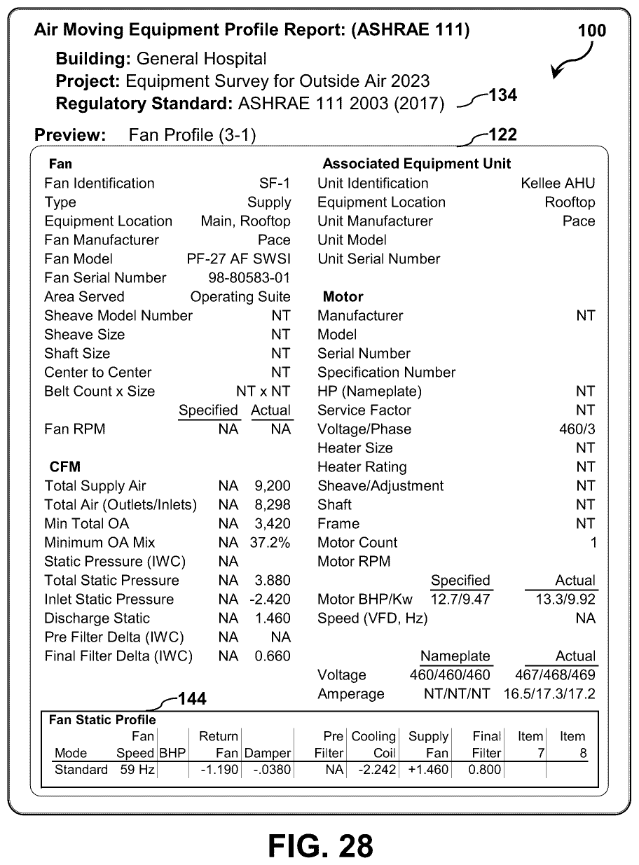

FIG. 28 presents a preview of a comprehensive Air Moving Equipment Profile in the DIM 100 user interface, specifically focusing on a supply fan 415 identified as SF-1. This preview 122 not only displays the detailed profile of the fan but it also serves as a worksheet for inputting data to generate a complete fan profile report.

The Air Moving Equipment Profile captures data about the supply fan, including its identification, type, location, manufacturer, model, and serial number. It extends to the fan's operational parameters such as CFM measurements and static pressure readings. The profile also includes an overview of associated equipment like the air handling unit and an in-depth profile of the fan's motor.

Integrated into the profile is the Fan Static Profile 144, which offers an intricate overview of the static pressures at various stages of the air handling process, starting from the first intake at the outside air louvres. This profile charts the pressures at every significant point in the system where air resistance can occur, such as dampers, filters, heating and cooling coils, and up to the final filter.

As a worksheet, this preview allows users to simultaneously input or update data directly into database(s) 600 and the reports. The system then uses this data to generate a complete fan profile report, providing a comprehensive overview of the fan's performance characteristics and the static pressures within the HVAC system.

This multifaceted functionality of the DIM 100 user interface serves as a vital tool for facility managers, HVAC professionals, and energy auditors. It tracks equipment performance, planning of routine maintenance, and identification of potential areas for energy conservation and efficiency enhancements, all within a single, user-friendly platform.

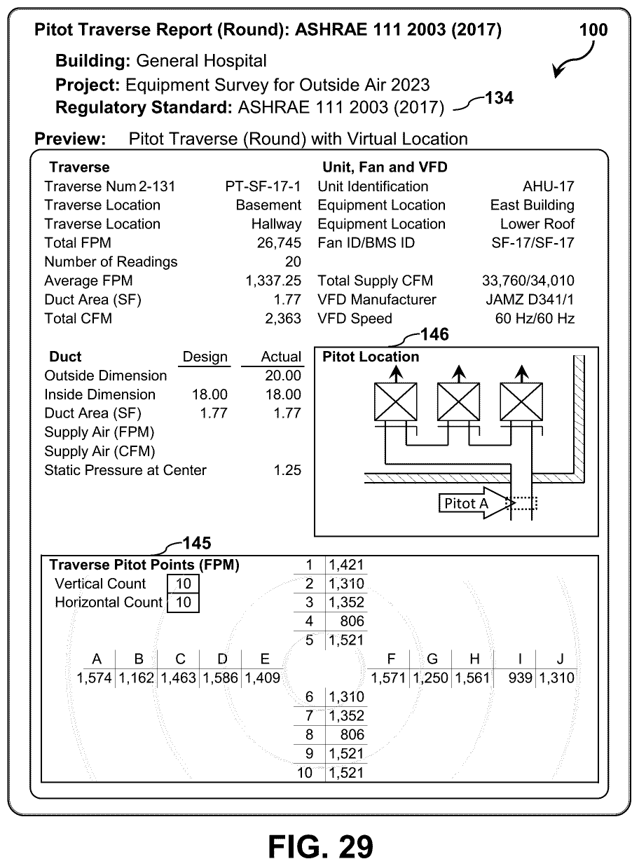

FIG. 29 presents a preview of the innovative Round Pitot Travers Report in the DIM 100 user interface. This report is a critical tool in the HVAC industry, used for measuring air velocity and flow rate within a duct using a pitot tube. The report provides detailed velocity readings at various points across the duct's cross-section 145, offering a comprehensive understanding of airflow characteristics.

The DIM 100 system integrates polygon mapping, a novel invention that significantly enhances the functionality and accuracy of equipment profiles, into traverse reports. In this Round Pitot Traverse Report, the pitot tube location is layered into the ductwork schematics as data. This is not just a static image. The location 146 is retained as a dynamic data point in the overall data and virtual model, with precise values for that specific point in the duct location. This means it can influence and be influenced by other variables in the system, allowing for real-time capture and reflection of changes in airflow dynamics within the duct.

This allows the DIM 100 platform to generate a complete duct airflow analysis, including average velocity and total airflow calculations, that include every register previously mapped into the DEVI' s 100 relational polygon dataset, along with the association of every polygon data feature to the fan or duct system being tested.

As a worksheet, the Round Pitot Traverse Report allows users to input or update data directly into the report. The system then uses this data to generate a detailed report, providing a comprehensive overview of the airflow characteristics within the duct. The Round Pitot Traverse Report in conjunction with the polygon mapping technology, offers a powerful tool for facility managers, HVAC professionals, and energy auditors. This innovative functionality enables a more detailed tracking of equipment performance, facilitates efficient planning of routine maintenance, and assists in identifying potential areas for energy conservation and efficiency improvements, all within a single platform.

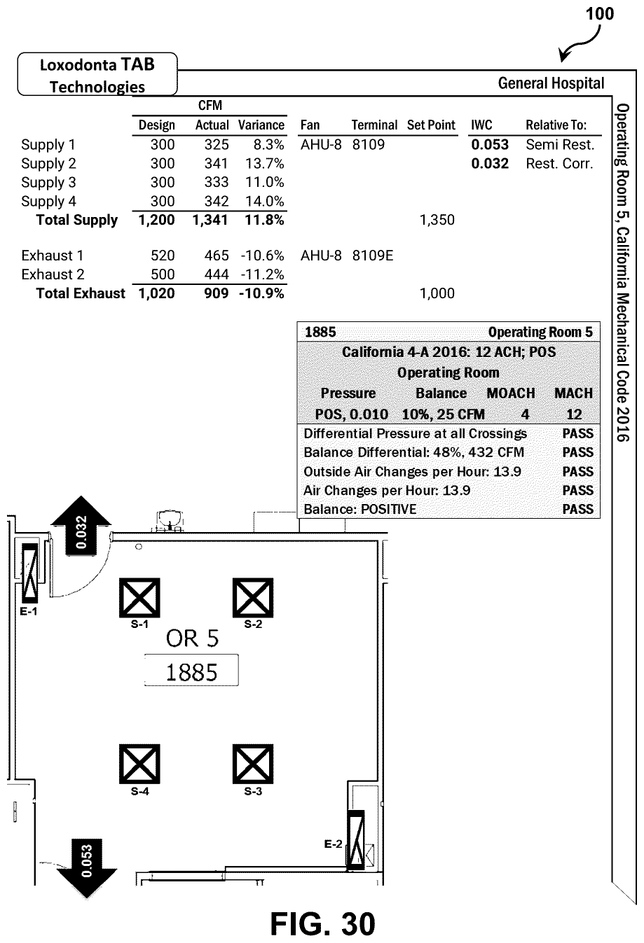

FIG. 30 illustrates a sample of an actual report produced by the DIM 100, a culmination of all the parameter tests, algorithms and polygonal relationships that make up the system for reporting air balance, infection control and energy conservation conditions. This example includes a room group in a healthcare facility and applies the ASHRAE 170 standards. Every feature in this report is part of a data set, including the lines and images that represent the rooms.

These reports are customized for immediate applications related to health and safety, but also comply with all regulatory parameters for building design, commissioning, maintenance, and conservation.

What is claimed is:

1. A system for controlling at least one of airborne infection, airborne contamination, and energy conservation in an at least one environment containing a plurality of rooms, the system comprising:
a data integration module receiving a first data, the first data including at least one of regulatory standard, reporting standard, public health protocols, air balance protocols, air balance report forms, user certifications, fire life safety floorplans, equipment certifications, manually tested conditions;
a construction design module receiving a first data, the first data including at least one of building specifications, architectural blueprints, mechanical drawings, ventilation schedules, HVAC equipment specifications, design conditions, building design standards, pre-construction reporting protocols, testing, adjusting and balancing parameters, as-built reporting protocols;
an energy conservation model, wherein the model optimizes the efficiency of the HVAC system in one or more environments, and wherein the model receives raw data, comprising at least one element from a selection of real-time, periodic, and historical inputs, including set points for HVAC equipment, parameters for maintaining balanced air conditions, ventilation schedules tailored for energy conservation, and design and tested conditions of HVAC systems under energy conservation measures;
an energy conservation module connected to the energy conservation model, the energy conservation module receiving a first data at pre-determined intervals from the from the energy conservation model, the first data including at least one of energy conservation set points for HVAC equipment, energy conservation parameters for air balance conditions, energy conservation ventilation schedule, energy conservation HVAC design conditions, energy conservation HVAC tested conditions; and transmitting it to the data integration module;
a sensor system, wherein the sensor system includes at least one of differential pressure sensor, static pressure sensor, or airflow sensor located in the at least one environment, wherein the sensor receives raw data of at least one current condition within the at least one environment;
a condition monitoring module connected to the sensor system, the condition monitoring module receiving a first data at pre-determined intervals from the sensor system, the first data including at least current conditions of the at least one environment and transmitting it to the data integration module;
a building automation system, wherein the building automation system is connected to components comprising at least one fan system, air moving equipment system, air conditioning system, duct system air handler unit, and air volume terminal units in the at least one environment wherein the building automation system receives raw data of at least one condition;
an integrated monitoring module connected to the building automation system, the integrated monitoring module receiving a first data at pre-determined intervals from the building automation system, the first data including at least current conditions of the at least one environment and transmitting it to the data integration module;
wherein the data integration module receives second data of at least one of construction design module, energy conservation module, condition monitoring module, integrated monitoring module comprising a virtual representation of the at least one environment;
wherein the data integration module receives the second data and calculates at least one parameter test for the at least one environment;
wherein the data integration module generates a report, wherein the report includes a full list of values of at least one of air flow rate measurements of the at least one environment for every register located within the plurality of rooms within the at least one environment;
wherein the data integration module generates a report, wherein the report includes a full list of values of at least one of transfer air rate of the at least one environment for every envelope crossing located within the plurality of rooms within the at least one environment;
wherein the data integration module generates a report, wherein the report includes a full list of values of at least one of differential pressure measurements of the at least one environment for every envelope crossing within the plurality of rooms within the at least one environment.

2. The system of claim 1 wherein the at least one environment includes at least one of at least one room and at least one corridor and at least one envelope crossing:
wherein the data integration module assigns a naming convention to the at least one room and corridor;
wherein the data integration module assigns at least one zone or room group to the at least one room and corridor;
wherein the data integration module assigns at least one regulatory standard to the at least one room and corridor;
wherein the data integration module assigns at least one function of space, room application, or air classification selected from the at least one regulatory standard to the at least one room and corridor.

3. The system of claim 2 wherein the data integration system optionally determines at least one failure of at least one parameter test in at least one of the at least one room and corridor from the first and second data;
wherein the failure can be at least one of air balance, air change, differential pressure, air transfer, ventilation rate, or exhaust rate regulatory requirement;
wherein the failure can be at least one of building design features, including incorrect estimated room dimensions;
wherein the failure can be at least one of contamination removal parameters received as first data within the data integration module or construction design module;
wherein the failure can be at least one of energy conservation parameters received as first data within the energy conservation module.

4. The system of claim 3 wherein the data integration system compares the parameter test results of at least two regulatory standards to the at least one room and corridor.

5. The system of claim 3 wherein the data integration system compares the parameter test results of at least two of at least one of original design regulatory standard(s) or newer regulatory standard(s).

6. The system of claim 3 wherein the data integration system compares the parameter test results of at least two of at least one of healthcare or non-healthcare regulatory standard(s).

7. The system of claim 1 wherein the at least one environment includes the at least one room and corridor mapped to at least one of design specification(s), actual condition(s), or regulatory standard(s).

8. The system of claim 1 wherein the virtual representation of the at least one environment is acquired from mechanical drawings or life safety floorplans using commercial or proprietary image processing algorithms.

9. The system of claim 1 wherein the virtual representation of the at least one environment is generated using commercial or proprietary artificial intelligence algorithms trained with human input.

10. The system of claim 1 wherein the virtual representation of the at least one environment is formatted and structured in a manner compatible with artificial intelligence algorithms.

11. The system of claim 1 where in the report includes predictive modeling comprising theoretical airflow, static pressure, differential pressure condition measurements.

12. The system of claim 1 wherein the report includes actual airflow, static pressure, and differential pressure condition measurements acquired by a technician.

13. The system of claim 1 wherein the report complies with reporting standards for digital integration into as-built schematics, as-built ventilation schedules, BAS systems, BIM models, and CAD files.

14. The system of claim 1 wherein at least one of the data integration module, construction design module, energy conservation module, condition monitoring module, and integrated monitoring module receives a first data in real time.

15. The system of claim 1 wherein the HVAC equipment includes at least one specified location of air handler units, fans, variable frequency drives, duct systems, terminal units, fume hoods, fan coil units, and grilles; wherein the report includes at least one virtual representation with at least one overlay of the at least one location of the at least one HVAC equipment.

16. The system of claim 1 wherein the data integration module generates a report and stores the report into the first data,
wherein the report includes at least one of a schematic of the environment based upon building specifications stored within the first data, and a list of values, comprising values of at least one of air flow rate, ventilation rate, exhaust rates, transfer air, differential pressure measurements,
wherein the report further includes the values from at least one design versus actual conditions parameter test conducted by the data integration module.

17. The system of claim 1 wherein the data integration module generates a report and stores the report into the first data;
wherein the report includes at least one of a schematic of the environment based upon building specifications stored within the first data, and a list of values, comprising values of at least one of air flow rate, ventilation rate, exhaust rates, transfer air, differential pressure measurements;
wherein the report further includes the values from at least one infection control parameter test, regulatory parameter test, contamination removal parameter test, or energy conservation parameter test conducted by the data integration module.

18. The system of claim 1 wherein the data integration module generates a report and stores the report into the first data;
wherein the report includes a schematic and a list of values, comprising every design specification of at least one of dimensions, room function, air flow rate, ventilation rate, exhaust rates, transfer air, differential pressure measurements, temperature, and humidity; the report further includes:
every room and corridor within the at least one building or construction project received as second data and stored within the first data;
every envelope crossing of the every room and corridor within the at least one building or construction project received as second data and stored within the first data;
every register within the every room and corridor within the at least one building or construction project received as second data and stored within the first data;
every HVAC equipment of the at least one building or construction project received as second data and stored within the first data;
wherein the report further includes at least one parameter test of regulatory standard, infection control, contamination removal, or energy conservation of at least one of the every room and corridor, the every envelope crossing, the every register, or the every HVAC equipment.

19. The system of claim 18 wherein the report complies with reporting standards for digital integration into as-built schematics, as-built ventilation schedules, BAS systems, BIM models, and CAD files.

20. The system of claim 1 wherein the data integration module generates a report and stores the report into the first data;
wherein the report includes a schematic and a list of values, comprising at least one of design specifications and verified and manually tested conditions of at least one of dimensions, room function, air flow rate, ventilation rate, exhaust rates, transfer air, differential pressure measurements, temperature, and humidity; the report further includes:
every room and corridor within the at least one building or construction project received as second data and stored within the first data;
every envelope crossing of the every room and corridor within the at least one building or construction project received as second data and stored within the first data;
every register within the every room and corridor within the at least one building or construction project received as second data and stored within the first data;
every HVAC equipment of the at least one building or construction project received as second data and stored within the first data;
wherein the report further includes at least one parameter test of regulatory standard, infection control, contamination removal, or energy conservation of at least one of the every room and corridor, the every envelope crossing, the every register, the every HVAC equipment.

21. The system of claim 20 wherein the report includes at least one comparison of the estimated room dimensions and volumes against the manually tested room dimensions and volumes.

22. The system of claim 20 wherein the report includes the values from at least one design conditions versus actual conditions parameter test conducted by the data integration module; and wherein the design conditions versus actual conditions are tested for at least one parameter test(s).

23. The system of claim 20 wherein the report complies with reporting standards for digital integration into as-built schematics, as-built ventilation schedules, BAS systems, BIM models, and CAD files.

24. The system of claim 1 wherein the data integration module is configured to adjust a condition of at least one HVAC component based upon a remedy for a deficiency, where the remedy is based upon at least one of air flow rate, differential pressure, air balance, air change, outside air change, ventilation rate, exhaust rate, temperature, humidity, contamination removal, or energy conservation of the at least one environment;
wherein the data integration module receives second data of at least one of construction design module, energy conservation module, condition monitoring module, integrated monitoring module comprising a virtual representation of the at least one environment;
wherein the data integration module receives the second data and calculates at least one parameter test for the at least one environment;
wherein the data integration module generates a notification, wherein the notification includes a full list of values of at least one of air flow rate measurements of the at least one environment for every register located within the plurality of rooms within the at least one environment;
wherein the data integration module generates a notification, wherein the notification includes a full list of values of at least one of transfer air rate of the at least one environment for every envelope crossing located within the plurality of rooms within the at least one environment;
wherein the data integration module generates a notification, wherein the notification includes a full list of values of at least one of differential pressure measurements of the at least one environment for every envelope crossing within the plurality of rooms within the at least one environment.

25. The system of claim 24 wherein the data integration system optionally determines at least one failure of the at least one parameter test in at least one of the at least one room and corridor from the first and second data;
wherein the failure can be at least one of air balance, air change, differential pressure, air transfer, ventilation rate, exhaust rate regulatory requirement;
wherein the failure can be at least one of energy conservation parameters received as first data within the energy conservation module;
wherein the failure can be at least one of contamination removal parameters received as first data within the data integration module.

26. The system of claim 25 wherein at least one of the energy conservation model, the sensor system, the building automation system receives raw data in real-time.

27. The system of claim 25 wherein at least one of the energy conservation module, the condition monitoring module, the integrated monitoring module receives first data in real-time.

28. The system of claim 25 wherein at least one of the energy conservation module, the condition monitoring module, the integrated monitoring module receives the notification in real-time.

29. The system of claim 25 wherein at least one of the energy conservation model, the sensor system, the building automation system displays the notification in real-time.

30. The system of claim 25 wherein the notification complies with reporting standards for digital integration into BAS systems, sensor systems, BIM models, and CAD files.

31. The system of claim 1 wherein at least one of the construction design module, energy conservation module, conditioning monitoring module, and integrated monitoring module communicates with a database(s) to store the first data, second data, and third data,
wherein the database is configured to communicate with a data integration module;
wherein the first data, second data, and third data are accessible to pre-selected users via the data integration module.

32. The system of claim 1 wherein at least one of the data integration module, construction design module, energy conservation module, conditioning monitoring module, and integrated monitoring module communicates with a database(s) to store the first data, second data, and third data,
wherein the database(s) is configured to communicate with at least one of the at least modules;
wherein the first data, second data, and third data are accessible to pre-selected users via at least one of the at least modules.
